(19) United States
(12) Patent Application Publication
(10) Pub. No.: US 2026/0300275 A1
(43) Pub. Date: Oct. 1, 2026

(54) ADAPTIVE AMBIGUITY DETECTION FOR TEXT-TO-SQL SYSTEMS

(71) Applicant: Oracle International Corporation, Redwood Shores, CA (US)

(72) Inventors: Neelesh Kumar Shukla, Bangalore (IN); Prabhat Kumar Prabhakar, Bangalore (IN); Vijayalakshmi Krishnamurthy, Sunnyvale, CA (US)

(73) Assignee: Oracle International Corporation, Redwood Shores, CA (US)

(21) Appl. No.: 19/629,942

(22) Filed: Mar. 26, 2026

(30) Foreign Application Priority Data
Mar. 26, 2025 (IN) 202541028486

(51) Int. Cl. G06F 16/242; G06F 16/2452; G06F 40/20; G06F 40/30; G06F 40/58

(52) U.S. Cl. CPC G06F 16/243; G06F 16/24522; G06F 40/20; G06F 40/30; G06F 40/58

(57) ABSTRACT

Techniques are provided for ambiguity detection in and context-driven optimization in text-to-SQL translation. The method involves receiving a natural language utterance and a database context. A generative model may determine that ambiguity exists in the utterance, the database context, or both, by applying a context adherence factor that balances schema-based logical reasoning with common-sense interpretation. The generative model can further determine that the ambiguity corresponds to one of several predefined ambiguity categories and may classify the ambiguity by type based on the identified category. The system can generate an explanation describing the ambiguity and may formulate one or more reactive questions requesting information needed to resolve the ambiguity. An ambiguity score may be generated to indicate a level of confidence that the ambiguity is present. The system can provide to a user the ambiguity type, the explanation, the reactive questions, and the ambiguity score.

### CROSS REFERENCE TO RELATED APPLICATION

The present application claims the benefit and priority of India Provisional Application No. 202541028486, filed on Mar. 26, 2025, the entire contents of which is incorporated herein by reference in its entirety for all purposes.

### FIELD

The present disclosure relates generally to converting natural language to a logical form, and more particularly, to machine learning techniques for ambiguity detection in and context-driven optimization in text-to-SQL translation.

### BACKGROUND

The advent of database management systems has revolutionized the way large datasets are stored, managed, and queried. Traditional databases, such as relational databases, have become the backbone of many applications across various industries. These databases are structured to store data in tables, allowing for the organization and retrieval of information in a systematic manner. The efficiency and reliability of databases have made them indispensable in fields such as finance, healthcare, and e-commerce, where large volumes of data need to be managed with precision and speed.

Structured Query Language (SQL) has been the primary tool for interacting with relational databases. SQL allows users to perform a wide range of operations, including data insertion, updates, deletions, and complex queries to retrieve specific information. The power and flexibility of SQL have made it the standard language for database management. However, the effective use of SQL requires a certain level of expertise, as constructing accurate and efficient queries can be complex and challenging for users who are not well-versed in the language.

In recent years, there has been a significant development in the field of databases with the emergence of text-to-SQL systems. These systems are designed to bridge the gap between natural language and SQL, enabling users to interact with databases using plain, conversational language. Text-to-SQL systems leverage advanced natural language processing (NLP) techniques and machine learning algorithms to translate user queries expressed in natural language into SQL commands. This innovation has the potential to democratize access to databases, allowing users without specialized SQL knowledge to efficiently retrieve and manipulate data.

The integration of text-to-SQL systems into database management represents a significant advancement in making databases more accessible and user-friendly. By simplifying the interaction with databases, these systems can enhance productivity and reduce the learning curve associated with database management. As businesses and organizations continue to accumulate and rely on large datasets, the ability to easily and accurately query databases using natural language will become increasingly valuable. This disclosure presents adaptive ambiguity detection and context-driven optimization techniques for the implementation and enhancement of text-to-query language technologies enabling more accurate interpretation of natural language queries and supporting robust, scalable database interaction across various domains.

### BRIEF SUMMARY

Machine learning techniques are disclosed herein (e.g., a computer implemented method, a system, non-transitory computer-readable medium storing code or instructions executable by one or more processors) ambiguity detection in and context-driven optimization in text-to-query translation. The disclosed subject matter describes adaptive analysis of natural language questions and associated database schema context to identify and explain ambiguities that can arise during query generation. A framework is presented that enables balancing of schema context with common-sense reasoning, allowing for adjustment of context adherence to address domain-specific requirements. The system assigns an ambiguity probability score to input queries and generates explanations specifying the source of ambiguity and clarification required. The approach supports dynamic prompting and domain adaptation, allowing incorporation of new ambiguity types and updating detection criteria with minimal training data. LLMs optimize ambiguity detection and explanation as schema definitions and logic change over time. Human review is facilitated through prioritization of ambiguous cases and provision of actionable suggestions. By leveraging weakly supervised learning from both real-world and synthetic datasets, the technology improves the accuracy and scalability of ambiguity detection in automated SQL query generation.

In various embodiments, a computer-implemented method includes: receiving a natural language utterance and database context; determining, by a generative model, that there is ambiguity in the natural language utterance, the database context, or both, wherein determining comprises applying a context adherence factor that balances between schema-based logical reasoning and common-sense interpretation of the generative model; determining, by the generative model, that the ambiguity corresponds to one of predefined ambiguity categories; classifying the ambiguity by an ambiguity type based on the predefined ambiguity category; generating an explanation describing the ambiguity and one or more reactive questions requesting information required to resolve the ambiguity; generating an ambiguity score indicating a level of confidence that the ambiguity is ambiguous; and providing to a user the ambiguity type, the explanation, the one or more reactive questions, and the ambiguity score.

In various embodiments, the context adherence factor is a tunable parameter having a value within a predetermined range, and wherein: when the context adherence factor is set to a maximum value within the range, the generative model relies exclusively on schema-based logical reasoning; when the context adherence factor is set to an intermediate value within the range, the generative model prioritizes schema-based logical reasoning and permits common-sense interpretations of terms in the natural language utterance; or when the context adherence factor is set to a minimum value within the range, the generative model prioritizes common-sense interpretation to interpret the natural language utterance when schema details are insufficient.

In various embodiments, the method further comprises: receiving a second natural language utterance and database context; determining, by a generative model, that there is no ambiguity in the second natural language utterance and database context; and generating a query statement in a programming language corresponding to the second natural language utterance and database context.

In various embodiments, the predefined ambiguity categories comprise database context ambiguities, natural language utterance ambiguities, model-identifiable ambiguities, or any combination thereof.

In various embodiments, the method further comprises: receiving a second natural language utterance and second database context; determining, by a generative model, that there is ambiguity in the second natural language utterance, the second database context, or both; determining, by a generative model, that the ambiguity in the second natural language utterance, the second database context, or both does not correspond to any of the predefined ambiguity categories; determining that the ambiguity in the second natural language utterance, the second database context, or both can be solved using common-sense interpretations; and generating a query statement in a programming language corresponding to the second natural language utterance and the second database context.

In various embodiments, the method further comprises: receiving a second natural language utterance and second database context; determining, by a generative model, that there is ambiguity in the second natural language utterance, the second database context, or both; determining, by a generative model, that the ambiguity in the second natural language utterance, the second database context, or both does not correspond to any of the predefined ambiguity categories; determining that the ambiguity in the second natural language utterance, the second database context, or both cannot be solved using common-sense interpretations; and performing an iterative optimization process comprising generating, by an optimizer generative model, one or more new ambiguity categories and corresponding ambiguity instructions based on the second natural language utterance, the second database context, and the explanation.

In various embodiments, the ambiguity score is generated as a numerical value within a predetermined range, and wherein: a score at or near a maximum value within the range indicates a high level of confidence that the natural language utterance is ambiguous; a score at or near a midpoint within the range indicates a moderate level of confidence that the natural language utterance is ambiguous; and a score at or near a minimum value within the range indicates a low level of confidence that the natural language utterance is ambiguous.

In various embodiments, the method further comprises: receiving a response from the user to the one or more reactive questions providing the information required to resolve the ambiguity; and generating a query statement in a programming language corresponding to the natural language utterance and the database context.

Some embodiments include a system that includes one or more processors; and one or more computer-readable media storing instructions which, when executed by the one or more processors, cause the system to perform part or all of the operations and/or methods disclosed herein.

Some embodiments include one or more non-transitory computer-readable media storing instructions which, when executed by one or more processors, cause a system to perform part or all of the operations and/or methods disclosed herein.

The techniques described above and below may be implemented in a number of ways and in a number of contexts. Several example implementations and contexts are provided with reference to the following figures, as described below in more detail. However, the following implementations and contexts are but a few of many.

### BRIEF DESCRIPTION OF THE DRAWINGS

The present disclosure will be better understood in view of the following non-limiting figures, in which:

FIG. 1 depicts a block diagram for an example NL2SQL tool, according to various embodiments.

FIG. 2 depicts a block diagram for an example generative AI SQL agent system, according to various embodiments.

FIG. 3 depicts a block diagram for an example generative AI SQL agent, according to various embodiments.

FIG. 4 depicts a block diagram for training, testing, and producing an NL2SQL model, according to various embodiments.

FIG. 5 depicts a block diagram depicting a workflow for detecting ambiguity in natural language queries. The diagram shows the process of generating clarification questions in response to detected ambiguities, incorporating user-provided information to resolve the ambiguities, and generating SQL statements based on the clarified queries, in accordance with various embodiments.

FIG. 6 depicts a block diagram depicting a process for dynamically optimizing ambiguity detection categories and generating instructions for addressing domain-specific ambiguities, according to various embodiments.

FIGS. 7A-7C each depicts a confusion matrix corresponding to the performance of an LLM configuration or experimental conditions evaluated on the Ambrosia baseline dataset. FIG. 7A shows the confusion matrix for the Command R+ LLM configuration on the Ambrosia baseline; FIG. 7B shows the confusion matrix for the Llama 3.1-405B LLM configuration; and FIG. 7C shows the confusion matrix for the GoCoder M1 Premium LLM configuration.

FIGS. 8A-8C each depicts a confusion matrix illustrating the effect of varying the context adherence factor on ambiguity detection in a text-to-SQL system using the original prompt configuration. FIG. 8A corresponds to a context adherence factor value of 1, representing strict reliance on schema-based reasoning. FIG. 8B corresponds to a context adherence factor value of 0.5, representing a balanced approach between schema-based reasoning and common-sense interpretation. FIG. 8C corresponds to a context adherence factor value of 0, representing primary reliance on common-sense interpretation. Each confusion matrix compares predicted ambiguity classifications to ground truth annotations.

FIGS. 9A and 9B each depicts a confusion matrix evaluating the impact of a revised prompt and the use of a context adherence factor on ambiguity detection in a text-to-SQL system. FIG. 9A corresponds to a context adherence factor value of 1, indicating strict schema-based reasoning. FIG. 9B corresponds to a context adherence factor value of 0, indicating primary reliance on general knowledge and common-sense interpretation. Each confusion matrix provides a comparison between model-predicted ambiguity labels and ground truth labels, enabling analysis of the effect of prompt engineering and parameter adjustment.

FIG. 10 is a flowchart illustrating a process for detecting ambiguity and performing context-driven optimization in text-to-SQL translation, according to various embodiments.

FIG. 11 is a block diagram illustrating one pattern for implementing a cloud infrastructure as a service system, according to various embodiments.

FIG. 12 is a block diagram illustrating another pattern for implementing a cloud infrastructure as a service system, according to various embodiments.

FIG. 13 is a block diagram illustrating another pattern for implementing a cloud infrastructure as a service system, according to various embodiments.

FIG. 14 is a block diagram illustrating another pattern for implementing a cloud infrastructure as a service system, according to various embodiments.

FIG. 15 is a block diagram illustrating an example computer system, according to various embodiments.

### DETAILED DESCRIPTION

In the following description, for the purposes of explanation, specific details are set forth in order to provide a thorough understanding of certain embodiments. However, it will be apparent that various embodiments may be practiced without these specific details. The figures and description are not intended to be restrictive. The word “exemplary” is used herein to mean “serving as an example, instance, or illustration.” Any embodiment or design described herein as “exemplary” is not necessarily to be construed as preferred or advantageous over other embodiments or designs.

### Introduction

In recent years, the amount of data powering different industries and their systems have been increasing exponentially. A majority of business information is stored in the form of relational databases that store, process, and retrieve data. Databases power information systems across multiple industries, for instance, consumer tech (e.g., orders, cancellations, refunds), supply chain (e.g., raw materials, stocks, vendors), healthcare (e.g., medical records), finance (e.g., financial business metrics), customer support, search engines, and much more. It is imperative for modern data-driven companies to track the real-time state of their business in order to quickly understand and diagnose any emerging issues, trends, or anomalies in the data and take immediate corrective actions. This work is usually performed manually by analysts who compose complex queries in query languages (e.g., database query languages such as declarative query languages) like SQL, PGQL, logical database queries, API query languages such as GraphQL, REST, and so forth. Composing such queries can be used to derive insightful information from data stored in multiple tables. These results are typically processed in the form of charts or graphs to enable users to quickly visualize the results and facilitate data-driven decision making.

Although common database queries (e.g., SQL queries) are often predefined and incorporated in commercial products, any new or follow-up queries still need to be manually coded by the analysts. Such static interactions between database queries and consumption of the corresponding results require time-consuming manual intervention and result in slow feedback cycles. It is vastly more efficient to have non-technical users (e.g., business leaders, doctors, or other users of the data) directly interact with the analytics tables via natural language (NL) queries that abstract away the underlying query language (e.g., SQL) code. Defining the database query requires a strong understanding of database schema and query language syntax and can quickly get overwhelming for beginners and non-technical stakeholders. Efforts to bridge this communication gap have led to the development of a new type of processing called natural language interfaces for databases (NLIDB). This natural search capability has become more popular over recent years as companies are developing deep-learning approaches for natural language to logical form (NL2LF) such as natural language to SQL (NL2SQL).

Logical form can refer to (i) programming query languages, (ii) intermediate forms, and/or (iii) programming languages. Programming query languages can include database query languages, and examples of programming query languages include, but are not limited to, SQL, PQL, GraphQL, SPARQL, and the like. Intermediate forms can refer to machine-oriented languages and/or meaning representation languages (MRLs) such as OMRL, AMRL, and the like. Examples of programming languages include, but are not limited to, Python, C++, Java, Ruby, and the like. NL2SQL seeks to transform natural language questions to SQL, allowing individuals to run unstructured queries against databases. The converted SQL could also enable digital assistants such as chatbots and others to improve their responses when the answer can be found in different databases or tables with different schemas.

In some instances, NL2SQL transforms natural language to SQL using generative artificial intelligence models such as LLMs. An LLM is a type of artificial intelligence (AI) that is trained to understand, generate, and manipulate human language (e.g., text data) in a coherent and contextually relevant manner. LLMs have resulted in significant progress in natural language processing tasks such as text-to-code (e.g., text-to-SQL), text generation and translation, and sentiment analysis. Due to their attention mechanisms and deep neural architectures, LLMs excel at capturing nuanced language patterns and correlations in massive volumes of text data. LLMs are designed to predict the next word or token in a sequence of text by computing a probability distribution over a fixed vocabulary for the next token based on the context of the preceding tokens. The prediction is achieved through a series of self-attention mechanisms incorporated in the LLMs that assign varying degrees of importance to different parts of the input sequence that enable the LLMs to make informed predictions. LLMs generate contextually appropriate and coherent text by learning a fixed vocabulary from enormous text corpora and predicting which token included in the fixed vocabulary should be the next token in an output sequence.

SQL is a standard database management language for interacting with relational databases. SQL can be used for storing, manipulating, retrieving, and/or otherwise managing data held in a relational database management system (RDBMS) and/or for stream processing in a relational data stream management system (RDSMS). The main goal of the Text-to-SQL model is to allow end users interact with their SQL databases through NL rather than SQL queries. Using a Text-to-SQL service, business analysts can extract information from their databases without thorough knowledge of SQL and the database schemas. In addition to the database schema, the main input to the Text-to-SQL model is a natural language question. For example: “tell me invoices starting with IBY7”. The main output from the Text-to-SQL model is a SQL query. For example: “SELECT * FROM accounts_payable_invoices WHERE LOWER(INVOICE_NUMBER) LIKE LOWER(‘iby7%’)”. As discussed above, the Text-to-SQL model is based on generative models such as LLMs, i.e. prompting a LLM to generate the SQL query from schema and question inputs. The database schemas may share the same NL2SQL prompt template, and the prompt template is populated with specific information (e.g., schema description comprising relevant information about tables and columns and potential values that will help the LLM to generate the correct SQL) for a current database schema and the natural language question. The prompt may further include business logic and instructions such as how to check for payment paid status with the column “accounts_payable_invoices.payment_status_flag” or remind the model to check for the column “amount_paid” if the user asks for ‘amount paid’ or ‘settled amount’. This business logic and instructions section may also include generic instructions on date time format or casing to help the model generate proper SQL queries.

As discussed above, generative models such as large language models that are either pre-trained or fine-tuned have emerged as the dominant approach to solving the text-to-query problem, yielding state-of-the-art results. Despite these advancements, natural language to query (e.g., NL2SQL) systems continue to face significant challenges in accurately interpreting user utterances, particularly when such utterances are vague, incomplete, or ambiguous with respect to the underlying database schema. Ambiguity may arise when an utterance contains terms or phrases with multiple semantic meanings, references that could correspond to more than one schema element (such as columns, tables, or values), or lacks the specificity required for precise understanding. An utterance is considered ambiguous within the database context if it has multiple valid interpretations due to unclear or conflicting meanings. Conversely, an utterance is considered unanswerable if it requires information absent from the database schema, references missing columns or tables, or depends on external domain knowledge or derived information not represented within the database. Additionally, utterances that fall outside the scope of NL2SQL, such as those requiring procedural logic or interpretations unrelated to database querying, are not addressable by such systems. These issues are often exacerbated by end users' limited familiarity with database structure and content, leading to inherent assumptions or omissions in their utterances. Further challenges stem from poorly described schema elements, duplicate or similar concepts within the schema, and the presence of noisy or inconsistent data, all of which complicate query formulation and understanding. These persistent challenges highlight the ongoing need for improved mechanisms for detecting, explaining, and addressing ambiguity and unanswerability in text-to-query systems.

Existing systems and methods intended to address ambiguity in text-to-query processing rely on static rules, rigid schema matching, or fixed categories of ambiguity. Such approaches often fail to generalize across diverse domains and database structures, resulting in limited effectiveness when confronted with queries that exhibit novel or context-specific ambiguity. The inability to dynamically adapt to new types of ambiguous utterances restricts the utility of these systems, especially as real-world databases and user queries evolve over time.

Benchmarking and evaluation frameworks commonly used for ambiguity detection frequently suffer from weaknesses in dataset construction and annotation. Synthetic datasets often lack realistic context or common-sense reasoning, while real-world datasets are often constrained by inconsistent labeling or author bias. Human annotators and automated systems alike demonstrate only moderate agreement rates in identifying ambiguity, underscoring the absence of a universal definition and the challenge of reproducibly capturing ambiguous cases. This limitation is further compounded by annotation inconsistencies, insufficient explanation of ambiguity, and a lack of explicit guidance for resolving ambiguous queries.

Prior methods generally exhibit poor recall and precision for ambiguous queries, particularly in settings where domain-specific terms or business logic are not explicitly defined in the schema. Many frameworks are unable to recognize or explain ambiguity arising from duplicate or similar schema elements, missing instructions for derived concepts, or vague user utterances. The inability to provide clear, actionable explanations for why a query is ambiguous further impedes the effectiveness of ambiguity detection, leaving users without the means to clarify their intent or resolve uncertainty.

Additionally, existing architectures often do not support the dynamic expansion of ambiguity categories or the integration of new instructions based on user feedback or evolving domain requirements. As a result, these systems are limited in their capacity to accommodate the breadth of ambiguity types encountered in practical deployments. The persistent shortcomings in domain adaptation, explanation capability, and dataset reliability motivate the need for adaptive and configurable frameworks capable of detecting, explaining, and resolving ambiguity in text-to-SQL systems.

To overcome these challenges and others, the techniques disclosed herein leverage a machine learning framework for ambiguity detection and context-driven optimization in text-to-query translations. The disclosed technology employs adaptive analysis of natural language questions and associated database schema context to identify and explain ambiguities that may arise during query generation. Unlike prior approaches that depend on static rules or fixed categories, the present framework enables adjustable balancing between schema context and common-sense reasoning through a configurable context adherence factor, thereby supporting domain-specific requirements and flexible interpretation. The system assigns an ambiguity probability score to each natural language question and generates detailed explanations that specify the source of ambiguity and the clarifications required. Dynamic prompting and domain adaptation are facilitated by allowing for the incorporation of new ambiguity types and updating detection criteria with minimal training data. The approach further supports human review by prioritizing ambiguous cases and providing actionable suggestions to resolve uncertainty. By leveraging weakly supervised learning from both real-world and synthetic datasets, the disclosed subject matter improves the accuracy, scalability, and adaptability of ambiguity detection in automated SQL query generation, addressing persistent limitations of prior art and advancing the reliability of natural language interfaces for databases.

In various embodiments, a computer-implemented method is provided comprising: receiving a natural language utterance and database context; determining, by a generative model, that there is ambiguity in the natural language utterance, the database context, or both, wherein determining comprises applying a context adherence factor that balances between schema-based logical reasoning and common-sense interpretation of the generative model; determining, by the generative model, that the ambiguity corresponds to one of predefined ambiguity categories; classifying the ambiguity by an ambiguity type based on the predefined ambiguity category; generating an explanation describing the ambiguity and one or more reactive questions requesting information required to resolve the ambiguity; generating an ambiguity score indicating a level of confidence that the ambiguity is ambiguous; and providing to a user the ambiguity type, the explanation, the one or more reactive questions, and the ambiguity score.

As used herein, the terms “about,” “similarly,” “substantially,” and “approximately” are defined as being largely but not necessarily wholly what is specified (and include wholly what is specified) as understood by one of ordinary skill in the art. In any disclosed embodiment, the term “about,” “similarly,” “substantially,” or “approximately” may be substituted with “within [a percentage] of” what is specified, where the percentage includes 0.1 percent, 1 percent, 5 percent, and 10 percent, etc. Moreover, the term terms “about,” “similarly,” “substantially,” and “approximately” are used to provide flexibility to a numerical range endpoint by providing that a given value may be slightly above or slightly below the endpoint without affecting the desired result.

As used herein, when an action is “based on” something, this means the action is based at least in part on at least a part of the something.

### Overview of Agents and NL2SQL Framework

An agent (also referred to as a skill, chatbot, chatterbot, talkbot, digital assistant, or the like) is a computer program that can engage in conversations with end users. The agent can generally respond to natural language messages (e.g., questions or comments) through a messaging application that uses natural language messages. Enterprises may use one or more agent systems to communicate with end users through a messaging application. The messaging application, which may also be referred to as a channel, may be an end user's preferred messaging application that they have already installed and are familiar with. Thus, the end user does not need to download or install new applications in order to chat with the agent system. The messaging application may interface with, for example, over-the-top (OTT) messaging channels (such as Facebook Messenger, WhatsApp, WeChat, Line, Kik, Telegram, Talk, Skype, Slack, or SMS); virtual private assistants (such as Amazon Alexa, Google Assistant, Apple Siri, or Microsoft Cortana, accessible through devices like Amazon Echo, Google Home, Apple HomePod, or compatible mobile devices); mobile and web app extensions that add chat capabilities to native or hybrid/responsive apps or web applications; or voice-based input (such as devices or apps that utilize Siri, Google Assistant, Alexa, Cortana, or other speech-based interfaces).

End user may interact with the agent system through a conversational interaction (sometimes referred to as a conversational user interface (UI)), similar to interactions between people. In some cases, the interaction may include the end user providing an utterance such as the query: “Please retrieve all invoices greater than ten thousand dollars for the last four years for Customer Y”, to the agent, and the agent responding with a natural language response based on translation of the user's natural language query to an SQL query and execution of the SQL query on an appropriate database.

In some embodiments, the agent system may intelligently handle end user interactions without interaction with an administrator or developer of the agent system. For example, an end user may send one or more messages to the agent system in order to achieve a desired goal. A message may include certain content, such as natural language text, audio, image, video, or another method of conveying a message. In some embodiments, the agent system may convert the content into a standardized logical form (e.g., an SQL query). The agent system may also prompt the end user for additional input parameters or request other additional information. In some embodiments, the agent system may also initiate communication with the end user, rather than passively responding to end user utterances. Described herein are various techniques for identifying an explicit or implicit invocation of an agent system and determining an input for the agent system being invoked.

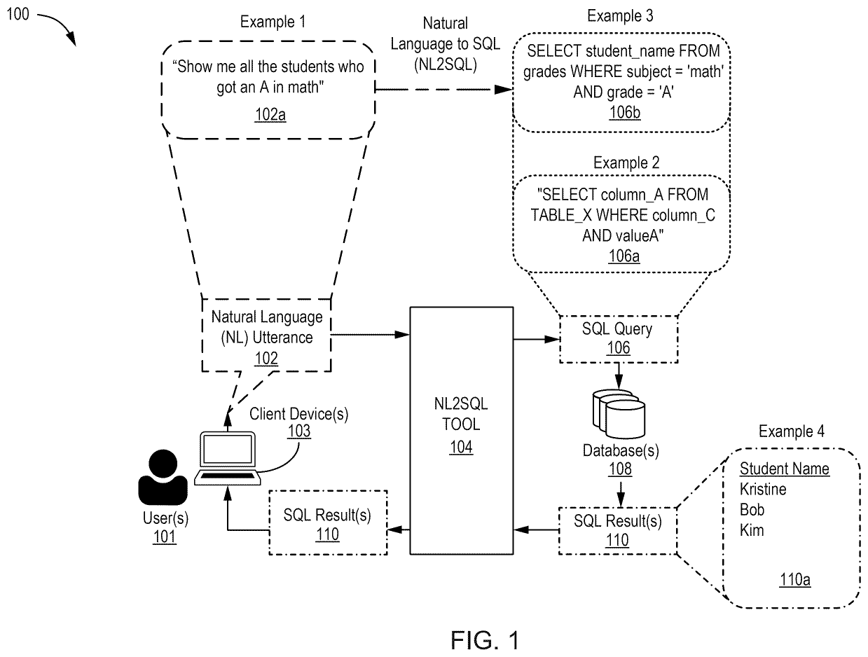

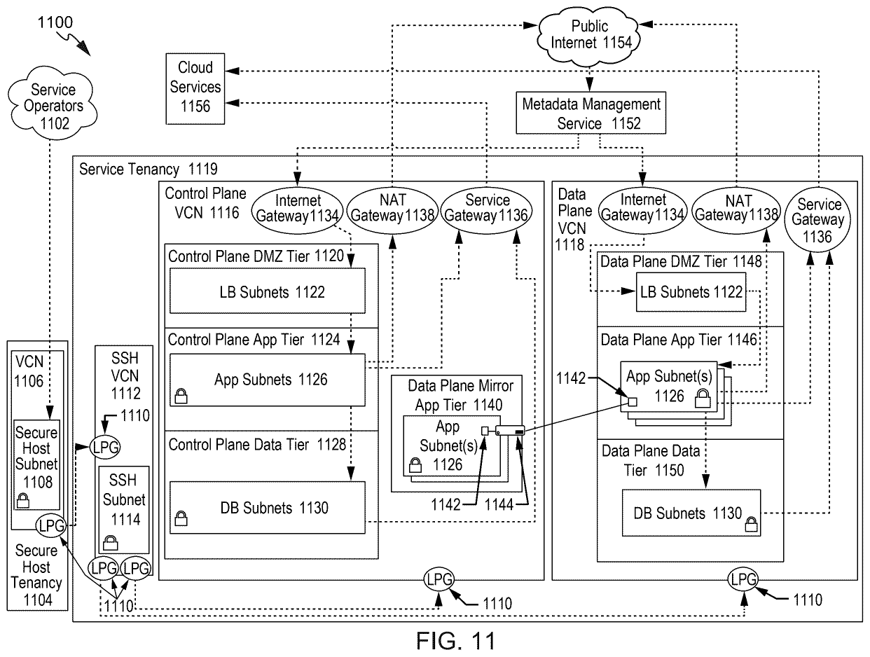

FIG. 1 depicts a simplified diagram of an environment 100 incorporating an exemplary NL2SQL tool, according to various embodiments. Environment 100 includes an NL2SQL tool 104 that enables users 101 to receive (i) a translated version of a natural language utterance 102 (e.g., a natural language query translated into a given programming language such as SQL), and/or (ii) a result of executing an action related to a natural language utterance 102 (e.g., a natural language query translated into a given programming language such as SQL, which is then executed on a database to retrieve a result for the query). As shown in FIG. 1, the NL2SQL tool 104 is configured to generate an SQL query 106 and one or more SQL query result(s) 110 based on the provided natural language utterance 102; however, other examples may implement tasks in addition to or in alternative to SQL query generation (e.g., schema checking, schema linking, sentence completion, extraction of key information, debugging, and other SQL-related tasks). The NL2SQL tool 104 can be implemented using software only, hardware only, firmware only, or any combination of hardware, software, and/or firmware. In some instances, the environment 100 is part of an Infrastructure as a Service (IaaS) cloud service (described in more detail with respect to FIGS. 11-15) and the NL2SQL tool can be implemented as part of the IaaS by leveraging the scalable computing resources and storage capabilities provided by the IaaS provider to process and manage large volumes of data and complex computations. This setup can allow the NL2SQL tool 104 to deliver real-time, responsive interactions while ensuring high availability, security, and performance scalability to meet varying demand levels. The NL2SQL tool 104 can be embodied or implemented in various physical systems or devices, such as in a computer, a mobile phone, a watch, an appliance, a vehicle, and the like. For the purposes of this example, the NL2SQL tool 104 generates and accepts queries related to SQL, but it should be understood that the techniques described herein are not limited to SQL and the NL2SQL tool 104 can be configured as any other NL2LF tool capable of generating queries and statements using other programming languages (e.g., PRQL, GraphQL, WebAssembly, Python, R, Java, N1QL, and the like).

As illustrated in FIG. 1, a user 101 provides a user input to the NL2SQL tool 104. The user input can be or include a natural language utterance 102. The natural language utterance can be in text form, such as when the user types a sentence, a question, a text fragment, or phrase and provides it as input to the NL2SQL tool 104 via client device(s) 103. The client device(s) 103 can be configured to communicate with the NL2SQL tool 104, provide the natural language utterance 102 to the NL2SQL tool 104 and receive outputs from the NL2SQL tool 104. In some implementations, the natural language utterance 102 can be in speech form, which may be converted to text form and provided to the NL2SQL tool 104. As an example, a natural language utterance 102 such as 102a “Show me all the students who got an A in math” can be spoken by the user 101 and the NL2SQL tool 104 may be configured as a standalone tool, as a plug-in, or make use of another audio-to-text translator, configured to translate the audio into text for further processing.

The NL2SQL tool 104 may be, or may make use of, one or more generative artificial intelligence models such as LLMs configured to generate an SQL query 106 (e.g., 106a or 106b) based on the natural language utterance 102. The NL2SQL tool 104 may receive a prompt including the natural language utterance 102 to generate an SQL query 106 that is relevant to the preferences of user 101. In some implementations, the user 101 and/or client device 103 generate a prompt including the natural language utterance 102 before providing the prompt to the NL2SQL tool 104. In other implementations, the NL2SQL tool 104 receives the natural language utterance 102 and generates the prompt itself, e.g., by populating slots of a prompt template, before providing the prompt to a trained generative artificial intelligence model.

The NL2SQL tool 104 converts the natural language utterance 102 (as in example 1 depicted in FIG. 1) to the SQL query 106. The NL2SQL tool 104 may consider schema information corresponding to one or more databases 108 to generate the SQL query 106. The SQL query 106 (as in examples 2 or 3 depicted in FIG. 1) may be executed on database(s) 108 to obtain an SQL result 110. As a non-limiting example, SQL result 110 can be a list of students who got an A in math based on a generated SQL query 106. The SQL result(s) 110 can be provided back to the user 101 by the NL2SQL tool 104. In some instances, the SQL result(s) 110 are reported back to the user 101 as raw output. In other instances, the SQL result(s) 110 are reported back to the user 101 as part of a natural language response (e.g., a summary) generated by the one or more generative artificial intelligence models in response to the natural language utterance 102. In other instances, the SQL result(s) 110 are reported back to the user 101 as part of a natural language response (e.g., a summary) generated by the one or more generative artificial intelligence models and/or with a visualization (e.g., a bar chart, pie chart, table, or the like) generated by one or more generative artificial intelligence models and/or analytic subsystems in response to the natural language utterance 102. The user 101 may receive the SQL result(s) 110 through the client device(s) 103. Additionally, or alternatively, the NL2SQL tool 104 may provide the SQL query 106 to the user(s) via other means such as an email communication, SMS message, or other types of notification receivable on one or more other computing devices. In some implementations, the SQL query 106 is provided to the user(s) in addition to or instead of running the SQL query 106 on the database(s) 108 to obtain SQL result(s) 110 (e.g., as part of a feedback request to validate the SQL query 106).

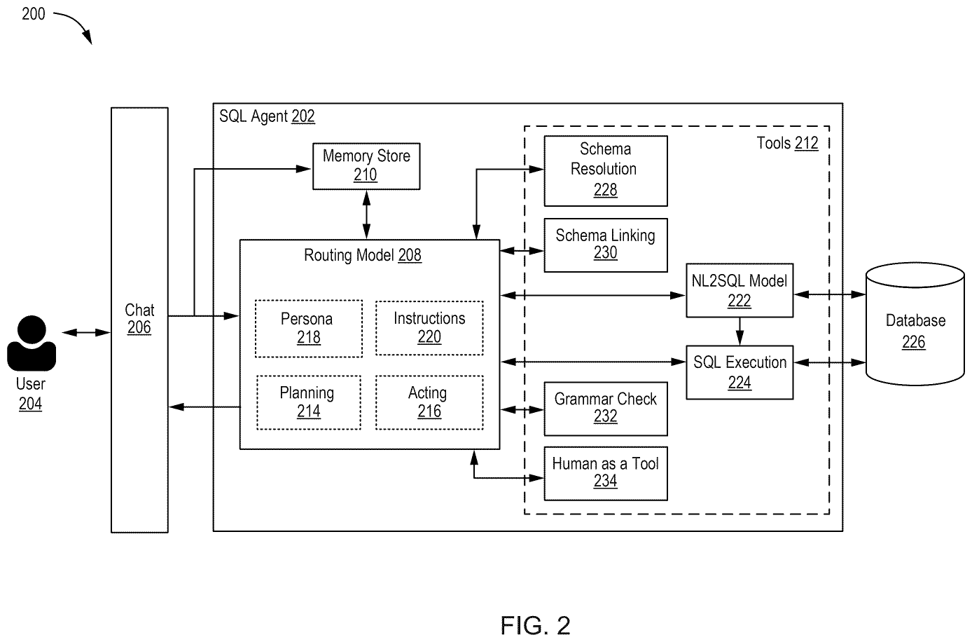

FIG. 2 is a simplified block diagram of an SQL agent system 200 according to certain embodiments. SQL agent system 200 is a computing system that can be implemented in software only, hardware only, firmware only, or any combination of hardware, software, and/or firmware. The SQL agent system 200 can convert natural language questions into SQL to help users complete their data related tasks by leveraging the power of generative artificial intelligence such as LLMs. In addition to their language capabilities (e.g., sentence completion, summarization, extraction of key information from text passages), generative artificial intelligence models can generate SQL statements. The purpose of the SQL agent system 200 is to enable users to interact with their databases with the least amount of effort. This may include the SQL agent system 200 interpreting user requests in natural language, reviewing database schema, implementing schema linking (i.e. identifying names of tables and columns in natural language questions), generating SQL queries and even executing the SQL statements. In certain embodiments, the SQL agent system 200 can be used to implement one or more tools related to SQL generation, execution, and/or review (e.g., NL2SQL tool 104 as described with respect to FIG. 1). The SQL agent system 200 can include an SQL agent 202 capable of converting a natural language question into an SQL query.

A user 204 can participate in a chat 206 (also described herein as a conversation or an interaction) with the SQL agent 202. The user 204 may interact with the chat 206 via a user interface such as a graphical user interface or conversational user interface. As an example, the user 204 may provide input to the SQL agent 202 via a user interface element such as a chat window. The chat 206 can include one or more inputs from the user 204 and one or more responses from the SQL agent 202. The chat 206 may correspond to one or more chat sessions between the user 204 and the SQL agent 202. During the chat 206, the user 204 provides a natural language utterance that can be processed by the SQL agent 202. The natural language utterance can include a question related to a database or SQL generation.

One or more user inputs provided by the user 204 via the chat 206 are provided to the SQL agent 202. Included in the SQL agent 202 are a routing model 208, a memory store 210 and tools 212. The routing model 208 and memory store 210 receive user inputs such as natural language utterances from the chat 206. The memory store 210 can store a chat history for the user 204 and contextual information related to the user 204, the chat 206, and/or other pieces of information relevant to the NL2SQL operations such as in-context examples, APIs, external knowledge, and the like. The tools 212 can include functions, APIs, and trained machine learning models that can be used by the SQL agent 202 to interact with external systems (e.g., database 226, external knowledge bases) and/or generate SQL statements.

The routing model 208 may be or may make use of one or more generative artificial intelligence models such as LLMs. The routing model 208 can include a planning 214 component and an acting 216 component (i.e., trained task). Planning 214 includes generating a plan that comprises a sequence of steps for execution (acting 216), which includes executing the steps in a generated plan using one or more tools 212. In some examples, the routing model 208 may retrieve contextual information related to the user 204 and/or chat 206 from the memory store 210 during planning 214 to improve plan generation. Planning 214 may further include determining a new plan based on a result produced by acting 216 and the execution of a previous plan.

One or more tools 212 supported by the SQL agent 202 may be LLM-based tools configured to receive a prompt and generate a result based at least in part on the prompt. As an example, the tools 212 can include an LLM-based NL2SQL model 222 that generates an SQL statement based on a prompt including a natural language utterance provided by the user 204 (e.g., as described in FIG. 1). In some instances, the routing model 208 can generate a prompt based on a natural language utterance received from the user 204. In some examples, steps for generating a prompt can be included in a plan generated by planning 214 and the prompt may be generated by acting 216. A prompt can include a persona 218 and instructions 220. The persona 218 can be selected from a set of available personas (see Table 1 for a non-limiting list of exemplary personas). Including the persona 218 in a prompt for an LLM may improve the accuracy of generated responses and customize responses generated by an LLM to the needs of the user 204. In some examples, planning 214 may select a tool from the tools 212 based on the persona 218.

TABLE 1

| Example Persona | Example Description |
|---|---|
| Junior Developer | A user having limited to no experience in writing SQL queries |
| | who requires assistance in writing and optimizing SQL |
| | queries. |
| Expert Developer | A user with several years of experience writing SQL queries. |
| Business Analyst | A user with strong context about the needs of a company |
| | and who wants quick data insights without deep SQL |
| | knowledge. |
| Data Scientist | A user focused on extracting and analyzing data efficiently. |

Instructions 220 describe the knowledge bases and tools available to the SQL agent 202. Instructions 220 can be included in a prompt for LLM-based tools and may guide a tool to generate a response relevant to the preferences of the user 204. Additionally, or alternatively, the prompt can include a table schema, description of columns in the table schema, context, in-context examples, additional instructions, a user question, or any combination thereof. In some examples, context may include contextual information related to the user 204 and/or chat 206 history and may be retrieved from the memory store 210 by the routing model 208. The prompt may further include database schema information corresponding to a database 226.

The routing model 208 may provide the generated prompt to a tool from the tools 212 selected by planning 214. As an example, the NL2SQL model 222 receives a prompt provided by the routing model 208 and generates an SQL query based on the prompt. The NL2SQL model 222 can be trained to convert a natural language question into an SQL query to help the user 204 complete data related tasks. In some examples, the SQL query generated by the NL2SQL model 222 is returned to the user 204 via the chat 206. Additionally, or alternatively, the generated SQL query is provided to an SQL execution 224 tool that is configured to execute SQL queries on the database 226. SQL execution 224 may receive an SQL result from the database 226 and provide the SQL result to the routing model 208. The routing model 208 may provide the SQL result to the user 204 via the chat 206. In some implementations, the routing model 208 may identify an error in the SQL result or determine the SQL query and/or result does not correspond to user 204 needs and generate a new plan using planning 214 to correct the error or generate a new SQL query.

Additional examples of tools include, but are not limited to, schema resolution 228, schema linking 230, grammar check 232, and human as a tool 234. Schema resolution 228 may be configured to check for and/or fix any errors within an SQL statement. The SQL agent 202 may use schema resolution 228 after an SQL query is generated by the NL2SQL model 222. Schema linking 230 may be configured to identify proper references to schema values (e.g., tables, columns, condition values) based on schema information and query patterns. Schema linking 230 can include content-based schema linking for mapping values, and name-based schema linking for mapping table and column names for SQL generation. For large schemas, retrieval augmented generation (RAG)-based schema linking may be implemented to retrieve a relevant subset of the schema. Schemas can be stored in a knowledge base (e.g., memory store 210) and relevant schema information can be retrieved based on a natural language query provided by the user 204. In some implementations, the knowledge base includes external data stores and schema linking 230 can include performing a web search to identify relevant schema. The SQL agent 202 may be unable to resolve ambiguities during schema linking 230. In such examples, the SQL agent 202 can ask the user 204 clarifying questions to resolve the ambiguities and/or acquire missing information to resolve the ambiguities.

Also included in the tools 212 is a grammar check 232 that can review grammar of generated statements. Tools 212 can also include human as a tool 234. The SQL agent 202 may seek human input for clarification and disambiguation. Human as a tool 234 may be used to supplement one or more additional tools of the set of tools 212 with human input or intervention. Human as a tool 234 can include asking the user 204 or another user, such as a developer, for information to correct previous generations.

The SQL agent 202 may use a single tool or a combination of tools 212 to generate a response to the user 204. The routing model 208 can select a tool and/or generate a prompt for the selected tool based on a natural language utterance received via the chat 206. The routing model 208 receives an output from the selected tool based on the prompt and/or context provided to the selected tool. In some implementations, the output generated by the selected tool is provided to the user 204 via the chat 206 as received by the routing model 208 (i.e., without additional modifications to the output).

In some implementations, the routing model 208 responds to the user 204 who provided the original query as part of a two-way conversation (e.g., via chat 206). The natural language response may include a natural language component (e.g., answers to questions, information, etc.) and/or a logical form component (e.g., an SQL query). In some embodiments, the routing model 208 may generate a natural language response containing the output generated by the selected tool. The routing model 208 may be configured to generate the natural language response and/or may use a response generation tool to generate the natural language response. The natural language response can be provided to the user 204 via the chat 206. In some implementations, the SQL agent 202 may provide a visualization of the generated output through a plot, table, graph, and the like, via the chat 206. As a particular example, the SQL agent 202 can use the schema linking 230 tool to identify names of tables and columns in a natural language utterance (which is an example of NL utterance 102 with respect to FIG. 1) provided by the user 204 and then generate an SQL query using the NL2SQL model 222 based on the identified table and column names. The SQL query may be provided to the user 204 via the chat 206 as generated by the NL2SQL model 222. In some implementations, the routing model 208 may generate a natural language response containing the SQL query and provide the natural language response to the user 204 via the chat 206.

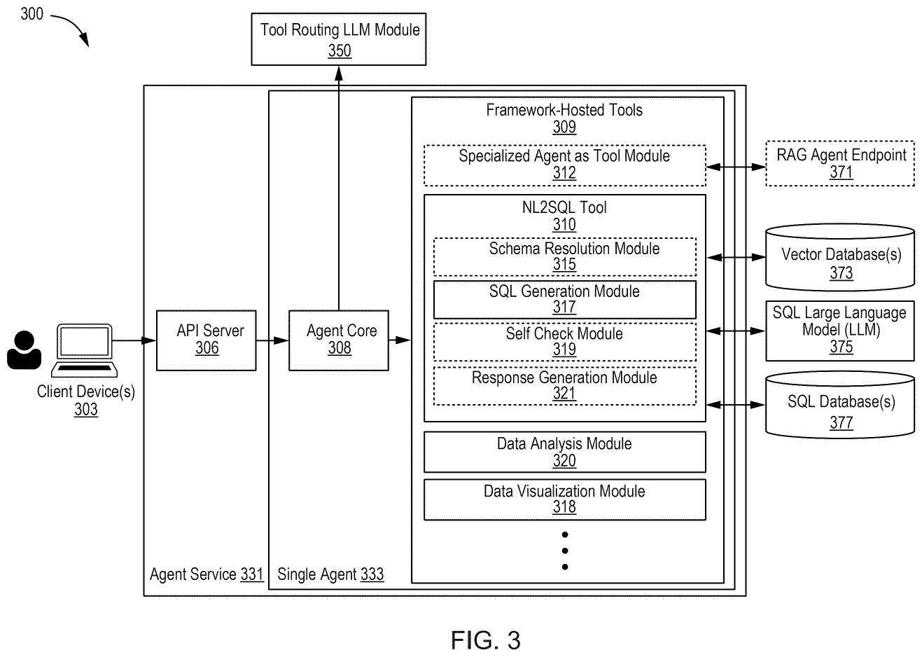

FIG. 3 depicts a simplified diagram 300 for an example generative AI SQL agent, according to various embodiments. As discussed in regard to FIGS. 1 and 2, user(s) (e.g., users 101 or 204) may use client device(s) 303 to submit a NL utterance and/or question to an agent service 331 by way of an API server 306. The API server 306 may be a software, hardware, and/or firmware component that enables one or more applications (e.g., cloud applications) to communicate as an intermediary between the client device(s) 303 and the agents. The API server 306 may identify a specific agent (e.g., single agent 333), or multiple agents, to handle the instance (e.g., by agent specialty or user preference) and select an agent core 308. The agent core 308 may be configured with pass-through routing or, if additional tools are included in the agent, a specific routing (e.g., ReAct routing) may be implemented. The agent core 308 may handle multi-step (or iterated) SQL resolution, generation, and/or execution. By way of a non-limiting example, in analytical use cases using unique software packages (e.g., Oracle™ Analytics Cloud (OAC), Tableau™, etc.), a single analytical dashboard may generate multiple SQL queries using output from previous inputs (e.g., by way of Churn analysis, Funnel analysis, cohort analysis, etc.). The agent core 308 may access a tool routing LLM module 350 in order to identify, select, utilize, and/or train one or more LLM(s) that may suitably apply to the utterance received from the client device(s) 303.

The agent core 308 may include one or more framework-hosted tools 309 for addressing various functions. For example, the framework-hosted tools 309 may include a specialized agent as tool module 312 which may be in communication with a retrieval-augmented generation (RAG) endpoint 371. The RAG endpoint 371 may improve the efficacy of one or more LLMs by suitably leveraging various sources of data. For example, retrieving data/documents relevant to the utterance (e.g., question, statement, task, etc.) and providing them as context for the LLM as either labeled or unlabeled data. The RAG endpoint 371 may provide support to the agent core and maintain up-to-date information based at least in part on other trained LLMs and/or agent cores (not depicted), and/or access domain-specific knowledge.

Included in the framework-hosted tools 309 is an NL2SQL tool 310, which is an example of the NL2SQL model 222 with respect to FIG. 2. The NL2SQL tool 310 includes, without limitation, modules 315, 317, 319, and 321. Schema resolution module 315 may function to receive input from the client device(s) 303 requesting the NL2SQL tool 310 check one or more schemas for any errors (e.g., syntax errors, semantic errors, etc.) and fix the errors (or recommend a fix). The agent core 308 may provide explanations to the client device(s) 303 about each fix performed. The explanations may be provided in natural language. In some examples, the NL2SQL tool 310 may attempt to automatically resolve the errors if possible and ask clarification questions (e.g., as output to the client device(s) 303) where suitably needed. If the error cannot be resolved, the error may be displayed to the user(s). As an example, the different types of errors that an agent core 308 (which is an example component of SQL agent 202 with respect to FIG. 2) may return can include syntax errors and semantic errors. The schema resolution module 315 may reference one or more vector database(s) 373 to obtain and/or store schema.

Also included in the NL2SQL tool 310 is an SQL generation module 317. The SQL generation module 317 may take the utterance received from the client device(s) 303 and construct an SQL query. To do this, the NL2SQL tool 310 may access one or more generative artificial intelligence models such as LLMs (e.g., SQL LLM 375) that may have been trained on generating SQL queries. An LLM may receive the utterance from the NL2SQL tool 310 and may translate the utterance into a relevant SQL query. The SQL generation module 317 may then pass the received SQL query from the LLM to one or more additional modules. For example, the SQL generation module 317 may pass the SQL query returned from the LLM to a response generation module 321. The response generation module 321 may append the SQL query (optionally along with information related to the utterance) and return the SQL query to the client device(s) 303. In addition, or alternatively, the response generation module 321 may pass the SQL query to one or more SQL database(s) 377 to retrieve information related to the utterance. The NL2SQL tool 310 may utilize a self-check module 319, which may function with any one or more of the other modules. The self-check module 319 may automatically try to resolve errors associated with the SQL query and/or LLM prompt containing the utterance. The self-check module 319 may ask clarifying questions to the client device(s) 303 and/or the LLM to resolve the errors.

The framework-hosted tools 309 include data analysis module 320 and a data visualization module 318. Each of 320 and 318 may function with any of the modules of the framework-hosted tools 309 in order to analyze and display the various analytics. The analytics may include analysis of schema, SQL queries, LLM accuracy, recommendations, or suitable equivalents.

### Training, Testing, and Deployment of a NL2SQL Model

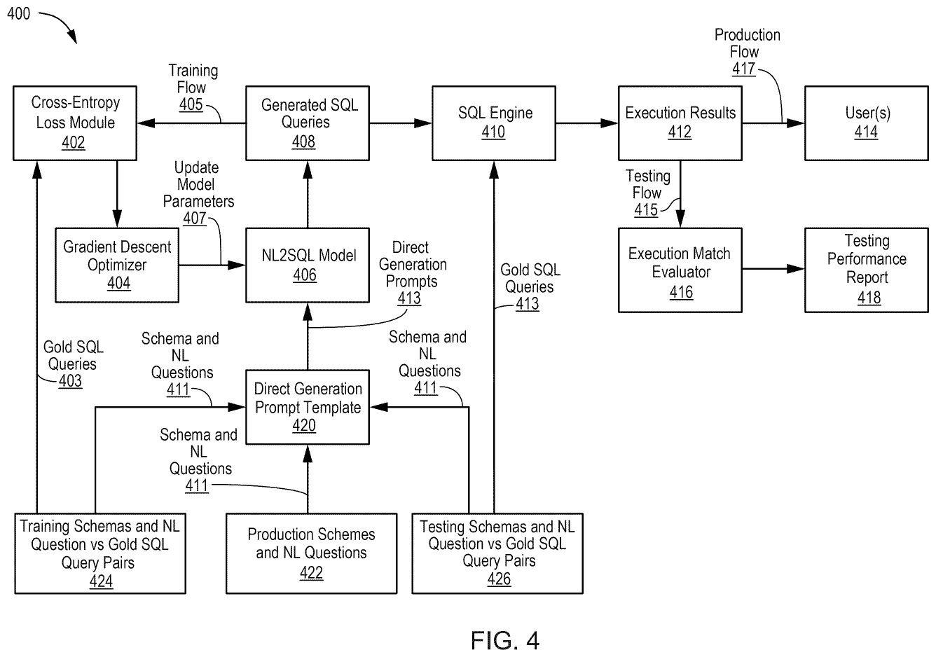

FIG. 4 depicts a simplified block diagram 400 for training, testing, and deployment or production of an NL2SQL Model, according to various embodiments. This simplified overview of training, testing, and inference depicts flows for a NL2SQL direct generation model (however it should be understood that similar steps could be implemented for a generation model that translates to an intermediate database query language which can be used to generate a query in a specific system query language or other for a generation model that translates to another programming language such as PRQL, GraphQL, WebAssembly, Python, R, Java, N1QL, and the like). A NL2SQL model is powered by a machine learning model (e.g., an LLM) configured to convert a NL utterance (e.g., a query posed by a user using an agent) into a logical form, for example, an intermediate database query language such as OMRL or a system query language format, such as SQL or PGQL. If an intermediate database query language format is used then the intermediate database query language can be used to generate a query in a specific system query language (e.g., SQL), which can then be executed for querying a system such as a database to obtain an answer to the user's utterance. If a system query language format is used, then the system query language can be directly executed for querying a system such as a database to obtain an answer to the user's utterance.

One goal of the NL2SQL model is to allow end users to interact with their systems, (e.g., SQL databases) through natural language rather than program specific language queries such as SQL queries. Using a NL2SQL service, users such as business analysts can extract information from their systems without thorough knowledge of a specific programming language and system schemas. The NL2SQL model is an LLM, which is an advanced type of artificial intelligence model designed to understand and generate human language. These models are trained on vast amounts of text data and leverage deep learning techniques to perform a variety of natural language processing tasks, such as text generation, translation, summarization, and answering questions. In the description below, the LLM (NL2SQL model) is designed and trained to convert natural language queries into SQL queries. This involves understanding the semantics of the natural language input, mapping it to the corresponding database schema, and generating a syntactically and semantically correct SQL query that can retrieve the desired information from the database. However, it should be understood that similar techniques could be implemented for other programming languages including other system query languages such as PGQL and/or other intermediate logical forms such as MRL or OMRL.

The input to the Natural Language-to-SQL (NL2SQL) model is a natural language question.

For example:
“Get me the list of employees from Australia.”

The main output from the NL2SQL model is an SQL query.

For example:
SELECT employee_id, employee_name FROM Employee WHERE country=“Australia”. Another important input to the NL2SQL model 406 is the database schema that helps the model to identify relevant tables and columns in the SQL output construction.

For example:

```
CREATE TABLE Employee (
  employee_id TEXT(12) NOT NULL,
  employee_name TEXT(100) NOT NULL,
  birth_date DATE NOT NULL,
  hire_date DATE NOT NULL,
  country TEXT(100),
  ...
)
CREATE TABLE JobTitle (
  ...
)
...
```

Described herein is a pre-trained NL2SQL model developed based on instruction fine-tuning of LLMs to provide this NL2SQL direct generation capability, e.g., the mapping of (Database Schema, NL Question)>SQL Query. Below is the summary of how the NL2SQL direct generation capability is implemented via instruction fine-tuning.

Data to train a NL2SQL model includes multiple database schemas defined as SQL CREATE TABLE statements:
Table names
Column names and types
Primary and foreign keys
Other constraints

### One Database Schema Example:

```
CREATE TABLE aircraft (
  aid NUMERIC(9, 0),
  name TEXT(30),
  distance NUMERIC(6, 0),
  PRIMARY KEY (aid)
)
CREATE TABLE employee (
  eid NUMERIC(9, 0),
  name TEXT(30),
  salary NUMERIC(10, 2),
  PRIMARY KEY (eid)
)
CREATE TABLE certificate (
  eid NUMERIC(9, 0),
  aid NUMERIC(9, 0),
  PRIMARY KEY (eid, aid),
  FOREIGN KEY(aid) REFERENCES aircraft (aid),
  FOREIGN KEY(eid) REFERENCES employee (eid)
)
CREATE TABLE flight (
  flno NUMERIC(4, 0),
  origin TEXT(20),
  destination TEXT(20),
  distance NUMERIC(6, 0),
  departure_date DATE,
  arrival_date DATE,
  price NUMERIC(7, 2),
  aid NUMERIC(9, 0),
  PRIMARY KEY (flno),
  FOREIGN KEY(aid) REFERENCES aircraft (aid)
)
```

Each database schema can be associated with multiple pairs of natural language questions and corresponding SQL queries.

### Example of NL Question and Corresponding SQL Query:

NL Question: “What is the name of the employee with salary greater than 100000 and with the most certificates to fly planes more than 5000?”
SQL Query: “SELECT T1.name FROM employee AS T1 JOIN certificate AS T2 ON T1.eid=T2.eid JOIN aircraft AS T3 ON T2.aid=T3.aid WHERE T3.distance>5000 AND T1.salary>100000 GROUP BY T1.eid ORDER BY count (*) DESC LIMIT 1”

Each question-query pair and its corresponding database schema are populated following a NL2SQL direct generation prompt template to create one direct generation prompt example:

### Direction NL2SQL Generation Prompt Example:

Given an input Question, create a syntactically correct Oracle SQL query to run.
Pay attention to using only the column names that you can see in the schema description.
Be careful to not query for columns that do not exist. Also, pay attention to which column is in which table.
Please double check the SQL query you generate.
DO NOT use alias in the SELECT clauses.
Only use the tables listed below.

```
CREATE TABLE aircraft (
  aid NUMERIC(9, 0),
  name TEXT(30),
  distance NUMERIC(6, 0),
  PRIMARY KEY (aid)
)
CREATE TABLE employee (
  eid NUMERIC(9, 0),
  name TEXT(30),
  salary NUMERIC(10, 2),
  PRIMARY KEY (eid)
)
CREATE TABLE certificate (
  eid NUMERIC(9, 0),
  aid NUMERIC(9, 0),
  PRIMARY KEY (eid, aid),
  FOREIGN KEY(aid) REFERENCES aircraft (aid),
  FOREIGN KEY(eid) REFERENCES employee (eid)
)
CREATE TABLE flight (
  flno NUMERIC(4, 0),
  origin TEXT(20),
  destination TEXT(20),
  distance NUMERIC(6, 0),
  departure_date DATE,
  arrival_date DATE,
  price NUMERIC(7, 2),
  aid NUMERIC(9, 0),
  PRIMARY KEY (flno),
  FOREIGN KEY(aid) REFERENCES aircraft (aid)
)
```

Question: What is the name of the employee with salary greater than 100000 and with the most certificates to fly planes more than 5000?
SQL: “SELECT T1.name FROM employee AS T1 JOIN certificate AS T2 ON T1.eid=T2.eid JOIN aircraft AS T3 ON T2.aid=T3.aid WHERE T3.distance>5000 AND T1.salary>100000 GROUP BY T1.eid ORDER BY count (*) DESC LIMIT 1”

The prompt example can then be sent to the LLM model to generate the SQL query during training and testing phases. The gold (ground truth) SQL Query: “SELECT T1.name FROM employee AS T1 JOIN certificate AS T2 ON T1.eid=T2.eid JOIN aircraft AS T3 ON T2.aid=T3.aid WHERE T3.distance>5000 AND T1.salary>100000 GROUP BY T1.eid ORDER BY count (*) DESC LIMIT 1” is used to evaluate the generated SQL query using a loss function such as cross-entropy loss (e.g., using cross-entropy loss module 402) in training and a performance metric such as execution match in testing. For execution match, both gold and generated SQL queries are executed on the database using the SQL engine. The result sets of the gold and generated SQL queries are compared to check if the results sets are a match.

The training and testing flows start at either a training schemas and NL question versus (vs.) gold SQL query pairs block 424 or a testing schemas and NL question versus gold SQL query pairs block 426, respectively, where training and testing data is collected (e.g., acquired or accessed). The data collection can include exploring various data sources such as public datasets, private data collections, or real-time data streams, depending on a project's needs. In some instances, a data source is a public or online repository of information or examples pertinent to a general or target domain space. Many domains have publicly available datasets provided by governments, universities, or organizations. For example, many government and private entities offer datasets on healthcare, environmental data, and more through various portals. For proprietary needs, data might be available through partnerships or purchases from private companies that specialize in data aggregation. In other instances, a data source is a private repository of information or examples pertinent to a general or target domain space. For example, a data source can be a storage device that stores various schemas and natural language questions (including labels for corresponding gold SQL queries 403, 413).

Preprocessing may be performed on the training and testing data (from 424, 426 respectively), serving as a bridge between raw data acquisition and effective model training. The primary objective of preprocessing is to transform raw data into a format that is more suitable and efficient for analysis, ensuring that the data fed into machine learning algorithms is clean, consistent, and relevant. This step can be useful because raw data often comes with a variety of issues such as missing values, noise, irrelevant information, and inconsistencies that can significantly hinder the performance of a model. By standardizing and cleaning the data beforehand, preprocessing helps in enhancing the accuracy and efficiency of the subsequent analysis, making the data more representative of the underlying problem the model aims to solve. At block 420, the preprocessing includes populating the training and testing data (e.g., schema and NL questions 411) into the direct generation prompt template (as described above) to create direct generation prompts 413 from which the NL2SQL model 406 generates SQL queries.

Once collected, generated, preprocessed, and/or labeled, the data may then be split into the training and testing datasets. The training and testing datasets may comprise the raw data and/or preprocessed data. The training and testing datasets are typically split into at least three subsets of data: training, validation, and testing. The training set is used to fit the model, where the machine learning model learns to make inferences based on the training data. The validation set, on the other hand, is utilized to tune hyperparameters and prevent overfitting by providing a sandbox for model selection. Finally, the test set serves as a new and unseen dataset for the model, used to simulate real-world application and evaluate the final model's performance. The process of splitting ensures that the model can perform well not just on the data it was trained on, but also on new, unseen data, thereby validating and testing its ability to generalize.

Various techniques can be employed to split the data effectively, with each method aiming to maintain a good representation of the overall dataset in each subset. A simple random split (e.g., a 70/20/10%, 80/10/10%, or 60/25/15%) is the most straightforward approach, where examples from the data are randomly assigned to each of the three sets. However, more sophisticated methods may be necessary to preserve the underlying distribution of data. For instance, stratified sampling may be used to ensure that each split reflects the overall distribution of a specific variable, particularly useful in cases where certain categories or outcomes are underrepresented. Another technique, k-fold cross-validation, involves rotating the validation set across different subsets of the data, maximizing the use of available data for training while still holding out portions for validation. These methods help in achieving more robust and reliable model evaluation and are useful in the development of predictive models that perform consistently across varied datasets.

At this stage, hyperparameters may also be acquired or set for the training and testing. The hyperparameters control the overall behavior of the models. Unlike model parameters that are learned automatically during training, hyperparameters are set before training begins and have a significant impact on the performance of the model. For example, in an LLM, hyperparameters include the learning rate, batch size, number of layers, number of attention heads, hidden layer size, dropout rate, weight decay, sequence length, and embedding dimension, among others. These settings can determine how quickly a model learns, its capacity to generalize from training data to unseen data, and its overall complexity. Correctly setting hyperparameters is important because inappropriate values can lead to models that underfit or overfit the data. Underfitting occurs when a model is too simple to learn the underlying pattern of the data, and overfitting happens when a model is too complex, learning the noise in the training data as if it were signal.

At block 420, the direct generation prompts (for the training and testing data) are input into the NL2SQL model (at block 406) via a training and testing subsystem for training and/or testing. The training and testing subsystem is comprised of a combination of specialized hardware and software to efficiently handle the computational demands required for training, validating, and testing a machine learning model. On the hardware side, high-performance GPUs (Graphics Processing Units) may be used for their ability to perform parallel processing, drastically speeding up the training of complex models, especially deep learning networks. CPUs (Central Processing Units), while generally slower for this task, may also be used for less complex model training or when parallel processing is less critical. TPUs (Tensor Processing Units), designed specifically for tensor calculations, provide another level of optimization for machine learning tasks. On the software side, a variety of frameworks and libraries may be utilized, including TensorFlow, PyTorch, Keras, and scikit-learn. These tools offer comprehensive libraries and functions that facilitate the design, training, validation, and testing of a wide range of machine learning models across different computing platforms, whether local machines, cloud-based systems, or hybrid setups, enabling developers to focus more on model architecture and less on underlying computational details.

Training is the initial phase of developing machine learning models such as the NL2SQL model where the model learns to generate SQL queries (output at block 408) based on the data training data (e.g., training flow 405) provided from the training datasets. During this phase, the model iteratively adjusts its internal model parameters to achieve a preset optimization condition. At blocks 402 and 404, the preset optimization condition can be achieved by minimizing the difference between the model output (e.g., generated SQL queries) and the ground truth labels (e.g., gold SQL queries) in the training data. In some instances, the preset optimization condition can be achieved when the preset fixed number of iterations or epochs (full passes through the training dataset) is reached. In some instances, the preset optimization condition is achieved when the performance on the validation dataset stops improving or starts to degrade. In some instances, the preset optimization condition is achieved when a convergence criterion is met, such as when the change in the model parameters falls below a certain threshold between iterations. This process, known as fitting, is fundamental because it directly influences the accuracy and effectiveness of the model.

In an exemplary training phase performed by the training and testing subsystem, the training subset of data is input into the machine learning algorithms to find a set of model parameters (e.g., weights, coefficients, trees, feature importance, and/or biases) that minimizes or maximizes an objective function (e.g., a loss function, a cost function, a contrastive loss function, a cross-entropy loss function, etc.). To train the machine learning algorithms to achieve accurate predictions, “errors” (e.g., a difference between a predicted label and the ground truth label) need to be minimized. In order to minimize the errors (blocks 402 and 404), the model parameters 407 can be configured to be incrementally updated by minimizing the objective function over the training phase (“optimization”). Various different techniques (e.g., stochastic gradient descent) may be used to perform the optimization. For example, to train machine learning algorithms such as an LLM, optimization can be done using back propagation. The current error is typically propagated backwards to a previous layer, where it is used to modify the weights and bias in such a way that the error is minimized. The weights are modified using the optimization function. Other techniques such as random feedback, Direct Feedback Alignment (DFA), Indirect Feedback Alignment (IFA), Hebbian learning, and the like can also be used to update the model parameters in a manner as to minimize or maximize an objective function. This cycle is repeated until a desired state (e.g., a predetermined minimum value of the objective function) is reached.

Validating is another phase of training where the model is checked for deficiencies in performance and the hyperparameters are optimized based on validation data provided from the training datasets. The validation data helps to evaluate the model's performance, such as accuracy, precision, recall, or F1-score, to gauge how well the model is likely to perform in real-world scenarios. Hyperparameter optimization, on the other hand, involves adjusting the settings that govern the model's learning process (e.g., learning rate, number of layers, size of the layers in neural networks) to find the combination that yields the best performance on the validation data. One optimization technique is grid search, where a set of predefined hyperparameter values are systematically evaluated. The model is trained with each combination of these values, and the combination that produces the best performance on the validation set is chosen. Although thorough, grid search can be computationally expensive and impractical when the hyperparameter space is large. A more efficient alternative optimization technique is random search, which samples hyperparameter combinations from a defined distribution randomly. This approach can in some instances find a good combination of hyperparameter values faster than grid search. Advanced methods like Bayesian optimization, genetic algorithms, and gradient-based optimization may also be used to find optimal hyperparameters more effectively. These techniques model the hyperparameter space and use statistical methods to intelligently explore the space, seeking hyperparameters that yield improvements in model performance.

Once a machine learning model has been trained and validated, it undergoes a final evaluation using the test data provided from the training and testing datasets, which is a separate subset of the data that has not been used during the training or validation phases. This step is important as it provides an unbiased assessment of the model's performance in simulating production operation. The test dataset serves as new, unseen data for the model, mimicking how the model would perform when deployed in actual use. During testing, the model's generated SQL queries (output at block 425) can be compared against the true values (e.g., gold SQL queries) in the test dataset using various performance metrics such as accuracy, precision, recall, and mean squared error, depending on the nature of the problem. Additionally, or alternatively, at blocks 410 and 412, the gold and generated SQL queries are executed on the corresponding database using an SQL engine (execution engine; see below in Production Flow section for detailed description) to obtain execution results. At block 416, the result sets (e.g., testing flow 415) from executing the gold and generated SQL queries are compared using an execution match evaluator to compute accuracy execution match metrics. This process helps to verify the generalizability of the model-its ability to perform well across different data samples and environments-highlighting potential issues like overfitting or underfitting and ensuring that the model is robust and reliable for practical applications. The NL2SQL model is fully validated and tested once the outputs have been reported (e.g., testing performance report) and deemed acceptable by user defined acceptance parameters (block 418). Acceptance parameters may be determined using correlation techniques such as Bland-Altman method and the Spearman's rank correlation coefficients and calculating performance metrics such as the error, accuracy, precision, recall, receiver operating characteristic curve (ROC), etc.

The production flow starts at block 422 where production schemas and natural language utterances (real-world input data) are input into the NL2SQL model via a production subsystem for inference. The production subsystem is comprised of various components for deploying machine learning models such as the NL2SQL model in a production environment. In some instances, the NL2SQL resides as a component of a larger system or service (e.g., use with an agent as described with respect to FIGS. 1-3). In some instances, the NL2SQL model and/or the inferences can be used by downstream applications to provide further information. For example, the inferences can be used to hold a conversation with a user as part of an agent or can be used to provide data analysis to a user via an analytical service such as analytics cloud-based service. Deploying the NL2SQL model includes moving the model(s) from a development environment (e.g., the training and testing subsystem, where it has been trained, validated, and tested), into a production environment where it can make inferences on real-world data (e.g., input data). This step typically starts with the model being saved after training, including its parameters and configuration such as final architecture and hyperparameters. It is then converted, if necessary, into a format that is suitable for deployment, depending on the deployment environment. For instance, a model trained in a developmental computing environment such as Python might be converted into a Java-friendly format for integration into a larger enterprise application. Deployment can be conducted on various platforms, including on-premises servers or cloud environments like OCI, AWS, Azure, Google, etc. (see below discussion of various computer and cloud architectures with respect to FIGS. 11-15).

At block 420, the input data (e.g., production schemas and natural language utterances) are populated into the direct generation prompt template (as described above) to create direct generation prompts from which the NL2SQL model generates SQL queries. At block 406, the direct generation prompt is input into the NL2SQL model via the production subsystem for inference. The NL2SQL model then translates the natural language utterance into an SQL query. This translation process includes the NL2SQL model first parsing the natural language utterance to understand the user's intent. This involves identifying the key components of the request, such as the desired action (e.g., SELECT, UPDATE), the entities involved (e.g., tables, columns), and any conditions or filters. For example, if the user says, “Show me all the customers who signed up in the last month,” the model identifies the action (retrieve data), the entities (customers), and the condition (signed up in the last month). The NL2SQL model then maps the identified entities and conditions to the corresponding elements in the schema (e.g., database schema). This step requires knowledge of the database structure, including table names, column names, and data types (which is included within the direct generation prompt template). Continuing with the example, the model needs to know that “customers” refers to a specific table, and “signed up” corresponds to a column (e.g., ‘signup_date’) in that table. Using the parsed intent and mapped schema elements, the NL2SQL model constructs a syntactically correct SQL query. This involves selecting the appropriate SQL keywords and structuring the query according to SQL syntax rules. For the example request, the LLM would generate the following SQL query:

```
  “sql
  SELECT * FROM customers WHERE signup_date >= DATE_SUB(CURDATE( ), INTERVAL 1
MONTH);
“
```

The NL2SQL model may then validate the constructed SQL query to ensure it aligns with the user's intent and adheres to the database schema. This could involve checking for syntax errors, ensuring the correct use of SQL functions, and verifying the query against the schema. If necessary, the NL2SQL model refines the query to better match the user's request or correct any identified issues. This step might also involve asking the user for clarification if the original utterance was ambiguous. Once generated and optionally validated, the NL2SQL model outputs the SQL queries at block 425.

At blocks 410 and 412, the SQL queries are executed on the corresponding database using an SQL engine (execution engine) to obtain execution results. The execution engine executes the SQL queries on a database by following a multi-step process that involves parsing, optimizing, and executing the query. Initially, an SQL query is parsed to create an internal representation, typically an Abstract Syntax Tree (AST), which outlines the structure of the query. The engine then consults the database schema to validate the query, ensuring that all referenced tables, columns, and data types exist and are correctly used. Once validated, the query undergoes optimization, where the execution engine determines the most efficient way to access and manipulate the data, often through the use of query optimization techniques such as indexing, join algorithms, and query rewriting. This step aims to minimize resource usage and execution time. Finally, the optimized query is executed against the database. The execution engine processes the query plan, retrieves the required data from the storage engine, and applies any necessary transformations, such as filtering, sorting, or aggregating. The resulting data is then formatted and returned to the user (or user(s)) by way of production flow 417 or application that issued the query (block 414), completing the process of data retrieval.

To manage and maintain its performance, a deployed model such as the NL2SQL model may be continuously monitored to ensure it performs as expected over time. This involves tracking the model's inference accuracy, response times, and other operational metrics. Additionally, the model may require retraining or updates based on new data or changing conditions in the environment it is applied in. This can be useful because machine learning models can drift over time due to changes in the underlying data the models are making predictions on-a phenomenon known as model drift. Therefore, maintaining a machine learning model in a production environment often involves setting up mechanisms for performance monitoring, regular evaluations against new test data, and potentially periodic updates and retraining of the model to ensure it remains effective and accurate in making predictions.

### Ambiguity Detection and Explanation in Text-To-SQL Systems

As discussed above, an NL2SQL system is powered by a deep learning model (e.g., an NL2SQL model such as an LLM) configured to convert a natural language (NL) utterance (e.g., a query posed by a user using a digital assistant or chatbot) into a structured query language (SQL) query. As data-driven applications increasingly rely on automated query generation, there is a need for methods that can reliably identify and explain ambiguity in user queries and their contextual information. The present disclosure introduces an approach that addresses these challenges by outlining processes and systems designed to facilitate ambiguity detection, clarification, and enhanced query interpretation.

Throughout this disclosure, the terms “SQL Query” and “SQL Queries” are used to describe a structured command or statement written in Structured Query Language (SQL) that is used to retrieve, manipulate, or manage data within a relational database. However, referencing SQL queries in this disclosure should not be considered limiting, and any suitable equivalent, including queries written in equivalent and/or similar languages or systems that perform equivalent and/or similar data operations, is anticipated within the scope of this disclosure.

Throughout this disclosure, the term “Generative Model” is used to describe a computational system or algorithm designed to generate outputs, such as text, images, or code, based on learned patterns and relationships from training data, often employing techniques like neural networks or probabilistic modeling. However, this definition should not be considered limiting, and any suitable equivalent, including machine learning models utilizing different architectures or methodologies to produce generative outputs, is anticipated within the scope of this disclosure.

Throughout this disclosure, the term “Natural Language Utterance” or “Natural Language Query” is used to describe a spoken, signed (e.g., American/French/British Sign Language, etc.), or written expression in a human language, that conveys a users intention or query and can be processed or interpreted by computational systems for tasks like translation, information retrieval, or conversational AI. However, this definition should not be considered limiting, and any suitable equivalent, including alternative forms of human language and/or equivalent machine language (or code) input or communication, is anticipated within the scope of this disclosure.

### Technical Challenges

Ambiguity in user utterances presents a fundamental technical challenge for natural language to query systems. Ambiguity arises because utterances often lack specificity or reference elements that are unclear, missing, or undefined within the schema or context. In practical deployment, ambiguity manifests when an utterance can be mapped to several distinct operations, database columns, tables, or values, or when the utterance lacks the specificity needed to be understood within the given schema. The absence of a universal and precise definition of ambiguity further complicates the task, resulting in inconsistent interpretation and evaluation. Empirical studies demonstrate that human annotators agree only 62% of the time on whether an utterance is ambiguous for a given database, while advanced models such as GPT-3.5 demonstrate an even lower agreement rate of 44%. This inconsistency reflects the absence of a clear and universal definition of ambiguity, as natural language utterances frequently allow for multiple interpretations. Without a refined definition of ambiguity, the evaluation of large language models' precision and recall for ambiguity detection remains impractical. The subjectivity and context sensitivity inherent in ambiguity further complicate system development and limit the effectiveness of conventional evaluation metrics.

Contextual adherence and semantic interpretation present substantial challenges for current ambiguity detection and query interpretation systems. Current systems frequently depend on static prompts, rigid schema matching, or fixed sets of predefined ambiguity categories. Such approaches do not capture nuanced or domain-specific semantics encountered in practical deployments. For example, terms such as “trade” or “margin” may hold diverse meanings across domains, causing models to misinterpret user intent. Even when users provide explicit domain-specific instructions, these systems often default to pre-trained or generalized knowledge rather than honoring user guidance, resulting in incorrect query generation for context-dependent terms. This inability to balance adherence to schema context with common-sense reasoning creates operational challenges and reduces overall system reliability.

The development and maintenance of domain-specific instructions or configurations for ambiguity detection impose a substantial operational burden and demand significant manual effort and subject matter expertise. Manual intervention is generally necessary to ensure the system accounts for evolving terminology, schema changes, and domain-specific semantics. This process is resource-intensive, time-consuming, and does not scale efficiently as domains evolve or new domains are introduced. The need for ongoing refinement and frequent updates to instructions further increases operational complexity, and current natural language to query systems do not offer automated or practical tools to facilitate efficient domain adaptation. As a result, these systems are less responsive to real-world business needs and less effective in maintaining accuracy and reliability over time.

High-quality datasets are essential for the effective detection, measurement, and resolution of ambiguity in natural language to query systems. Existing benchmark datasets, including both synthetic and real-world examples, introduce significant technical limitations that undermine the reliability of ambiguity detection. Synthetic datasets often lack realistic context and fail to capture the common-sense reasoning required for practical deployments, while real-world datasets typically suffer from poor category typing, annotation inconsistency, and insufficient coverage of domain-specific ambiguity. Current benchmark datasets, such as Ambrosia and AmbiQT, frequently employ vague or linguistically focused definitions of ambiguity, omit actionable explanations or clarification guidance, and may reflect author bias or lack rigorous validation standards. Annotation quality remains inconsistent, with insufficient context definitions and limited mechanisms for peer review, resulting in datasets that do not accurately represent the challenges encountered in production environments. These limitations extend beyond ambiguity detection, affecting the training and evaluation of machine learning models and constraining their utility in real-world deployments. As a result, advanced models evaluated on these datasets exhibit poor recall and precision for ambiguous queries, and the lack of robust, explanatory, and representative datasets restricts the ability to measure or improve key metrics such as ambiguity recall and unambiguous precision.

Approaches commonly used for ambiguity detection rely on rigid categorization, strict adherence to schema context, and limited involvement of human reviewers. These methods lack the flexibility to accommodate domain-specific ambiguity and do not incorporate dynamic mechanisms for updating prompts, expanding detection criteria, or integrating new ambiguity types as schema definitions and business logic evolve. Minimal support exists for human-in-the-loop review or the systematic prioritization and explanation of ambiguous utterances, which limits the capacity to resolve uncertainty and support user clarification. The absence of actionable suggestions or clarification guidance leaves ambiguity unresolved, contributing to the generation of inaccurate or erroneous programming language queries and increasing the risk of syntax errors in practical deployments.

In summary, the technical challenges outlined above suggest that a universal definition and interpretation of ambiguity may not be achievable across all use cases for natural language to query systems. Accordingly, effective ambiguity detection methods are likely to benefit from a flexible approach that balances adherence to schema context with the application of common-sense reasoning. The use of configurable parameters such as a context adherence factor, dynamic prompt updates, and minimal training data for domain adaptation enables improved identification and resolution of ambiguous utterances. Enhanced support for explainability, including the generation of clear explanations and actionable suggestions for resolving ambiguity, facilitates human review and decision-making. The application of ambiguity scoring and robust evaluation metrics, such as ambiguous recall and unambiguous precision, assists in prioritizing ambiguous cases by severity and advances the reliability and accuracy of automated programming language query generation from natural language.

### Technical Solution

In order to address the aforementioned challenges and others, disclosed herein is a framework for ambiguity detection and resolution in natural language to query systems. The framework employs a configurable context adherence parameter, referred to as the context adherence factor, to provide a dynamic and tunable approach for balancing strict adherence to schema or context with the application of common-sense reasoning. The context adherence factor operates on a continuous scale ranging from zero to one and enables adjustment of system behavior between exclusive reliance on explicit schema information and the incorporation of general world knowledge when determining whether a natural language utterance is ambiguous or can be resolved through inference. By enabling this level of control and adaptability, the context adherence factor addresses the challenge of inconsistent and context-sensitive ambiguity, supporting more reliable and accurate interpretation of natural language utterances in diverse querying scenarios.

The context adherence factor allows system operators, developers, or subject matter experts to tailor the behavior of ambiguity detection according to specific use cases or domain requirements. When set to a stricter value (e.g., 1), the system strictly follows the schema or context, flagging any utterance as ambiguous if the schema does not provide sufficient detail for unambiguous interpretation. At intermediate settings, the system balances context-based reasoning with common-sense inference, and at less strict values (e.g., 0), the system primarily relies on general language understanding, making reasonable assumptions to clarify queries in the absence of explicit schema information. This tunable parameter directly addresses the technical challenge of inconsistent ambiguity definition and low agreement rates among annotators and models, providing an operationalized mechanism for reproducibly controlling ambiguity detection behavior across evolving domains.

The framework further incorporates an LLM-driven iterative optimization process for dynamic learning and refinement of ambiguity detection criteria. Leveraging an LLM as an optimizer, the system is designed to iteratively learn, adapt, and expand its set of domain-specific ambiguity categories and detection instructions using labeled training data and subject matter expert feedback. Labeled examples having natural language utterances, associated database context, ambiguity labels, and explanatory reasoning are used to train and calibrate the system. When an utterance does not align with predefined ambiguity categories, the system evaluates whether the ambiguity can be resolved through common-sense reasoning or, if not, dynamically introduces new categories and instructions to improve detection capability. This process supports continuous improvement and domain adaptation with minimal manual intervention, mitigating the operational burden and scaling challenges present in prior systems.

To further enhance ambiguity detection and resolution, the framework applies a structured classification scheme to ambiguous utterances. Ambiguity may be categorized according to types such as context or schema gaps, query vagueness, calculation scope uncertainty, domain-term ambiguity, and logical contradiction, among others. For each input utterance, the system assigns an ambiguity score that reflects the probability or confidence that the utterance is ambiguous given the current schema and configuration. The framework also generates explanations that specify the source of ambiguity, identify any clarifications required, and, where appropriate, propose follow-up questions to facilitate resolution. These features collectively enable actionable handling of ambiguity and support human-in-the-loop workflows, allowing subject matter experts to review system reasoning, provide targeted feedback, and further refine ambiguity detection and resolution processes.

By integrating these features, the framework diverges from prior approaches that rely on static prompts, rigid categorization, or exclusive schema adherence. Rather than blocking or halting query execution or producing errors when ambiguity is detected, the framework is designed to maintain a continuous query workflow. Instead, the framework surfaces concise explanations and targeted clarification prompts to the user or subject matter expert, enabling the identification and resolution of ambiguous cases without interrupting the overall query generation process. This approach allows users to receive immediate feedback and guidance for resolving ambiguity, while the system continues to process queries and deliver results where possible. The combination of dynamic context adherence, structured ambiguity classification, and explanation generation improves both ambiguity recall and unambiguous precision, thereby enhancing the reliability and robustness of automated programming language query generation in diverse and practical deployment environments.

### Overview of Ambiguity Detection and Query Generation Flow

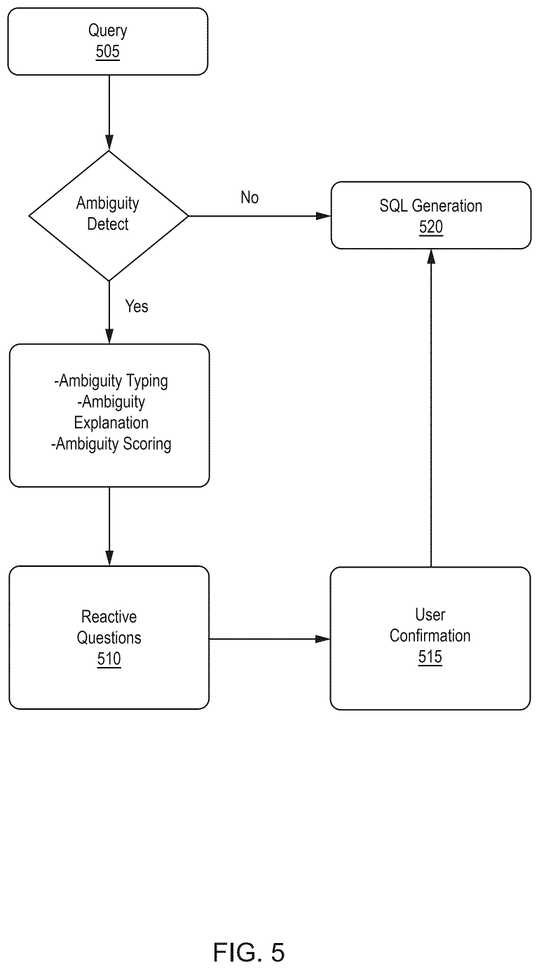

FIG. 5 is a high-level block diagram of an ambiguity detection and query generation system 500, according to various embodiments. Although the example given below is directed towards database query languages like SQL, it should be understood that the methods and techniques described herein may be applied to other query languages such as PGQL, logical database queries, API query languages (e.g., GraphQL, REST) and so forth. To do so, modifications specific to the query language used, may be made to the prompt used by the generative AI that do not go beyond the scope of the present disclosure. The ambiguity detection and query generation system 500 can be implemented using software only, hardware only, firmware only, or any combination of hardware, software, and/or firmware. As depicted in FIG. 5, each step can be understood to include an execution of one or more processes and/or programs implemented with software, hardware, and/or firmware within a system (e.g., as described with respect to FIGS. 11-15).

It is to be understood that the generative models, artificial intelligence models, and related components described herein, such as those employed in the natural language query generation process, the contextual rewriting process, the in-context learning retrieval process, the SQL query generation process, and the validation processes, may be implemented using the same model, different models, or any subset thereof may be the same or different, depending on the requirements of a particular embodiment. For example, in some embodiments, a single AI model or generative model may be configured to perform multiple tasks across the pipeline, while in other embodiments, separate models specialized for follow-up query generation, contextual rewriting, SQL synthesis, or validation may be used. Moreover, any combination or sub-combination of these models or modules may be employed, and the allocation of tasks among models may be varied without departing from the scope of the present disclosure. The architecture is thus modular and extensible, supporting replacement, augmentation, or reconfiguration of models and components as technical advances or application needs dictate.

The ambiguity detection and query generation system 500 initially receives a natural language query 505 from a user. The natural language query 505 may be directed to a database or data source and can reference specific entities, attributes, calculations, or criteria that may or may not correspond directly to elements within the database schema. In some embodiments, the natural language query 505 may be ambiguous, such that multiple semantic interpretations are possible, or may be unanswerable, such that information required for resolution is not available in the database schema or contextual information. The system may also collect additional contextual information, such as user profile data, prior interactions, or session metadata, to support accurate parsing and interpretation of the query 505.

Next, it is determined whether the natural language query 505 is ambiguous or not. This determination may be performed by a generative model, such as a large language model, which may analyze the query in conjunction with the relevant database schema and any collected contextual information. The generative model considers the schema structure, definitions of columns and tables, relationships among schema elements, and any specific instructions included in its prompt. In certain embodiments, the generative model applies a context adherence factor, which is a tunable parameter that modulates the extent to which the analysis relies on explicit schema information as opposed to general or common-sense knowledge. The generative model evaluates whether the query 505 unambiguously maps to schema elements, or whether the language or referenced concepts are subject to multiple interpretations, omissions, or conflicts. If the generative model determines that the query 505 is unambiguous, such that sufficient information is present and the intended mapping is clear, the system may generate a corresponding query statement, such as a structured query language (SQL) statement, for execution or review by a user. If the generative model detects ambiguity or determines that the query is unanswerable due to missing schema elements or insufficient context, the system initiates an ambiguity analysis process.

When ambiguity is detected, the system (e.g., the LLM) initiates a structured process to classify and explain the ambiguity present in the natural language query 505. The system initially tries to align the ambiguity to a predefined generic ambiguity category, such as and without limitation, context ambiguity, query ambiguity, calculation scope ambiguity, model-identified ambiguity, and the like. For each detected ambiguity type, the LLM generates an explanatory output that describes the source of the ambiguity, referencing the specific schema elements, terminology, or contextual information that contribute to the uncertainty. The system also assigns an ambiguity score, which is a probability value indicating the level of confidence that the query is ambiguous. This score reflects considerations such as the clarity of schema mappings, the presence of multiple plausible interpretations, or the absence of information required for precise query generation. The ambiguity type, explanation, and score are provided in a structured format for further processing, user review, or integration with subsequent resolution steps. This approach enables transparent and consistent identification and explanation of ambiguous or unanswerable queries, supporting effective user interaction

In addition to identifying the ambiguity type and providing an explanation and score, the system may also generate one or more reactive questions 510 designed to elicit the specific information or clarifications needed to resolve the detected ambiguity. The LLM formulates these reactive questions 510 by referencing the identified ambiguous terms, schema elements, or calculation criteria that contributed to the ambiguity score and explanation. In various embodiments, the reactive questions 510 may ask the user to select among multiple schema columns, specify the meaning of a domain-specific term, or provide missing constraints or parameters relevant to the query. If multiple ambiguities are detected within the user's original question, the system may generate a sequence of reactive questions 510 addressing each source of uncertainty. The reactive questions 510 are presented to the user in a clear and concise manner, with the goal of obtaining the necessary details to advance the query generation process.

Following presentation of the reactive questions, the system receives a response from the user 515, enabling interactive clarification and refinement of the original query. The user 515 may provide additional information, select from presented options, confirm the intended meaning, or revise the query to address the ambiguity identified by the system. In various embodiments, the user 515 may be a subject matter expert, an end user, or any individual with relevant knowledge of the data or application context. The user's 515 input may resolve all outstanding ambiguities, permitting the process to proceed to query generation. Alternatively, the user's 515 response may introduce new ambiguities or leave the original uncertainty unresolved, prompting the system to repeat ambiguity detection and clarification steps as necessary. The system supports an iterative interaction loop, allowing for continued engagement until the ambiguity is adequately addressed or the user elects to proceed with the information available.

Once sufficient clarification has been obtained, or all ambiguities have been resolved through user interaction, the system proceeds to generate a query statement 520 that reflects the clarified user intent. The SQL statement 520 may be synthesized by the same LLM employed in earlier ambiguity detection steps or, in certain embodiments, by a different LLM or a specialized NL2SQL model configured for query generation. The final query statement 520 incorporates the resolved elements, explicit criteria, and user-provided details, ensuring alignment with the database schema and the requirements established during the ambiguity resolution process. In embodiments where ambiguities have been addressed through iterative clarification, the query statement 520 is constructed to include the user's selections, definitions, or parameters, thereby increasing precision and reducing the risk of misinterpretation. The generated query statement 520 may then be presented to the user for review, executed against the target database or data source, or further processed in accordance with system configuration. The system may also log the ambiguity resolution steps and user interactions for purposes such as auditability, continuous improvement, or future training of the ambiguity detection and query generation pipeline.

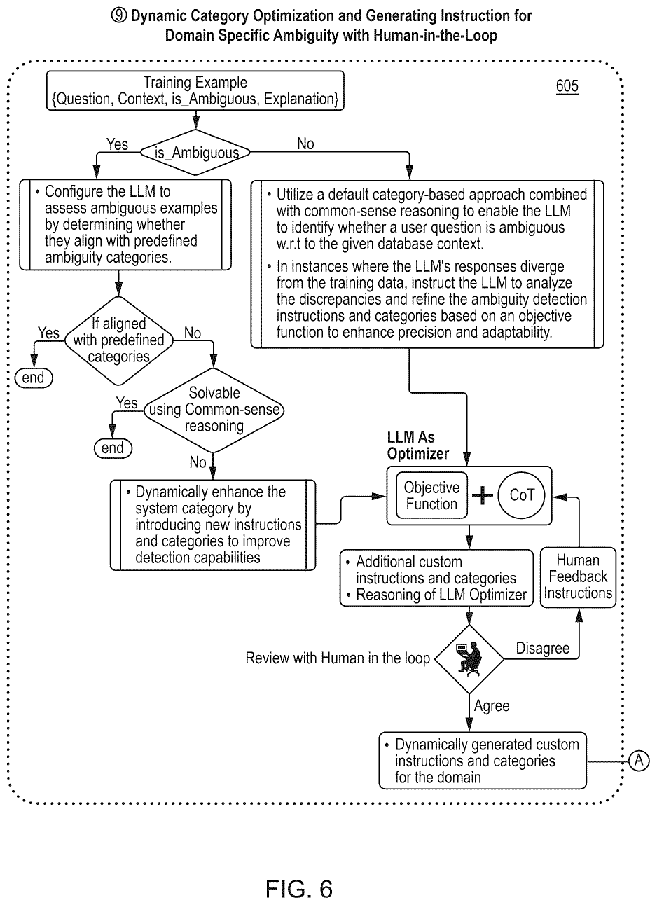

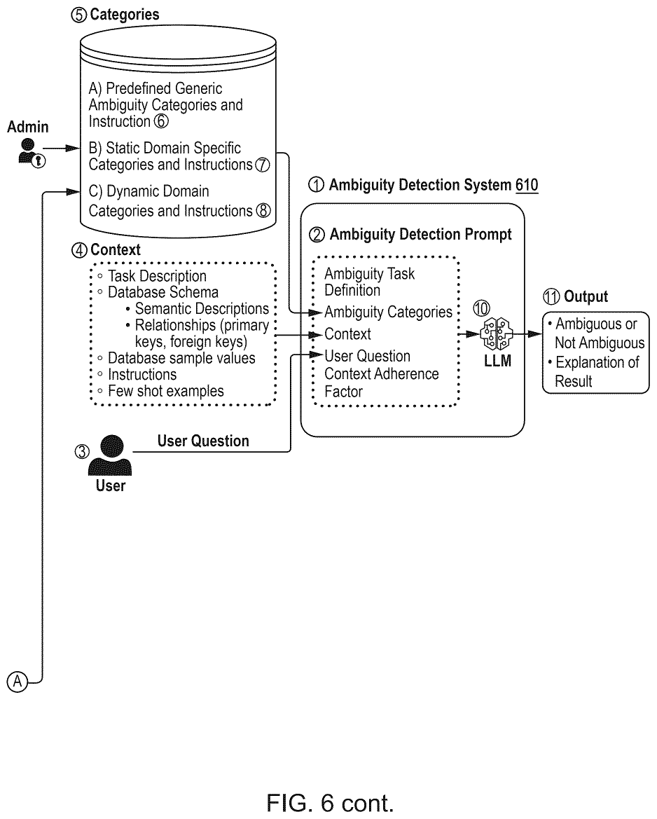

FIG. 6 is a block diagram illustrating a system architecture 600 configured for dynamic optimization of ambiguity detection categories and generation of instructions for addressing domain-specific ambiguities in text-to-SQL systems. The system supports adaptive workflows that identify, classify, and explain ambiguous elements in user queries directed to structured databases. Architecture 600 integrates a feedback-driven refinement process in which generative models and human reviewers collaborate to improve ambiguity detection and resolution over time.

System architecture 600 comprises that contribute to the adaptive and explainable operation of domain-specific ambiguity detection in text-to-SQL workflows. The ambiguity assessment workflow 605 manages the intake and evaluation of labeled training examples. This workflow determines whether each training example aligns with predefined ambiguity categories and enhances the system's detection capabilities when new ambiguity types are identified. An optimizer generative model drives this enhancement by using objective functions and chain-of-thought reasoning to propose new ambiguity detection instructions and categories. Proposed enhancements are subjected to a human-in-the-loop review, in which subject matter experts or administrators validate or refine the instructions and categories. Only enhancements confirmed by expert review are integrated into the system, ensuring accurate and effective domain adaptation.

Following the evaluation and refinement of ambiguity detection logic, the system applies these enhancements during real-time query analysis. System architecture 600 includes an ambiguity detection system 610 that uses LLMs to analyze user queries, determine the presence of ambiguity, and provide explanatory output. The ambiguity detection system receives input in the form of an ambiguity detection prompt, which aggregates the task definition, relevant ambiguity categories, database context, user question, and a context adherence factor parameter. The LLM processes this prompt and generates outputs that indicate whether the query is ambiguous, together with an explanation of the determination.

The generative models and related components referenced in FIG. 6 may be implemented using a single model or multiple distinct models, depending on the needs of a particular embodiment. In some configurations, a single large language model may be adapted to perform multiple tasks within the workflow, while in other configurations, separate models may be designated for specific functions such as reactive question generation, prompt optimization, or SQL synthesis. The allocation of tasks among models may be varied, and any combination or subset of these models may be employed in practice. The architecture of system 600 is designed to be modular and flexible, permitting replacement, augmentation, or reconfiguration of models and components in response to advancements in technology or evolving application requirements. This modularity supports ongoing optimization and adaptation of the workflow, facilitating integration of new modeling approaches or enhancements as they become available.

System architecture 600 receives input in the form of labeled training examples. Each labeled training example includes a natural language question, the associated database context, an ambiguity label that specifies whether the question is ambiguous or unambiguous, and a supporting explanation for the assigned label. The database context includes schema definitions, table and column descriptions, relevant metadata, business logic, and illustrative examples. These components provide both structural and domain-specific information that supports the evaluation of ambiguity in natural language queries.

In various instances, the set of labeled training examples may be generated by aggregating data from a range of sources to ensure comprehensive coverage of ambiguity types for system training and evaluation. These sources may include public datasets, private collections, and datasets synthesized specifically for the ambiguity detection task. For example, a public dataset such as the Spider dataset may be used to supply natural language questions and corresponding database contexts, which together form a foundational ground truth dataset. Additional training examples may be constructed by pairing queries from other sources, such as the enhanced AmbiQT dataset, with database contexts drawn from Spider, thereby generating unambiguous examples through intentional schema-query combinations. To further enrich the training set, a generative model, such as an LLM, may be utilized to create ambiguous variants of these queries, with each variant aligned to a specific ambiguity type, such as context ambiguity or calculation scope ambiguity. The process of dataset construction may include both automated and manual components: a generative model can assign preliminary ambiguity labels and generate supporting explanations for each example, while subject matter experts may subsequently review, verify, and, if necessary, revise these labels and explanations through a peer review process.

In the ambiguity assessment workflow, the system uses a generative model, such as a large language model, to evaluate each labeled training example. The model examines the natural language query in conjunction with its database context to determine whether the example is ambiguous. A training example may be considered ambiguous if, based on the schema context, it presents multiple plausible interpretations, lacks the specificity or clarity necessary for unambiguous mapping to schema elements, or references terms, columns, tables, or relationships that are absent, undefined, or have conflicting meanings within the context. Ambiguity may also arise when the phrasing of the query is vague or open-ended, when implicit assumptions or domain-specific terminology are used without adequate schema support, or when the calculation scope or aggregation criteria cannot be uniquely determined. When making this determination, the generative model is configured to classify the ambiguity by type, referencing predefined ambiguity categories, to generate a corresponding explanation, and to assign an ambiguity probability score that reflects the confidence of the assessment.

The generative model initially attempts to align the training example with a predefined generic ambiguity category or a static domain-specific ambiguity category maintained in the system's categories database. If the model determines that the example corresponds to one of these established categories, the ambiguity class or type is assigned accordingly. A static domain-specific ambiguity category refers to a type or classification of ambiguity that is particular to a specific application domain, business context, or data environment. These categories may address ambiguity scenarios unique to a given industry, organizational process, or specialized data schema. For example, static domain-specific categories may include ambiguities related to proprietary business logic, domain-specific terminology, or custom data structures that are not adequately captured by generic ambiguity categories. Domain experts, system administrators, or other authorized personnel may curate and update these categories, maintaining them in a repository or knowledge base that is accessible for both training and runtime ambiguity assessment.

A predefined ambiguity category, also referred to as a generic ambiguity category, encompasses types of ambiguity commonly encountered during the analysis of natural language queries directed to structured databases. Such categories may be established in advance within the ambiguity detection system to support systematic identification, classification, explanation, or resolution of ambiguous queries. The construction of these categories may be informed by domain expertise, empirical studies, operational experience, or patterns identified through error analysis of annotated training data. Examples of predefined ambiguity categories may include context ambiguities, such as missing schema elements, duplicate or similar column names, or undefined business terms; query ambiguities, such as vague or open-ended questions; ambiguities in calculation scope; logical contradictions; and ambiguities that a language model can identify based on linguistic features. See Tables 2A-2C below for more detailed explanations. The system may extend, refine, or supplement these categories over time as new forms of ambiguity are encountered. The scope of a predefined ambiguity category may be tailored to the needs of a particular domain, user group, or application, and may encompass both generic and domain-specific classifications to support robust and adaptable ambiguity detection and explanation.

TABLE 2A
Context Ambiguity Examples: Ambiguities originating from provide context, like task
definition, persona, database tables, columns, relations, business logic etc.

| Ambiguity Definition | Descriptions |
|---|---|
| Missing Schema related | User Query: “Show me the latest transactions.” |
| items, examples: columns, | Ambiguity: The schema might be missing a clear |
| tables, or relations between | relation between a Transaction and Date or may not |
| tables etc. | have a Transaction table at all. |
| Duplicate or Similar- | Confusion caused by tables or columns having similar |
| Sounding Context Items | names, creating ambiguity in which one to use. |
| | User Query: “What deals have been profitable?” |
| | Ambiguity: The system has both Trade and |
| | Transactions tables, and both can have a Profit |
| | column |
| | User Query: “Show me the ratings.” |
| | Ambiguity: It's unclear whether the user is asking |
| | for product ratings, movie ratings, or something |
| | else. |
| Domain-Specific Term | Ambiguity arises when the system cannot map a |
| Understanding Missing | domain-specific term to the correct table or column. |
| | User Query: “Show me the margin for the last |
| | quarter.” |
| | Ambiguity: The term “margin” in finance can refer to |
| | different concepts, such as: |
| | Profit Margin: The percentage of revenue that |
| | exceeds costs (Gross Profit Margin, Net Profit |
| | Margin, etc.). |
| | Interest Margin: The difference between the |
| | interest earned on assets and the interest paid |
| | on liabilities (Net Interest Margin). |
| | Margin in Trading: The collateral required to |
| | cover the credit risk in a financial trade (such as a |
| | margin account). |
| Derived Definitions but | The system lacks the ability to compute derived values |
| Missing Instructions | based on domain-specific rules. |
| | User Query: “Show me all valued customers.” |
| | Ambiguity: “Valued customers” is a derived |
| | business concept, not directly present in the |
| | schema. There is no instruction on how to calculate |
| | or define “valued” (e.g., customers who make high- |
| | value purchases). |
| Value Ambiguities | The query has unclear or missing value information. |
| Not Able to Infer the | Ambiguity arises when the column or table names are |
| Purpose of Column or | acronyms, poorly written, or the name doesn't clearly |
| Table by Name | reflect the intended data or purpose. |

TABLE 2B
Query Ambiguity Examples: Even with the right context,
the user doesn't frame the query appropriately.

| Ambiguity Definition | Descriptions |
|---|---|
| Vague or Open-Ended | The query is too vague or lacks necessary criteria to generate an SQL |
| Questions | query. |
| | User Query: “Show me all accounts.” |
| | Ambiguity: The query is too broad and could return an excessive |
| | amount of data. It's unclear whether specific filters should be applied |
| | (e.g., active accounts, high-balance accounts, etc.). |
| Attachment, Entities, | Ambiguity regarding which entities and their properties to retrieve, or |
| and Properties | relationships between entities are misinterpreted. |
| Ambiguity | User Query: “Show me the writers and editors on a work-for-hire.” |
| | Ambiguity: It's unclear whether the user is asking for writers, editors, |
| | or both involved in a work-for-hire, and how these roles are linked in |
| | the schema. |
| Inherent User Patterns | The user assumes the system has domain knowledge, but this is not |
| and Business | provided in the query or context. |
| Knowledge Assumed | User Query: “Show me the top-performing regions.” |
| | Ambiguity: There may be multiple ways to measure “performance” |
| | (e.g., revenue, customer satisfaction, etc.), but this assumption is not |
| | stated. |

TABLE 2C
Ambiguities which LLM Can Identify Based on Inherent
Knowledge of Text to SQL or Language Examples:

| Ambiguity Definition | Descriptions |
|---|---|
| Poorly formed or | The query is too vague or lacks necessary criteria to generate an SQL |
| semantically incorrect | query. |
| questions | User Query: “Show me the trend of region XYZ profitment.” |
| | Ambiguity: The word “profitment” is not recognized and is likely a |
| | misspelling of “profit,” but the LLM may not be able to infer that |
| | correctly. |

For each detected ambiguity, the LLM generates a detailed explanation in natural language. This explanation specifies the assigned ambiguity category (e.g., context ambiguity, query ambiguity, calculation scope ambiguity, etc.) and identifies the relevant schema elements or query features that contributed to the ambiguity determination. The explanation articulates the rationale for classifying the query as ambiguous, referencing conflicting, missing, or unclear information within the database schema or contextual parameters. Additionally, the system may present these explanations to users through a user interface or as part of a structured response, enabling users to understand the precise nature of the ambiguity and what information is required for resolution. Explanations may also be logged or stored in a system repository, supporting auditability and facilitating expert review. System administrators or subject matter experts may access these records to validate the reasoning process and to identify recurrent ambiguity patterns.

In some instances, the system may further use the generated explanations to inform ongoing refinement of ambiguity detection logic. The explanations may become part of the system's training data, where they are reviewed and may be used to create new labeled examples or to update detection rules and ambiguity categories. This feedback mechanism enables the system to adapt dynamically as new forms of ambiguity are encountered.

By systematically generating and surfacing actionable, context-aware explanations, the system enables more efficient user clarification and reduces manual intervention. These features enhance the transparency, reliability, and adaptability of automated natural language query interfaces for structured data systems.

To quantify the ambiguity assessment, the large language model generates an ambiguity probability score for each evaluated query. The ambiguity probability score is a numerical value ranging from 0 to 100, representing the model's confidence that the query is ambiguous in the context of the provided schema and any relevant metadata. The score is computed based on explicit, documented criteria that may include the presence or absence of key schema elements, the clarity of relationships between tables and columns, the specificity of query terms, and the identification of conflicting or missing information. A score near 100 indicates a high level of confidence that the query is ambiguous, such as when critical schema components are missing or relationships are undefined or unclear. A score near 50 reflects moderate ambiguity, where multiple plausible interpretations exist but the evidence does not conclusively support a single classification. A score near 0 indicates high confidence that the query is unambiguous and clearly corresponds to the schema and context provided.

The ambiguity probability score may be generated according to transparent and reproducible criteria, which are maintained within system documentation and may be updated as the system is retrained or as new forms of ambiguity are identified. The criteria used to calculate the ambiguity probability score may include, but are not limited to, the following factors:
Schema Coverage: The model evaluates whether all terms in the query can be directly mapped to corresponding elements in the database schema, such as table names, column names, or defined relationships. If one or more terms lack a clear mapping, the score increases to reflect greater ambiguity.
Presence of Duplicate or Similar Schema Elements: If the query references terms that correspond to multiple possible schema elements (for example, if the schema contains more than one column or table with similar or identical names), the score is raised to reflect the increased likelihood of ambiguity.
Specificity of Query Language: The model considers the specificity and clarity of the language used in the query. Queries containing vague, open-ended, or colloquial expressions e.g., “recent,” “top-performing,” or “valued” are assigned higher scores unless explicit definitions or instructions exist within the schema or contextual metadata.
Relationship Completeness: The score is influenced by whether the schema provides clear, direct relationships between referenced entities. If the query requires joining tables or columns that are not directly related in the schema, or if the relationships are unclear or missing, the score is increased.
Calculation Scope and Metric Definition: For queries that request aggregated values, statistics, or derived metrics (such as “average growth,” “margin,” or “correlation”), the model checks for the presence of explicit calculation logic or business rules in the schema or supporting documentation. Ambiguity in calculation scope or metric definition leads to a higher score.
Semantic Consistency and Logical Contradiction: The model evaluates the logical consistency of the query with respect to the schema. Contradictory requests (such as asking for transaction details of customers with no transactions) or semantically incorrect language (e.g., misspellings or undefined terms) result in a higher ambiguity score.
Historical User Clarifications: The system may incorporate data from prior user clarifications or manual reviews. Queries or query patterns that have previously required clarification may contribute to a higher ambiguity probability score for similar new queries.

For example, if a query such as “Show me all valued customers” is received and the schema does not define what constitutes a “valued customer,” the score may be set near 100 to reflect the high likelihood of ambiguity. If a query such as “List all accounts” is presented and the schema contains multiple tables with “account” in the name, but the query does not specify which account type is intended, the score may be set at an intermediate value, such as 50, to indicate moderate ambiguity. Conversely, if a query explicitly references well-defined schema elements and includes sufficient constraints for precise mapping, the score may approach 0, signaling high confidence in non-ambiguity.

The ambiguity probability score supports multiple technical functions within the system by enabling the prioritization of ambiguous queries for human review, routing high-scoring queries to subject matter experts for further analysis, and informing user clarification workflows by identifying queries where additional information is most needed. The score also contributes to system optimization by highlighting recurring ambiguity patterns and serving as a signal for retraining or refining detection logic. By providing a quantifiable and criteria-driven measure of ambiguity, the system enables explainable, reproducible, and user-centric operations.

Following the assignment of an ambiguity probability score, the system proceeds according to the outcome of the generative model's evaluation. If the generative model evaluates a training example and determines that it is not ambiguous, the system applies a default category-based approach in combination with common-sense interpretation. This approach relies on general ambiguity detection strategies that are not restricted to specific, predefined ambiguity categories. Under this strategy, the generative model uses both explicit schema information and implicit domain knowledge to resolve ambiguities that were not anticipated during the initial system configuration. Common-sense reasoning allows the model to assess the plausibility of query interpretations based on typical language usage and established domain conventions. This enables the detection of ambiguities that result from vague phrasing, implicit assumptions, or meanings that depend on context. During the instances where the generative model's evaluation using the default category-based approach diverges from the training data the system instructs the model to analyze these discrepancies. The model may then refine the ambiguity detection instructions and categories. This refinement process is performed iteratively and involves an optimizer generative model in conjunction with human-in-the-loop review, as described in further detail below.

If the large language model evaluates a training example and determines that it is ambiguous in a way that corresponds to a predefined ambiguity category, the system concludes the ambiguity classification for that example. The example may be incorporated into downstream operations within the system. These downstream operations may include using the example to train or retrain machine learning models that perform ambiguity detection, validating the performance of such models against known instances of ambiguity, and generating synthetic queries or responses for system testing. The example may also be included in datasets used to benchmark the system's accuracy or to refine prompt templates for improved ambiguity detection. In addition, the example can be leveraged to create or update instructional material and to support the automated generation of query statements that are used in user-facing applications.

If the system determines that a training example is ambiguous but does not align with any predefined ambiguity category, the workflow proceeds to a common-sense interpretation path. In this context, common-sense interpretation refers to a reasoning process in which the generative model evaluates a natural language query or database context by applying general knowledge, typical language usage, and broadly accepted domain conventions. This approach does not rely solely on explicit schema definitions, predefined categories, or programmed rules. Common-sense interpretation may include the use of background knowledge, inferential logic, or contextually appropriate assumptions to resolve ambiguities, fill informational gaps, or interpret user intent when the database schema or explicit instructions are incomplete, unclear, or insufficient for unambiguous resolution. Through this reasoning process, the model may infer plausible meanings or relationships that are not expressly defined in the schema, such as mapping vague or colloquial language to relevant domain concepts. Additionally, common-sense interpretation enables the model to recognize and address ambiguities that arise from implicit assumptions, idiomatic expressions, or natural variations in language. The model may also apply typical reasoning patterns, such as deducing the most likely interpretation based on contextual factors, user roles, or historical usage. This capability allows the system to detect and explain ambiguities that may not be anticipated by predefined or static domain-specific categories.

When a training example can be resolved using common-sense interpretation, the system concludes the ambiguity classification for that example. The example may then be included in downstream processes as previously described.

When the ambiguity assessment workflow encounters a training example that does not correspond to any predefined generic or static domain-specific ambiguity category and cannot be resolved through common-sense reasoning, the system initiates an iterative optimization and refinement process. This process is managed by an optimizer generative model, which uses an objective function and chain-of-thought reasoning to analyze the ambiguous example and propose new ambiguity detection instructions and categories. Any proposed enhancements generated by the optimizer undergo human-in-the-loop review, where subject matter experts or system administrators evaluate, validate, and, where necessary, refine or revise the new instructions and categories before they are integrated into the system. The optimizer generative model may be implemented as a large language model or another machine learning model trained on natural language data and domain-specific examples. The optimizer is designed to identify, analyze, and propose new ambiguity detection categories and instructions when presented with queries that are not adequately addressed by the system's existing categories or by common-sense reasoning mechanisms. In certain implementations, the optimizer may operate as an ensemble of multiple pretrained models, incorporate knowledge from external sources or rule-based systems, or integrate with automated retraining pipelines. The specific reasoning strategies, objective functions, and instruction formats applied by the optimizer may be tailored to suit the requirements of particular application domains, regulatory environments, or system architectures.

The optimizer generative model applies a combination of objective function evaluation and chain-of-thought reasoning to analyze ambiguous examples. The objective function is used to quantify the quality, relevance, or accuracy of proposed ambiguity detection instructions or categories. For instance, the system may use objective functions that measure accuracy with respect to human-annotated labels, semantic similarity to established benchmark examples, F1 score, or results of human-in-the-loop assessment. The configuration of the system, the requirements of its users, or the nature of the ambiguity being addressed may influence which objective functions are selected or how they are weighted during the evaluation process.

Chain-of-thought reasoning enables the optimizer to construct explicit, stepwise logical explanations that describe the nature and source of ambiguity in a user query. This reasoning may be implemented as a single-step analysis or as a multi-turn, iterative process, in which the model examines relationships among the query, the schema context, the detected ambiguity, and outcomes from previous analyses. The optimizer may utilize formal logic, rule-based inference, probabilistic reasoning, or a combination of these approaches to identify the factors that contribute to ambiguity and to propose appropriate resolution strategies.

Based on its analysis, the optimizer generative model generates proposed enhancements to the ambiguity detection system. These enhancements may include new ambiguity categories that are tailored to address observed domain- or context-specific ambiguities, the formulation of detection instructions or decision rules (often in the form of natural language prompts) to guide future identification of similar ambiguities, and updates to clarification prompts, example-based guidance, or other auxiliary instructions designed to improve overall system performance. The optimizer may also generate sample prompts, clarification questions, or rule-based templates that demonstrate how a new ambiguity category can be detected and resolved within the system.

All candidate enhancements generated by the optimizer generative model are reviewed by human reviewers prior to being integrated into the system. Human reviewers, such as subject matter experts, annotators, or system administrators, may examine the proposed categories and instructions for practical relevance, accuracy, and consistency with existing logic. Reviewers may approve, modify, or reject individual enhancements. The review process may be documented, versioned, or audited as appropriate for the deployment environment. If a proposed enhancement is approved, it is integrated into the system's ambiguity category repository and detection instruction set, enabling the system to address similar ambiguous cases in future user interactions. If an enhancement is not approved, the optimizer may repeat the analysis and reasoning process, incorporating reviewer feedback and refining the proposals as necessary. This iterative process may continue until an enhancement is approved or the ambiguity is otherwise resolved.

This feedback-driven optimization loop supports continuous learning and robust domain adaptation within the ambiguity detection system. By leveraging both automated reasoning and expert validation, the system can iteratively refine and expand its ambiguity detection logic, maintaining alignment with evolving domain requirements and user needs, and supporting scalable, explainable text-to-SQL workflows.

Once the optimizer generative model, together with human reviewers, has validated and integrated new ambiguity detection categories, instructions, or prompts, these enhancements become part of the system's operational logic. The ambiguity detection system 610 is configured to leverage the updated categories, detection rules, and clarification strategies during real-time analysis of user queries. This integration ensures that the system remains adaptive, continually expands its coverage of ambiguity types, and applies the most current domain knowledge and detection methods in every user interaction. As a result, the ambiguity detection system 610 benefits from ongoing refinement and is able to provide more accurate, context-aware, and explainable ambiguity assessments.

The ambiguity detection system 610 executes real-time analysis of user-submitted natural language queries for structured data sources. For each query, the system constructs an ambiguity detection prompt that aggregates multiple types of information necessary for accurate ambiguity assessment. The prompt includes a task definition specifying the ambiguity detection objective, a set of ambiguity categories, the relevant database context, the specific user question, and a context adherence factor parameter. The set of ambiguity categories are provided by a categories database that serves as a repository that stores the predefined ambiguity categories, the dynamically generated ambiguity categories, and domain-specific ambiguity categories.

The database context provides the ambiguity detection system with the relevant background and schema information necessary for accurate evaluation of natural language queries. This context may include task descriptions, database schemas, table and column descriptions, explicit relationships such as primary and foreign keys, domain-specific values, business logic, and few-shot example queries.

The context adherence factor is a configurable parameter that modulates the LLM's reasoning strategy, enabling a balance between strict schema-based evaluation and broader common-sense interpretation as described in earlier sections. At one end (e.g., a value of 1), the system interprets questions strictly in accordance with the explicit schema and instructions, flagging as ambiguous any query that cannot be resolved solely by information present in the schema. At the other end (e.g., a value of 0), the system allows for broader interpretation using common-sense knowledge to resolve uncertainties or fill in gaps, thus reducing the number of queries flagged as ambiguous. Intermediate values (e.g., 0.5) balance these approaches. This parameter allows the ambiguity detection system to be adapted for different use cases, database environments, or user needs, such as strict compliance in regulated domains or more flexible reasoning in everyday business contexts. The result is a reproducible, explainable, and adjustable framework for determining and scoring ambiguity in natural language questions intended for database querying.

Once the ambiguity detection prompt is constructed, it is provided as input to an LLM. The LLM processes the prompt and generates an output indicating whether the user query is ambiguous, unambiguous, or unanswerable, and provides an explanation of the result. The explanation may include references to specific schema elements, ambiguity categories, or contextual features that contributed to the determination. When appropriate, the output may also include clarification questions or follow-up prompts designed to resolve ambiguity by eliciting additional information from the user or admin.

Optionally, the approach generates corresponding SQL statements for the user queries and context determined not to be ambiguous. For those queries and context determined to be ambiguous, the ambiguity type, explanation of ambiguity, and ambiguity scoring are determined/identified and collated. Optionally, one or more reactive questions may be generated based on the ambiguity type, explanation of ambiguity, and ambiguity scoring and provide to the user. The user may provide the needed information to resolve the ambiguity, allowing the system to generate a query statement in a programming language corresponding to the natural language utterance and the database context.

### EXAMPLES

The following examples are offered by way of illustration, and not by way of limitation.

Ambiguity in the interpretation of natural language queries presents a significant challenge for text-to-SQL systems, often resulting in incorrect or incomplete database retrievals and undermining user trust in automated data access solutions. The present study aimed to empirically evaluate the effectiveness of a machine learning-based system for detecting and explaining ambiguity in natural language queries submitted to relational databases. Experimental assessments were conducted using both real-world and synthetic datasets containing a range of ambiguous and unambiguous queries, with ambiguity labels and supporting explanations curated through a peer-reviewed process. The evaluation compared the proposed system, which leveraged large language models and a configurable context adherence parameter, against established baseline models and prompts. The results demonstrated that the system achieved an ambiguous recall rate of up to 90%, with weighted F1 scores improving as the context adherence factor was tuned to balance schema reliance and common-sense reasoning. Notably, the system outperformed baseline approaches in capturing a broader range of ambiguity types, including context ambiguities, query vagueness, and calculation scope uncertainty, while providing consistent probability scores and detailed explanatory output. These findings indicate that adaptive ambiguity detection and explanation substantially enhance the reliability and transparency of natural language database interfaces, supporting more robust user interaction and reducing the risk of erroneous query execution. The outcomes suggest that the integration of such systems into production environments may improve end-user confidence and inform future developments in explainable artificial intelligence for data management applications.

### Dataset Preparation and Annotation

To evaluate the performance of the ambiguity detection system, a ground truth dataset was generated containing a diverse set of natural language queries and associated database schema contexts, each labeled for ambiguity and accompanied by an explanatory rationale. The ground truth dataset was generated by aggregating pairs of benchmark natural language utterances and their corresponding database context from publicly available sources including the Ambrosia, AmbiQT, and Spider datasets. Due to the limited availability of public and real-world datasets on ambiguity detection, synthetic pairs of natural language utterances-database contexts were also constructed by combining natural language utterances from the AmbiQT dataset with original database contexts from the Spider dataset to generate unambiguous examples. Additionally, the GPT-40 LLM was used to generate ambiguous queries that aligned with predefined ambiguity types (e.g., context ambiguities, natural language utterance ambiguities, and model-identifiable ambiguities).

To generate the labels and explanations for the pairs of natural language utterances-database contexts above, the pairs of natural language utterances-database contexts were processed by the llama 3.1-405B LLM to generate preliminary ambiguity labels and explanations. These were subsequently reviewed and corrected by both LLM and human annotators. The label disagreement between the LLM and human annotators was approximately 20%, primarily for questions involving cost and growth.

Provided below is a non-limiting example of a prompt that was provided to the LLM to generate the preliminary ambiguity labels and explanations. Following the prompt are several examples of synthetic ground truth data points (Table 3) and final ground truth data points (Table 4).

### Initial Ambiguity Label and Explanation Generation Prompt

You are an advanced SQL generation assistant. Your task is to analyze a given context and user
question to detect potential ambiguities that might arise when generating an SQL query. Follow
these steps:

| | |
|---|---|
| 1. | Carefully examine the provided Context (e.g., database schema, instructions) to |
| | understand its structure and details. |
| 2. | Review the User Question to identify ambiguities such as unclear column or table |
| | mappings, missing information, or conflicting interpretations. |
| 3. | If the question is ambiguous, clearly explain the reason(s) for the ambiguity and |
| | specify what additional information is required to resolve it. |
| 4. | If the question is unambiguous, confirm it and state why it is clear. |

Input Format:

| | |
|---|---|
| ◯ | Context: [Details of the database schema, tables, columns, instructions, etc.] |
| ◯ | User Question: [The user's natural language question] |

Output Format:

| | |
|---|---|
| ◯ | Ambiguity Status: [Ambiguous/Unambiguous] |
| ◯ | Reason for Ambiguity (if any): [Explain why the question is ambiguous and what |
| | information is missing] |
| ◯ | Suggestions to Resolve Ambiguity (if any): [List specific clarifications needed] |

TABLE 3
Synthetic Data Entries Generated Using Spider Dataset

| NLQ | Context | Label | Explanation |
|---|---|---|---|
| List teachers' | Database ID: course_teach | Ambiguous | This query is |
| names | Original Table Name: course | | ambiguous because |
| with age near 32, | Table Name: course Original | | ‘age near 32’ or |
| around the same | Column Names: [‘Course_ID’, | | ‘around the same |
| age | ‘Staring_Date’, ‘Course’] | | age group’ is not |
| group. | Column Names: [‘course id’, | | clearly defined. The |
| | ‘staring date’, ‘course’] Column | | schema has an ‘Age’ |
| | Types: [‘number’, ‘text’, ‘text’] | | column, but there is |
| | Primary Key: [‘course id’] | | no criterion in the |
| | Foreign Key: None | | database that |
| | Original Table Name: teacher | | defines an age |
| | Table Name: teacher Original | | group or a range |
| | Column Names: [‘Teacher_ID’, | | around 32. It is |
| | ‘Name’, ‘Age’, ‘Hometown’] | | unclear whether |
| | Column Names: [‘teacher id’, | | ‘near 32’ should |
| | ‘name’, | | include ages like 31, |
| | ‘age’, ‘hometown’] Column | | 32, 33, or some |
| | Types: [‘number’, ‘text’, ‘text’, | | other range. |
| | ‘text’] | | |
| | Primary Key: [‘teacher id’] | | |
| | Foreign Key: None | | |
| | Original Table Name: | | |
| | course_arrange Table Name: | | |
| | course arrange | | |
| | Original Column Names: | | |
| | [‘Course_ID’, ‘Teacher_ID’, | | |
| | ‘Grade’] Column Names: [‘course | | |
| | id’, ‘teacher id’, ‘grade’] | | |
| | Column Types: [‘number’, | | |
| | ‘number’, ‘number’] | | |
| | Primary Key: [‘course id’] | | |
| | Foreign Key: [‘course id’, ‘teacher | | |
| | id’] | | |
| What is the id and | Database ID: | Ambiguous | The query specifies |
| summary of the | student_transcripts_tracking | | ‘last semester,’ but |
| program that | Original Table Name: | | the schema does |
| enrolled the | Addresses Table | | not provide any |
| highest number of | Name: addresses | | indication of which |
| students last | Original Column Names: | | semester was the |
| semester? | [‘address_id’, ‘line_1’, ‘line_2’, | | most recent. There |
| | ‘line_3’, ‘city’, ‘zip_postcode’, | | is no mechanism |
| | ‘state_province_county’, | | in the schema to |
| | ‘country’, | | determine the ‘last’ |
| | ‘other_address_details'] | | semester, which |
| | Column Names: [‘address id’, | | makes it |
| | ‘line 1’, ‘line 2’, ‘line 3’, ‘city’, ‘zip | | ambiguous as to |
| | postcode’, ‘state province | | how to identify the |
| | county’, ‘country’, ‘other address | | correct time period |
| | details'] | | for calculating |
| | Column Types: [‘number’, ‘text’, | | enrollment. |
| | ‘text’, ‘text’, ‘text’, ‘text’, ‘text’, | | |
| | ‘text’, ‘text’] | | |
| | Primary Key: [‘address id’] Foreign | | |
| | Key: None | | |
| | Original Table | | |
| | Name: Courses | | |
| | Table Name: | | |
| | courses | | |
| | Original Column Names: | | |
| | [‘course_id’, ‘course_name’, | | |
| | ‘course_description’, | | |
| | ‘other_details'] | | |
| | Column Names: [‘course id’, | | |
| | ‘course name’, ‘course | | |
| | description’, ‘other details'] | | |
| | Column Types: [‘number’, | | |
| | ‘text’, ‘text’, ‘text’] Primary | | |
| | Key: [‘course id’] | | |
| | Foreign Key: None | | |
| | Original Table Name: | | |
| | Departments Table | | |
| | Name: departments | | |
| | Original Column Names: | | |
| | [‘department_id’ | | |
| | ‘department_name’, | | |
| | ‘department_description’, | | |
| | ‘other_details'] | | |
| | Column Names: [‘department | | |
| | id’, ‘department name’, | | |
| | ‘department description’, | | |
| | ‘other details'] | | |
| | Column Types: [‘number’, | | |
| | ‘text’, ‘text’, ‘text’] Primary | | |
| | Key: [‘department id’] | | |
| | Foreign Key: None | | |
| | Original Table Name: | | |
| | Degree_Programs Table | | |
| | Name: degree programs | | |
| | Original Column Names: | | |
| | [‘degree_program_id’, | | |
| | ‘department_id’, | | |
| | ‘degree_summary_name’, | | |
| | ‘degree_summary_description’, | | |
| | ‘other_details'] Column | | |
| | Names: [‘degree program id’, | | |
| | ‘department id’, | | |
| | ‘degree summary name’, ‘degree | | |
| | summary description’, ‘other | | |
| | details'] | | |
| | Column Types: [‘number’, | | |
| | ‘number’, ‘text’, ‘text’, ‘text’] | | |
| | Primary Key: [‘degree program | | |
| | id’] | | |
| | Foreign Key: [‘department id’] | | |
| | Original Table | | |
| | Name: Sections | | |
| | Table Name: | | |
| | sections | | |
| | Original Column Names: | | |
| | [‘section_id’, ‘course_id’, | | |
| | ‘section_name’, | | |
| | ‘section_description’, | | |
| | ‘other_details'] Column Names: | | |
| | [‘section id’, ‘course id’, ‘section | | |
| | name’, ‘section description’, | | |
| | ‘other details'] | | |
| | Column Types: [‘number’, | | |
| | ‘number’, ‘text’, ‘text’, ‘text’] | | |
| | Primary Key: [‘section id’] | | |
| | Foreign Key: [‘course id’] | | |
| | Original Table Name: | | |
| | Semesters Table | | |
| | Name: semesters | | |
| | Original Column Names: | | |
| | [‘semester_id’, ‘semester_name’, | | |
| | ‘semester_description’, | | |
| | ‘other_details'] | | |
| | Column Names: [‘semester id’, | | |
| | ‘semester name’, ‘semester | | |
| | description’, ‘other details'] | | |
| | Column Types: [‘number’, | | |
| | ‘text’, ‘text’, ‘text’] Primary | | |
| | Key: [‘semester id’] | | |
| | Foreign Key: None | | |
| | Original Table | | |
| | Name: Students | | |
| | Table Name: | | |
| | students | | |
| | Original Column Names: | | |
| | [‘student_id’, | | |
| | ‘current_address_id’, | | |
| | ‘permanent_address_id’, | | |
| | ‘first_name’, ‘middle_name’, | | |
| | ‘last_name’, | | |
| | ‘cell_mobile_number’, | | |
| | ‘email_address', ‘ssn’, | | |
| | ‘date_first_registered’, ‘date_left’, | | |
| | ‘other_student_details'] Column | | |
| | Names: [‘student id’, ‘current | | |
| | address id’, ‘permanent address | | |
| | id’, ‘first name’, ‘middle name’, | | |
| | ‘last name’, ‘cell mobile number’, | | |
| | ‘email address', ‘ssn’, ‘date first | | |
| | registered’, ‘date left’, ‘other | | |
| | student details'] | | |
| | Column Types: [‘number’, ‘number’, | | |
| | ‘number’, ‘text’, ‘text’, | | |
| | ‘text’, ‘text’, ‘text’, ‘text’, | | |
| | ‘time’, ‘time’, ‘text’] | | |
| | Primary Key: [‘student id’] | | |
| | Foreign Key: [‘address id’, ‘address | | |
| | id’] | | |
| | Original Table Name: | | |
| | Student_Enrolment Table | | |
| | Name: student enrolment | | |
| | Original Column Names: | | |
| | [‘student_enrolment_id’, | | |
| | ‘degree_program_id’, | | |
| | ‘semester_id’, ‘student_id’, | | |
| | ‘other_details'] | | |
| | Column Names: [‘student | | |
| | enrolment id’, ‘degree program | | |
| | id’, ‘semester id’, ‘student id’, | | |
| | ‘other details'] | | |
| | Column Types: [‘number’, | | |
| | ‘number’, ‘number’, ‘number’, | | |
| | ‘text’] | | |
| | Primary Key: [‘student enrolment id’] | | |
| | Foreign Key: [‘degree program id’, | | |
| | ‘semester id’, ‘student id’] | | |
| | Original Table Name: | | |
| | Student_Enrolment_Courses | | |
| | Table Name: student enrolment | | |
| | courses | | |
| | Original Column Names: | | |
| | [‘student_course_id’, ‘course_id’, | | |
| | ‘student_enrolment_id’] | | |
| | Column Names: [‘student course | | |
| | id’, ‘course id’, ‘student enrolment | | |
| | id’] | | |
| | Column Types: [‘number’, | | |
| | ‘number’, ‘number’] | | |
| | Primary Key: [‘student | | |
| | course id’] | | |
| | Foreign Key: [‘course id’, ‘student | | |
| | enrolment id’] | | |
| | Original Table Name: | | |
| | Transcripts Table | | |
| | Name: transcripts | | |
| | Original Column Names: | | |
| | [‘transcript_id’, ‘transcript_date’, | | |
| | ‘other_details'] | | |
| | Column Names: [‘transcript id’, | | |
| | ‘transcript date’, ‘other details'] | | |
| | Column Types: | | |
| | [‘number’, ‘time’, | | |
| | ‘text’] Primary Key: | | |
| | [‘transcript id’] | | |
| | Foreign Key: None | | |
| | Original Table Name: | | |
| | Transcript_Contents | | |
| | Table Name: transcript contents | | |
| | Original Column Names: | | |
| | [‘student_course_id’, ‘transcript_id’] | | |
| | Column Names: [‘student course id’, | | |
| | ‘transcript id’] | | |
| | Column Types: [‘number’, ‘number’] | | |
| | Primary Key: None | | |
| | Foreign Key: [‘student course id’, | | |
| | ‘transcript id’ | | |
| What are the | Database ID: cre_Doc_Template_Mgt | Ambiguous | The query |
| distinct template | Original Table Name: | | references ‘a |
| type descriptions | Ref_Template_Types Table Name: | | specific type’ of |
| for all documents | reference template types Original | | template without |
| using templates of | Column Names: | | specifying which |
| a specific type? | [‘Template_Type_Code’, | | template type is |
| | ‘Template_Type_Description’] | | being referred to. |
| | Column Names: [‘template type | | While the schema |
| | code’, ‘template type description’] | | provides a ‘template |
| | Column Types: [‘text’, ‘text’] Primary | | type code,’ it is not |
| | Key: [‘template type code’] Foreign | | clear which specific |
| | Key: None | | template type is |
| | Original Table Name: Templates | | meant here, causing |
| | Table Name: templates | | ambiguity in the |
| | Original Column Names: | | query's |
| | [‘Template_ID’, ‘Version_Number’, | | interpretation. |
| | ‘Template_Type_Code’, | | |
| | ‘Date_Effective_From’, | | |
| | ‘Date_Effective_To’, | | |
| | ‘Template_Details'] | | |
| | Column Names: [‘template id’, | | |
| | ‘version number’, ‘template type | | |
| | code’, ‘date effective from’, ‘date | | |
| | effective to’, ‘template details'] | | |
| | Column Types: [‘number’, ‘number’, | | |
| | ‘text’, ‘time’, ‘time’, ‘text’] | | |
| | Primary Key: [‘template id’] Foreign | | |
| | Key: [‘template type code’] | | |
| | Original Table Name: Documents | | |
| | Table Name: documents | | |
| | Original Column Names: | | |
| | [‘Document_ID’, ‘Template_ID’, | | |
| | ‘Document_Name’, | | |
| | ‘Document_Description’, | | |
| | ‘Other_Details'] Column Names: | | |
| | [‘document id’, ‘template id’, | | |
| | ‘document name’, ‘document | | |
| | description’, ‘other details'] | | |
| | Column Types: [‘number’, ‘number’, | | |
| | ‘text’, ‘text’, ‘text’] | | |
| | Primary Key: [‘document id’] Foreign | | |
| | Key: [‘template id’ | | |
| | Original Table Name: Paragraphs | | |
| | Table Name: paragraphs | | |
| | Original Column Names: | | |
| | [‘Paragraph_ID’, ‘Document_ID’, | | |
| | ‘Paragraph_Text’, ‘Other_Details'] | | |
| | Column Names: [‘paragraph id’, | | |
| | ‘document id’, ‘paragraph text’, ‘other | | |
| | details'] | | |
| | Column Types: [‘number’, ‘number’, | | |
| | ‘text’, ‘text’] | | |
| | Primary Key: [‘paragraph id’] Foreign | | |
| | Key: [‘document id’] | | |
| Which year had the | Database ID: wta_1 | Ambiguous | The term ‘major |
| most matches in a | Original Table Name: players Table | | tournament’ is |
| major | Name: players | | ambiguous because |
| tournament? | Original Column Names: [‘player_id’, | | the schema |
| | ‘first_name’, ‘last_name’, ‘hand’, | | includes a |
| | ‘birth_date’, ‘country_code’] | | ‘tourney_level’ |
| | Column Names: [‘player id’, ‘first | | column, but it is |
| | name’, ‘last name’, ‘hand’, ‘birth | | unclear how to |
| | date’, ‘country code’] Column Types: | | define a ‘major’ |
| | [‘number’, ‘text’, ‘text’, ‘text’, ‘time’, | | tournament level. |
| | ‘text’] | | The term ‘major’ |
| | Primary Key: [‘player id’] Foreign Key: | | might refer to a |
| | None | | specific value in the |
| | Original Table Name: matches Table | | ‘tourney_level’ |
| | Name: matches | | column, but without |
| | Original Column Names: [‘best_of’, | | further clarification, |
| | ‘draw_size’, ‘loser_age’, ‘loser_entry’, | | it is difficult to know |
| | ‘loser_hand’, ‘loser_ht’, ‘loser_id’, | | what values in that |
| | ‘loser_ioc’, ‘loser_name’, ‘loser_rank’, | | column should be |
| | ‘loser_rank_points', ‘loser_seed’, | | considered major |
| | ‘match_num’, ‘minutes', ‘round’, | | tournaments. |
| | ‘score’, ‘surface’, ‘tourney_date’, | | |
| | ‘tourney_id’, ‘tourney_level’, | | |
| | ‘tourney_name’, ‘winner_age’, | | |
| | ‘winner_entry’, ‘winner_hand’, | | |
| | ‘winner_ht’, ‘winner_id’, ‘winner_ioc’, | | |
| | ‘winner_name’, ‘winner_rank’, | | |
| | ‘winner_rank_points', ‘winner_seed’, | | |
| | ‘year’] | | |
| | Column Names: [‘best of’, ‘draw | | |
| | size’, ‘loser age’, ‘loser entry’, ‘loser | | |
| | hand’, ‘loser ht’, ‘loser id’, ‘loser ioc’, | | |
| | ‘loser name’, ‘loser rank’, ‘loser rank | | |
| | points', ‘loser seed’, ‘match num’, | | |
| | ‘minutes', ‘round’, ‘score’, ‘surface’, | | |
| | ‘tourney date’, ‘tourney id’, ‘tourney | | |
| | level’, ‘tourney name’, ‘winner age’, | | |
| | ‘winner entry’, ‘winner hand’, ‘winner | | |
| | ht’, ‘winner id’, ‘winner ioc’, ‘winner | | |
| | name’, ‘winner rank’, ‘winner rank | | |
| | points', ‘winner seed’, ‘year’] Column | | |
| | Types: [‘number’, ‘number’, ‘number’, | | |
| | ‘text’, ‘text’, ‘number’, ‘number’, ‘text’, | | |
| | ‘text’, ‘number’, ‘number’, ‘number’, | | |
| | ‘number’, ‘number’, ‘text’, ‘text’, ‘text’, | | |
| | ‘time’, ‘text’, | | |
| | ‘text’, ‘text’, ‘number’, ‘text’, ‘text’, | | |
| | ‘number’, ‘number’, ‘text’, ‘text’, | | |
| | ‘number’, ‘number’, ‘number’, | | |
| | ‘number’] | | |
| | Primary Key: None | | |
| | Foreign Key: [‘player id’, ‘player id’] | | |
| | Original Table Name: rankings Table | | |
| | Name: rankings | | |
| | Original Column Names: | | |
| | [‘ranking_date’, ‘ranking’, ‘player_id’, | | |
| | ‘ranking_points', ‘tours'] Column | | |
| | Names: [‘ranking date’, ‘ranking’, | | |
| | ‘player id’, ‘ranking points', ‘tours'] | | |
| | Column Types: [‘time’, ‘number’, | | |
| | ‘number’, ‘number’, ‘number’] | | |
| | Primary Key: None | | |
| | Foreign Key: [‘player id’] | | |

As shown in Table 4 below, each entry in the ground truth dataset included a natural language query, the corresponding schema context, an ambiguity label (ambiguous or unambiguous), and a brief supporting explanation.

TABLE 4
Ground Truth Ambiguity Data Entries

| NLQ | Context | Label | Explanation |
|---|---|---|---|
| Which project | Given an input Question, create a | Ambiguous | The question is |
| has the minimum | syntactically correct Oracle SQL | | asking for the |
| margin in 2023? | query to run. | | project with the |
| | Please double check that the SQL | | minimum margin |
| | query you generate is valid for | | in 2023, but the |
| | Oracle Database. | | term “margin” is |
| | Only use the table listed below. | | not clearly |
| | TABLE STRUCTURE | | defined in the |
| | ------------- | | provided context. |
| | CREATE TABLE MOVIESTREAM | | Margin can be |
| | CTS_PO C_PROJECT_ACCOUNTS | | calculated in |
| | (PROJECT_ID NUMBER, | | different ways, |
| | # identifier for a project | | such as the |
| | PROJECT_DESC | | difference |
| | VARCHAR(100 CHAR), # | | between revenue |
| | project description | | and total costs, or |
| | CUSTOMER_DEPARTMENT_ID | | as a percentage of |
| | INTEGER, | | revenue. |
| | CUSTOMER_ID_DESCRIPTION | | Additionally, the |
| | VARCHAR(100 CHAR), | | context does not |
| | BUSINESS_UNIT VARCHAR(100 | | specify which |
| | CHAR), | | costs should be |
| | MARKET_UNIT VARCHAR(100 | | included in the |
| | CHAR), | | margin |
| | MARKETS VARCHAR (100 CHAR), | | calculation (e.g., |
| | SBU1 VARCHAR(100 CHAR), | | direct costs, |
| | SBU2 VARCHAR(100 CHAR), | | indirect costs, |
| | YEAR_NUM NUMBER(4), | | account |
| | # current date is 1 July 2024 | | management |
| | ““QUARTER_ABBR_CHAR_”” | | costs, deal |
| | VARCHAR(4 CHAR), # | | pursuit costs). |
| | e.g., ““Qtr1”” | | |
| | ““MONTH_YEAR_MMM_YYYY_”” | | |
| | VARCHAR(6 CHAR), # e.g., | | |
| | ““Jul-24”” | | |
| | (has both month and year | | |
| | information) | | |
| | VERTICAL VARCHAR (100 CHAR), | | |
| | SUB_VERTICAL VARCHAR(100 | | |
| | CHAR), | | |
| | PARENT_CUSTOMER | | |
| | VARCHAR(100 CHAR), | | |
| | SERVICE_LINE VARCHAR(100 | | |
| | CHAR), | | |
| | PRACTICE_AREA VARCHAR(100 | | |
| | CHAR), PRACTICE_NAME | | |
| | VARCHAR(100 CHAR), | | |
| | ACTUAL_REVENUE | | |
| | NUMBER, # revenue | | |
| | ACTUAL_DIRECT_COSTS | | |
| | NUMBER, # cost | | |
| | ACTUAL_ACCOUNT_{—} | | |
| | MANAGEMENT NUMBER, # | | |
| | cost | | |
| | ACTUAL_INDIRECT_COSTS | | |
| | NUMBER, # cost | | |
| | ACTUAL_DEAL_PURSUIT | | |
| | NUMBER # cost | | |
| | ); | | |
| | Requirements: | | |
| | - When asked about project, return | | |
| | project ID and description. | | |
| | - Revenue, costs, and margins | | |
| | should always be first aggregated | | |
| | using SUM and GROUP BY. | | |
| | - Return the topmost row only when | | |
| | asked for the highest or lowest | | |
| | value. | | |
| | Given an input Question, create a | | |
| | syntactically correct Oracle SQL | | |
| | query to run. Please double check | | |
| | that the SQL query you generate is | | |
| | valid for Oracle Database. Only use | | |
| | the table listed below. | | |
| | TABLE STRUCTURE | | |
| | ------------------ | | |
| | CREATE TABLE | | |
| | MOVIESTREAM CTS_POC_{—} | | |
| | PROJECT_ACCOUNTS ( | | |
| | PROJECT_ID NUMBER, # | | |
| | identifier for a project | | |
| | PROJECT_DESC VARCHAR | | |
| | (100 CHAR), # project | | |
| | description | | |
| | CUSTOMER_DEPARTMENT_ID | | |
| | INTEGER, | | |
| | CUSTOMER_ID_DESCRIPTION | | |
| | VARCHAR(100 CHAR), | | |
| | BUSINESS_UNIT VARCHAR | | |
| | (100 CHAR), | | |
| | MARKET_UNIT VARCHAR | | |
| | (100 CHAR), | | |
| | MARKETS VARCHAR(100 | | |
| | CHAR), | | |
| | SBU1 VARCHAR(100 | | |
| | CHAR), | | |
| | SBU2 VARCHAR(100 | | |
| | CHAR), | | |
| | YEAR_NUM NUMBER(4), # | | |
| | current date is 1 July 2024 | | |
| | “QUARTER_ABBR_CHAR_” | | |
| | VARCHAR(4 CHAR), # e.g., | | |
| | “Qtr1” | | |
| | “MONTH_YEAR_MMM_YYYY_” | | |
| | VARCHAR(6 CHAR), # e.g., | | |
| | “Jul-24” (has both month | | |
| | and year information) | | |
| | VERTICAL VARCHAR(100 | | |
| | CHAR), | | |
| | SUB_VERTICAL VARCHAR | | |
| | (100 CHAR), | | |
| | PARENT_CUSTOMER | | |
| | VARCHAR(100 CHAR), | | |
| | SERVICE_LINE VARCHAR | | |
| | (100 CHAR), | | |
| | PRACTICE_AREA | | |
| | VARCHAR(100 CHAR), | | |
| | PRACTICE_NAME | | |
| | VARCHAR(100 CHAR), | | |
| | ACTUAL_REVENUE | | |
| | NUMBER, # revenue | | |
| | ACTUAL_DIRECT_COSTS | | |
| | NUMBER, # cost | | |
| | ACTUAL_ACCOUNT_{—} | | |
| | MANAGEMENT NUMBER, # cost | | |
| | ACTUAL_INDIRECT_COSTS | | |
| | NUMBER, # cost | | |
| | ACTUAL_DEAL_PURSUIT | | |
| | NUMBER # cost | | |
| | ); | | |
| | Requirements: | | |
| | - When asked about project, return | | |
| | project ID and description. | | |
| | - Revenue, costs, and margins | | |
| | should always be first aggregated | | |
| | using SUM and GROUP BY. | | |
| | - Return the topmost row only when | | |
| | asked for the highest or lowest | | |
| | value. | | |
| | - The margin is the difference | | |
| | between revenue and the total cost | | |
| | (includes direct, indirect, account | | |
| | management, deal pursuits) | | |
| What is the | Given an input Question, create a | Ambiguous | The question does |
| correlation | syntactically correct Oracle SQL | | not specify the |
| between | query to run. | | type of correlation |
| Revenue and | Please double check that the SQL | | to calculate (e.g., |
| Margin for all | query you generate is valid for | | Pearson |
| accounts in | Oracle Database. Only use the | | correlation |
| business unit | table listed below. | | coefficient, |
| “BU1” | TABLE STRUCTURE | | Spearman rank |
| | ------------------ | | correlation |
| | CREATE TABLE | | coefficient, etc.). |
| | MOVIESTREAM | | Or how to present |
| | CTS_POC_PROJECT_ACCOUNTS ( | | the correlation |
| | PROJECT_ID NUMBER, # identifier | | |
| | for a project | | |
| | PROJECT_DESC VARCHAR(100 | | |
| | CHAR), # | | |
| | project description | | |
| | CUSTOMER_DEPARTMENT_ID | | |
| | INTEGER, | | |
| | CUSTOMER_ID_DESCRIPTION | | |
| | VARCHAR (100 CHAR), | | |
| | BUSINESS_UNIT VARCHAR(100 | | |
| | CHAR), MARKET_UNIT | | |
| | VARCHAR(100 CHAR), MARKETS | | |
| | VARCHAR(100 CHAR), | | |
| | SBU1 VARCHAR(100 CHAR), SBU2 | | |
| | VARCHAR(100 CHAR), | | |
| | YEAR_NUM NUMBER(4), # current | | |
| | date is 1 July 2024 | | |
| | “QUARTER_ABBR_CHAR_” | | |
| | VARCHAR(4 CHAR), # e.g., “Qtr1” | | |
| | “MONTH_YEAR_MMM_YYYY_” | | |
| | VARCHAR(6 | | |
| | CHAR), # e.g., “Jul-24” (has both | | |
| | month and year information) | | |
| | VERTICAL VARCHAR(100 CHAR), | | |
| | SUB_VERTICAL VARCHAR(100 | | |
| | CHAR), PARENT_CUSTOMER | | |
| | VARCHAR(100 CHAR), | | |
| | SERVICE_LINE VARCHAR(100 | | |
| | CHAR), PRACTICE_AREA | | |
| | VARCHAR(100 CHAR), | | |
| | PRACTICE_NAME VARCHAR(100 | | |
| | CHAR), ACTUAL_REVENUE | | |
| | NUMBER, # revenue | | |
| | ACTUAL_DIRECT_COSTS NUMBER, | | |
| | # cost | | |
| | ACTUAL_ACCOUNT_MANAGEMENT | | |
| | NUMBER, # cost | | |
| | ACTUAL_INDIRECT_COSTS | | |
| | NUMBER, # cost | | |
| | ACTUAL_DEAL_PURSUIT NUMBER | | |
| | # cost | | |
| | ); | | |
| | Requirements: | | |
| | - When asked about project, return | | |
| | project ID and description. | | |
| | - Revenue, costs, and margins | | |
| | should always be first aggregated | | |
| | using SUM and GROUP BY. | | |
| | - Return the topmost row only when | | |
| | asked for the highest or lowest | | |
| | value. | | |
| | - The margin is the difference | | |
| | between revenue and the total cost | | |
| | (includes direct, indirect, account | | |
| | management, deal pursuits) | | |
| What is the | Given an input Question, create a | Ambiguous | The question is |
| movement in | syntactically correct Oracle SQL | | asking for the |
| margin from | query to run. | | “movement in |
| 2022 to 2023? | Please double check that the SQL | | margin” from 2022 |
| | query you generate is valid for | | to 2023, which |
| | Oracle Database. Only use the | | implies a |
| | table listed below. | | calculation of the |
| | TABLE STRUCTURE | | difference in |
| | ------------------ | | margin between |
| | CREATE TABLE MOVIESTREAM | | the two years. |
| | CTS_POC_ PROJECT_ACCOUNTS ( | | However, the |
| | PROJECT_ID NUMBER, # | | question does not |
| | identifier for a project | | specify what type |
| | PROJECT_DESC VARCHAR | | of margin is being |
| | (100 CHAR), # project description | | referred to (e.g., |
| | CUSTOMER_DEPARTMENT_{—} | | total margin, |
| | ID INTEGER, | | average margin, |
| | CUSTOMER_ID_DESCRIPTION | | margin for a |
| | VARCHAR(100 CHAR), | | specific project or |
| | BUSINESS_UNIT VARCHAR (100 | | customer). |
| | CHAR), | | Additionally, the |
| | MARKET_UNIT VARCHAR (100 | | question does not |
| | CHAR), | | clarify whether |
| | MARKETS VARCHAR(100 CHAR), | | the margin should |
| | SBU1 VARCHAR(100 CHAR), | | be calculated at |
| | SBU2 VARCHAR(100 CHAR), | | the project level |
| | YEAR_NUM NUMBER(4), # | | or aggregated |
| | current date is 1 July 2024 | | across all |
| | “QUARTER_ABBR_CHAR_” | | projects. |
| | VARCHAR(4 CHAR), # e.g., | | |
| | “Qtr1” | | |
| | “MONTH_YEAR_MMM_YYYY_” | | |
| | VARCHAR(6 CHAR), # e.g., | | |
| | “Jul-24” (has both month and | | |
| | year information) | | |
| | VERTICAL VARCHAR(100 CHAR), | | |
| | SUB_VERTICAL VARCHAR (100 | | |
| | CHAR), | | |
| | PARENT_CUSTOMER | | |
| | VARCHAR(100 CHAR), | | |
| | SERVICE_LINE VARCHAR(100 | | |
| | CHAR), | | |
| | PRACTICE_AREA VARCHAR(100 | | |
| | CHAR), PRACTICE_NAME | | |
| | VARCHAR(100 CHAR), | | |
| | ACTUAL_REVENUE | | |
| | NUMBER, # revenue | | |
| | ACTUAL_DIRECT_COSTS | | |
| | NUMBER, # cost | | |
| | ACTUAL_ACCOUNT_MANAGEMENT | | |
| | NUMBER, # cost | | |
| | ACTUAL_INDIRECT_COSTS | | |
| | NUMBER, # cost | | |
| | ACTUAL_DEAL_PURSUIT | | |
| | NUMBER, # cost | | |
| | ); | | |
| | Requirements: | | |
| | - When asked about project, return | | |
| | project ID and description. | | |
| | - Revenue, costs, and margins | | |
| | should always be first aggregated | | |
| | using SUM and GROUP BY. | | |
| | - Return the topmost row only when | | |
| | asked for the highest or lowest | | |
| | value. | | |
| | - The margin is the difference | | |
| | between revenue and the total cost | | |
| | (includes direct, indirect, account | | |
| | management, deal pursuits) | | |

### Ambrosia Baseline Specific Ambiguity Detection

To establish a baseline performance of advanced large language models for ambiguity detection in natural language-to-SQL translation, a controlled experiment was conducted using the Ambrosia dataset. This dataset comprised 892 unambiguous and 381 ambiguous natural language queries, each paired with a structured database schema context. The primary objective of this experiment was to assess and compare the ability of three advanced large language models—Command R+, Llama 3.1-405B, and GoCoder M1 Premium—to accurately distinguish between ambiguous and unambiguous queries using a standardized evaluation protocol.

Each model was provided with the same “baseline prompt,” which instructed the model to classify each natural language query as either ambiguous or unambiguous with respect to the supplied schema. The baseline prompt was designed to be general and did not include definitions or examples of ambiguity, serving as a reference point for subsequent prompt and model refinements (see below exemplary prompt). For each query in the dataset, the model was required to output a binary label only; no explanation or supporting text was requested or evaluated in this setup.

Ambrosia Prompt - Baseline

```
def get_baseline_prompt (context, question):
    prompt = \
    ‘”
    The task is to identify ambiguous question in English that are intended to interact with an
SQLite database. Questions can take the form of an instruction or command and can be
ambiguous, meaning they can be interpreted in different ways (corresponding to different SQL
queries that produce different results). Answer True or False, and do not include any
explanations.
  Given the following SQLite database schema:
  ## SQL_DATABASE_DUMP: % s
  Is the following question ambiguous:
  ## QUESTION: % s
  ‘” % (context, question)
  return prompt
```

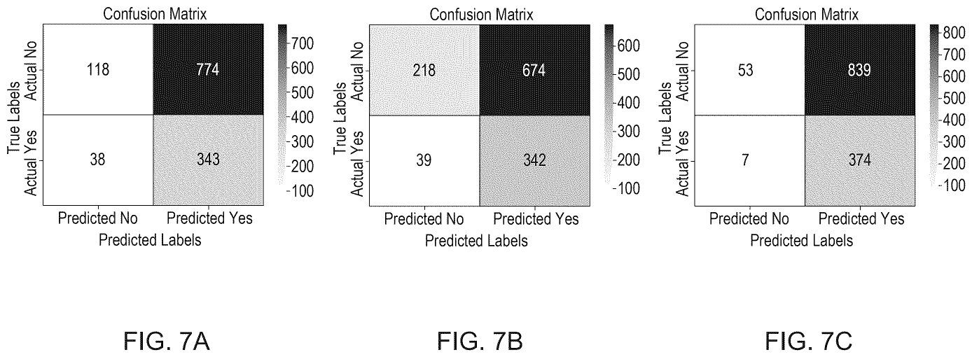

Model performance was evaluated using several standard metrics, including ambiguous recall (the proportion of true ambiguous queries correctly identified), ambiguous precision (the proportion of queries labeled as ambiguous that are truly ambiguous), unambiguous recall, unambiguous precision, weighted F1 score, macro F1 score, and overall accuracy. See Table 5. To facilitate a comprehensive interpretation of results, the output of each model was also summarized in a confusion matrix (see FIGS. 7A-7C), which cross-tabulates predicted and actual labels. In this context, the upper left quadrant of the confusion matrix represents true negatives (unambiguous queries correctly identified), the upper right quadrant represents false positives (unambiguous queries mislabeled as ambiguous), the lower left quadrant represents false negatives (ambiguous queries mislabeled as unambiguous), and the lower right quadrant represents true positives (ambiguous queries correctly identified).

The Command R+ model (see the first row in Table 5 and FIG. 7A) demonstrated high recall for ambiguous queries, identifying 90% of ambiguous cases. The confusion matrix for this model revealed a pronounced tendency to over-predict ambiguity, with a large number of unambiguous queries misclassified as ambiguous (774 false positives versus 118 true negatives). The model achieved 343 true positives and 38 false negatives for ambiguous queries. This resulted in an ambiguous precision of 0.31, unambiguous recall of 0.13, unambiguous precision of 0.76, a weighted F1 score of 0.29, and an overall accuracy of 0.36. The confusion matrix illustrated that while the model was sensitive to ambiguous utterances, it struggled to correctly identify unambiguous queries, leading to a skewed classification profile.

The Llama 3.1-405B model (see the second row in Table 5 and FIG. 7B) achieved a similar ambiguous recall of 0.90 but showed improved performance in distinguishing unambiguous queries. The number of true negatives increased to 218, and false positives were reduced to 674. The number of true positives (342) and false negatives (39) were consistent with the previous model. This model's ambiguous precision was 0.34, unambiguous recall was 0.24, unambiguous precision was 0.85, weighted F1 score was 0.41, and overall accuracy was 0.44. The narrative summary of the confusion matrix indicated a modest improvement in unambiguous query identification and a slightly better balance between recall and precision.

The GoCoder M1 Premium model (see the third row in Table 5 and FIG. 7C) exhibited the highest recall for ambiguous queries, reaching 0.98, and the highest number of true positives (374) among the three models. However, this was accompanied by a substantial increase in false positives (839), with only 53 true negatives and 7 false negatives. The ambiguous precision was 0.31, unambiguous recall was 0.06, unambiguous precision was 0.88, weighted F1 score was 0.22, and overall accuracy was 0.34. The confusion matrix for this model reflected a pronounced sensitivity to ambiguity, resulting in a high rate of over-identification and limited capacity to correctly classify unambiguous cases.

In summary, all three models demonstrated strong recall for ambiguous queries using the baseline prompt, but this performance came at the expense of precision, particularly in classifying unambiguous queries. The results revealed a consistent trade-off between capturing ambiguous cases and minimizing false positives. The results underscore the limitations of current LLM-based ambiguity detection and support the need for more adaptive and configurable frameworks.

TABLE 5
Results of Ambrosia Baseline Specific Ambiguity Detection

| | Ambig. | Ambig. | Unambig. | Unambig. | Weighted | Macro | |
|---|---|---|---|---|---|---|---|
| LLM | Recall | Precision | Recall | Precision | F1 | F1 | Accuracy |
| Command | 0.9 | 0.31 | 0.13 | 0.76 | 0.29 | 0.34 | 0.36 |
| R+ | | | | | | | |
| Llama 3.1- | 0.9 | 0.34 | 0.24 | 0.85 | 0.41 | 0.43 | 0.44 |
| 405B | | | | | | | |
| GoCoder | 0.98 | 0.31 | 0.06 | 0.88 | 0.22 | 0.29 | 0.34 |
| M | | | | | | | |
| Premium | | | | | | | |

Abbreviations:
Ambig.: Ambiguous;
Unambig.: Unambiguous

### Ambrosia Prompt—Ambiguity Definitions and Examples

To investigate the effect of prompt design on ambiguity detection performance, a series of targeted experiments were conducted using the Llama 3.1-405B LLM and the Ambrosia dataset. The primary objective of these experiments was to evaluate how the inclusion of ambiguity definitions and illustrative examples within the prompt influenced the model's capacity to accurately distinguish between ambiguous and unambiguous queries in the context of text-to-SQL translation.

The Ambrosia dataset used in these experiments consisted of 71 unambiguous and 29 ambiguous queries, each paired with a structured schema context. Three prompt configurations were evaluated: a baseline prompt with no definitions or examples, a prompt augmented with explicit definitions of ambiguity types, and a prompt containing both definitions and representative examples of ambiguous queries. Each prompt version instructed the model to classify each query as ambiguous or unambiguous with respect to the provided schema context, without generating supporting explanations. See below for an exemplary prompt:

def get_baseline_prompt (context, question):
prompt = \

‘”

```
    The task is to identify ambiguous question in English that are intended to interact with an
SQLite database. Questions can take the form of an instruction or command and can be
ambiguous, meaning they can be interpreted in different ways (corresponding to different SQL
queries that produce different results).
  The Ambiguities could be of three types:
```

| | |
|---|---|
| - | ** Scope ambiguity** arises when it is unclear which elements a quantifier, such as |
| | “each”, “every”, or “all” refers to. |
| - | **Attachment ambiguity** occurs when it is unclear how a modifier of phrase is attached |
| | to the rest of the sentence. |
| - | **Vagueness ambiguity** occurs when context creates uncertainty about which set of |
| | entities is being referred to. |

```
  Answer True or False, and do not include any explanations.
  Review your answer and revise if required.
  Given the following SQLite database schema:
  ## SQL_DATABASE_DUMP: % s
  Is the following question ambiguous:
  ## QUESTION: % s
  ‘” % (context, question)
  return prompt
```

Evaluation metrics included ambiguous recall, ambiguous precision, unambiguous recall, unambiguous precision, weighted F1 score, macro F1 score, and overall accuracy (see Table 6).

With the baseline prompt, the Llama 3.1-405B model achieved strong recall for ambiguous queries (0.93), correctly identifying most ambiguous cases. However, this performance was offset by a lower ambiguous precision (0.34) and a modest unambiguous recall (0.27), indicating a tendency to over-predict ambiguity. The overall accuracy was 0.46, and the weighted F1 score was 0.44.

When the prompt was supplemented with explicit definitions of ambiguity, the model's recall for ambiguous queries remained high (0.90), but ambiguous precision dropped to 0.29, and unambiguous recall decreased to 0.10. This result demonstrated that, although the model continued to detect most ambiguous queries, the addition of definitions alone led to a decline in the correct identification of unambiguous cases, resulting in more unambiguous queries being incorrectly flagged as ambiguous. The accuracy for this configuration was 0.33, and the weighted F1 score was 0.25.

In the final experiment, the prompt was further enriched with definitions and explicit examples of ambiguous queries. This configuration produced a more balanced performance, with ambiguous recall at 0.79, ambiguous precision at 0.28, unambiguous recall at 0.17, and unambiguous precision at 0.67. The overall accuracy was 0.35, and the weighted F1 score was 0.31. The inclusion of both definitions and examples improved the model's ability to correctly identify ambiguous cases without a substantial increase in false positives, achieving a more equitable trade-off between recall and precision.

In summary, the experiments demonstrated that prompt engineering-specifically, the inclusion of detailed definitions and contextually relevant examples-significantly influenced the performance profile of the Llama 3.1-405B model in ambiguity detection tasks. While recall for ambiguous queries remained relatively robust across configurations, the trade-off with precision and unambiguous recall highlighted the importance of prompt design in calibrating model sensitivity and specificity. These findings supported the conclusion that context-aware prompting, particularly when paired with representative examples, can enhance the reliability of large language models in distinguishing ambiguous from unambiguous queries in text-to-SQL applications.

TABLE 6
Ambiguity Definitions and Examples Results:

| | Ambig. | Ambig. | Unambig. | Unambig. | Weighted | |
|---|---|---|---|---|---|---|
| Experiment | Recall | Precision | Recall | Precision | F1 | Accuracy |
| Base Prompt | 0.93 | 0.34 | 0.27 | 0.9 | 0.44 | 0.46 |
| (no criteria) | | | | | | |
| Add | 0.9 | 0.29 | 0.1 | 0.7 | 0.25 | 0.33 |
| definitions of | | | | | | |
| ambiguities | | | | | | |
| Add | 0.79 | 0.28 | 0.17 | 0.67 | 0.31 | 0.35 |
| definitions | | | | | | |
| and example of | | | | | | |
| ambiguities | | | | | | |

Abbreviations:
Ambig.: Ambiguous;
Unambig.: Unambiguous

Error analysis was conducted to further characterize the limitations and operational challenges encountered during ambiguity detection experiments using the Llama 3.1-405B model and the Ambrosia dataset (see below). This analysis focused on reviewing instances where the model's predicted ambiguity labels diverged from the ground truth annotations, with attention to both false positives (unambiguous queries misclassified as ambiguous) and false negatives (ambiguous queries misclassified as unambiguous).

Error Analysis

```
Query: Give me the phone numbers and full addresses including postal codes of pop music fans.
Context: CREATE TABLE Albums (
  AlbumID INTEGER PRIMARY KEY,
  Title TEXT,
  ReleaseYear INTEGER,
  ArtistID INTEGER,
  FOREIGN KEY(ArtistID) REFERENCES Artists(ArtistID)
);
CREATE TABLE Artists (
  ArtistID INTEGER PRIMARY KEY,
  Name TEXT,
  Genre TEXT
);
CREATE TABLE Concerts (
  ConcertID INTEGER PRIMARY KEY,
  Date DATETIME,
  City TEXT,
  Country TEXT,
  VenueName TEXT,
  HeadlineArtistID INTEGER,
  FOREIGN KEY(HeadlineArtistID) REFERENCES Artists(ArtistID)
);
CREATE TABLE Customers (
  CustomerID INTEGER PRIMARY KEY,
  FirstName TEXT,
  LastName TEXT,
  Email TEXT,
  PhoneNumber VARCHAR(15),
  ″″“AddressLine″″ TEXT,
  ″″PostalCode″″ TEXT);
CREATE TABLE Tickets (
  TicketID INTEGER PRIMARY KEY,
  PurchaseDate DATETIME,
  SeatNumber TEXT,
  CustomerID INTEGER,
  ConcertID INTEGER,
  Price DECIMAL(10,2),
  FOREIGN KEY(CustomerID) REFERENCES Customers(CustomerID),
  FOREIGN KEY(ConcertID) REFERENCES Concerts(ConcertID)
);
Ground Label: Unambiguous
LLM Prediction: Ambiguous
“We think the team labeled unambiguous because the query is linguistically correct. But it has
ambiguities from NLSQL or domain angle: No definition of Music which can be directly referred
from schema. Definition of term Fan is unknown”
```

A review of model outputs revealed that misclassifications frequently occurred in cases involving queries with schema elements that had similar or duplicate names. For example, queries where a column could refer to either “performer_name” or “artist_name” in the schema were sometimes labeled ambiguous by the model, even when annotators considered these terms interchangeable due to identical underlying data. Similar patterns were observed with table ambiguity, where multiple tables with overlapping columns led to uncertainty in mapping user language to schema structure. In these scenarios, the model tended to err on the side of caution, flagging queries as ambiguous when the schema context did not unambiguously specify the intended mapping.

Other error types included join ambiguity, where the correct source of an attribute could be either of two joined tables, and precomputed aggregate ambiguity, where the model had to determine whether to compute an aggregate on-the-fly or use a precomputed value from a dedicated table. In these cases, the model's predictions reflected uncertainty about the appropriate query construction, particularly in the absence of explicit guidance in the prompt or schema documentation.

The analysis also highlighted the impact of vague or open-ended user language. Queries that relied on domain knowledge, contained implicit assumptions, or included undefined business terms were more likely to be misclassified. For example, queries using terms such as “fan” or “music” that were not directly represented in the schema led to ambiguity in model interpretation. In certain cases, the model identified ambiguity where annotators did not, suggesting differences in the interpretation of domain concepts or annotation standards.

Discrepancies between model and ground truth labels were further influenced by the quality and consistency of dataset annotations. In some instances, queries labeled unambiguous by human annotators were flagged as ambiguous by the model due to lack of explicit schema mapping or the presence of terms with multiple potential interpretations. These findings pointed to the importance of clear annotation guidelines, representative schema documentation, and prompt engineering to reduce subjectivity and improve alignment between automated and human ambiguity assessment.

The error analysis underscored that the model's tendency to maximize recall for ambiguous cases often resulted in increased false positive rates, especially in the absence of detailed ambiguity definitions or illustrative examples in the prompt. The inclusion of definitions and examples in subsequent experiments was found to improve calibration, but certain forms of ambiguity (e.g., particularly those rooted in domain-specific language or schema complexity) remained challenging. In summary, the error analysis provided diagnostic insight into the operational boundaries of the ambiguity detection system, identified recurring sources of misclassification, and informed refinements to prompt design, annotation practices, and schema documentation.

### AmbiQT

The evaluation of ambiguity detection performance was extended to the AmbiQT dataset to further benchmark the system's ability to classify natural language queries as ambiguous or unambiguous within diverse schema contexts. The objective of this experiment was to assess the Command R+ model's effectiveness in distinguishing between ambiguous and unambiguous queries and to analyze the types of errors observed in this setting.

The AmbiQT dataset was originally created using T5-based models prior to the widespread adoption of LLMs and includes queries and corresponding schema contexts curated to test ambiguity recognition in text-to-SQL translation. The dataset includes both ambiguous and unambiguous queries, with ambiguity labels assigned based on schema structure and domain knowledge. The dataset presents notable challenges related to annotation standards and ambiguity definitions. In particular, the labeling conventions sometimes reflect the limitations of prior model architectures, and cases of subtle or context-dependent ambiguity may be inconsistently annotated.

In the experimental setup, the Command R+ model was presented with each query and its associated schema context from the AmbiQT dataset. The model was tasked with assigning an ambiguity label to each query, categorizing it as either ambiguous or unambiguous according to its internal analysis of the schema and query language. Performance was measured using recall metrics for both unambiguous and ambiguous cases. The model achieved an unambiguous recall of 0.87, indicating a high rate of correct identification for unambiguous queries, while the ambiguous recall was 0.35, reflecting a more limited ability to detect ambiguous queries under these conditions.

As shown below in the error analysis, several issues were observed during evaluation. The experiment identified inconsistencies in ambiguity labeling and a lack of common-sense reasoning, both of which contributed to discrepancies between system predictions and ground truth annotations. Error analysis was performed by reviewing example queries where the model's predictions diverged from the annotated ground truth. In one example, the query “Show the name of teachers aged either 32 or 33?” was paired with a schema containing both “title” and “full_name” columns in the “teacher” table. The ground truth label was ambiguous, citing the potential for confusion between the two similarly named columns. The Command R+ model, however, labeled the query as unambiguous, interpreting the schema as providing sufficient information to map the query terms directly to schema elements without ambiguity.

In a second example, the query “Find the number of pets for each student who has any pet and student id.” was presented with a schema where the “student” table included both “id” and “student_id” columns. The ground truth label was ambiguous, noting the potential for confusion between these columns. The system labeled this query as unambiguous, reasoning that the schema provided enough detail to determine the correct mapping based on context.

These examples illustrate recurring themes in the error patterns observed: the presence of schema ambiguity, particularly where columns or tables share similar names, and the challenge of aligning model interpretation with human annotation standards. Such errors are not unique to the AmbiQT dataset but are indicative of broader limitations in handling schema complexity and context-dependent ambiguity in text-to-SQL systems. In summary, the AmbiQT experiment highlighted both strengths and challenges of the Command R+ model in ambiguity detection. High recall for unambiguous queries was observed, but detection of ambiguous cases was more limited, influenced by annotation inconsistencies and schema ambiguity. The results underscore the importance of clear labeling standards, representative schema documentation, and continued refinement of both datasets and model reasoning for robust ambiguity detection in natural language database querying.

Error Analysis

Example 1:
Query: Show the name of teachers aged either 32 or 33?
Context: course: course, staring_date, course_id | teacher: hometown, teacher_id, title, age,
full_name | course_arrange: teacher_id, grade, course_id
Ground Label: Ambiguous as Title and full_name are two different columns
System Label: Unambiguous: The query is not ambiguous. It clearly asks for the names of
teachers who are either 32 or 33 years old, and the schema provides the necessary information
to answer this query. full_name and age in table teacher.
Example 2:
Query: Find the number of pets for each student who has any pet and student id.
Context: student: id, sex, city_code, fname, lname, student_id, age, major, advisor | has_pet:
petid, stuid | pets: pettype, petid, weight, pet_age
Ground Label: Ambiguous as there are two columns for id. One Id and other student_id
System Label: Unambiguous The query is not ambiguous. it clearly asks for the count of pets for
students who have any pets, and the schema provides all the necessary information to answer
this query. student_id, has_pet table where petid and stuid are mapped.

### Impact of the Context Adherence Factor on Ambiguity Detection

The purpose of this set of experiments was to analyze and compare the impact of prompt design and the inclusion of a context adherence factor on ambiguity detection performance in text-to-SQL systems. The evaluation was conducted using the Spider synthetic dataset, which consists of queries and schema contexts designed to systematically test the ability of large language models to distinguish between ambiguous and unambiguous queries.

An example of an original prompt used in these experiments is provided below. This prompt instructed the model to analyze each natural language query in the context of a provided schema, determine whether the query was ambiguous, and assign an ambiguity probability score. The prompt included a context adherence factor as a parameter ranging from 0 to 1 that modulated the model's reliance on schema-based reasoning versus general common-sense interpretation. Higher values instructed the model to strictly adhere to schema information, while lower values allowed for greater flexibility in interpretation.

Ambiguity Detection Prompt - Original

def get_prompt(database_schema: str, user_query: str, context_adherence_factor: float) −> str:
prompt_text_v6 = f″″″
You are tasked with analyzing natural language queries to determine if they are ambiguous based
on a provided database schema. Ambiguity arises when a query has multiple possible
interpretations, lacks sufficient detail, or when information is missing from the schema needed
to generate a precise SQL statement. Ambiguous queries can confuse a database system, which
may lead to incorrect or incomplete query results.
Given the **database schema**:
{database_schema}
And the **user query**:
{user_query}
And the **contxt adherence factor** parameter:
{context_adherence_factor}
Your job is to:

| | |
|---|---|
| 1. | **Identify the relevant tables, columns, and relationships between tables using the |
| | ‘ Primary Key‘ and ‘ Foreign Key‘ in the schema and interpret the query accurately**. |
| | Use your Relational Database (RDBMS) knowledge to logically find relationships from the |
| | schema, but also apply common sense if details in the schema are ambiguous, |
| | depending on the ‘ context_adherence_factor‘ . |
| 2. | **Determine if the query is ambiguous based on the schema and the |
| | degree_of_freedom‘ value **. |

### Context Adherence Factor Parameter
The ‘ context_adherence_factor‘ parameter ranging between [0-1]. It dictates the balance
between logical reasoning based on the schema and the use of general common sense. Interpret
the degree of freedom value as follows:

| | |
|---|---|
| ∘ | **1**: Rely strictly on logical reasoning based on the schema. Avoid inferring or |
| | assuming any details that are not explicitly stated in the schema. Mark a query as |
| | ambiguous if it lacks schema information needed for a precise interpretation. |
| ∘ | **0.5**: Equally balance logical reasoning with common sense. Use schema |
| | information as a primary guide but allow some flexibility to interpret terms or phrases |
| | based on general knowledge if they make the query clearer and reduce ambiguity. |
| ∘ | **0**: Rely primarily on common sense and general understanding. Use the schema as a |
| | reference, but if the schema lacks specific details, apply reasonable assumptions to |
| | interpret the query clearly whenever possible. |

### Ambiguity Probability Score
Along with determining whether the query is ambiguous, you are required to generate a
**probability score (0-100)** indicating the likelihood of ambiguity. This score must be
consistent and reproducible based on clear criteria:

| | |
|---|---|
| ∘ | **Score closer to 100**: High confidence in ambiguity. Use this when there is strong |
| | evidence that the query is ambiguous (e.g., missing key terms or unclear relationships in |
| | the schema). |
| ∘ | **Score closer to 50**: Moderate ambiguity. There are elements in the query that could |
| | be interpreted in multiple ways but not conclusively so. |
| ∘ | **Score closer to 0**: High confidence in non-ambiguity. Use this when the query clearly |
| | matches the schema with no missing or unclear elements. |

### Database Schema
The schema can contain the following elements or a subset of these elements for each table:

| | |
|---|---|
| ∘ | **Original Table Name**: The table name as stored in the database. |
| ∘ | **Table Name**: The table name with added context or meaning. |
| ∘ | **Original Column Names**: Column names as they appear in the database. |
| ∘ | **Column Names**: Explained, meaningful column names matching the original |
| | columns. |
| ∘ | **Column Types**: Data type for each column (e.g., text, number). |
| ∘ | **Primary Key**: Primary key column of the table. |
| ∘ | **Foreign Key**: List of foreign key columns in the table, if applicable. |

### Important Note

| | |
|---|---|
| ∘ | **If a schema lacks examples or additional context, use logical reasoning to interpret the |
| | query by relating tables, columns, and relationships across tables using primary and |
| | foreign keys. Adapt reasoning according to the ‘ degree_of_freedom‘ .** |
| ∘ | **Error on the side of marking as ambiguous if the query is unclear or if there's doubt |
| | about its interpretation.** |
| ∘ | **Ensure all aspects of the query are clear within the context of the schema and align |
| | with the degree_of_freedom.** |

### Types of Ambiguity

| | |
|---|---|
| 1. | **Context Ambiguities** |

Contextual ambiguities arise when required information or relationships to interpret the query
are missing or unclear in the schema. This type includes the following subcategories:

| ∘ | **Missing Schema-Related Items**: The query references elements not present in the | |
|---|---|---|
| | schema, such as absent tables, columns, or relationships. | |
| | ◯ | **Example Query**: ″Show me the latest transactions.″ |
| | ◯ | **Ambiguity**: If there are no ″Transaction″ or ″Date″ columns, it's unclear how |
| | | to fulfill this request. |
| ∘ | **Duplicate or Similar-Sounding Context Items**: Confusion arises due to similar or | |
| | identical names. | |
| | ◯ | **Example Query**: ″What deals have been profitable?″ |
| | ◯ | **Ambiguity**: Both ″Trade″ and ″Transactions″ tables have a ″Profit″ column, so |
| | | it's unclear which is meant. |
| ∘ | **Domain-Specific Term Understanding Missing**: The query uses a term not directly | |
| | mapped to schema elements. | |
| | ◯ | **Example Query**: ″Show me the margin for the last quarter.″ |
| | ◯ | **Ambiguity**: ″Margin″ could mean Profit Margin, Interest Margin, or Trading |
| | | Margin depending on context. |
| ∘ | **Derived Definitions but Missing Instructions**: The query references a derived | |
| | business concept not directly represented in the schema. | |
| | ◯ | **Example Query**: ″Show me all valued customers.″ |
| | ◯ | **Ambiguity**: ″Valued customers″ lacks definition in the schema, and no rules |
| | | are provided for deriving it. |
| ∘ | **Value Ambiguities**: Unclear value definitions in the query make interpretation | |
| | difficult. | |
| | ◯ | **Example Query**: ″Show me high-value accounts.″ |
| | ◯ | **Ambiguity**: It's unclear whether ″high-value″ refers to account balance, |
| | | transaction count, or another measure. |
| ∘ | **Unclear Column or Table Naming**: Vague names or acronyms are difficult to interpret | |
| | without context. | |
| | ◯ | **Example Query**: ″What is the trend in MTR values?″ |
| | ◯ | **Ambiguity**: If ″MTR″ is an acronym without definition, it's unclear what it |
| | | refers to. |
| ∘ | *Unclear Metric or Criteria**: When the query specifies a condition or metric that could | |
| | refer to multiple columns or lacks clarity. | |
| | ◯ | **Example Query**: ″Show top-performing employees.″ |
| | ◯ | **Ambiguity**: Without a specific metric (sales, customer feedback, etc.), the |
| | | criterion for ″top-performing″ is unclear. |

| | |
|---|---|
| 2. | ** Query Ambiguitities** |

These ambiguities occur when the query itself lacks clarity, regardless of schema content.

| ∘ | **Vague or Open-Ended Questions**: The query is too broad or lacks specifics to convert | |
|---|---|---|
| | into SQL. | |
| | ◯ | **Example Query**: ″Show me all accounts.″ |
| | ◯ | **Ambiguity**: It's unclear how to focus or limit the result set without criteria |
| | | (e.g., active, highbalance). |
| ∘ | **Attachment, Entities, and Properties Ambiguity**: It's unclear which entities, | |
| | properties, or relationships are intended. | |
| | ◯ | **Example Query**: ″Show me the writers and editors on a work-for-hire.″ |
| | ◯ | **Ambiguity**: It's unclear if both writers and editors or only one group is |
| | | intended. |
| ∘ | **Implicit Assumptions about Business Knowledge**: Unstated assumptions about | |
| | business terms or context specific knowledge that may not be universally understood. | |
| | ◯ | **Example Query**: ″Show me the top-performing regions.″ |
| | ◯ | **Ambiguity**: It's unclear if ″top-performing″ means revenue, customer |
| | | satisfaction, or another metric. |

| | |
|---|---|
| 3. | **Ambiguities in Calculation Scope** |

Ambiguity arises when unclear calculation scope or granularity makes interpretation
challenging.

| | |
|---|---|
| ∘ | **Example Query**: ″What was the average sales growth last year?″ |
| ∘ | **Ambiguity**: It's unclear if ″average″ refers to overall sales growth, growth by region, or |
| | product growth. |
| 4. | **LLM Recognizable Ambiguities** |

Unclear language that a language model might detect based on syntax or common usage errors.

| ∘ | **Poorly Formed or Semantically Incorrect Questions**: Queries may contain | |
|---|---|---|
| | misspellings or incorrect terminology. | |
| | ◯ | **Example Query**: ″Show me the trend of region XYZ profitment.″ |
| | ◯ | **Ambiguity**: ″Profitment″ is likely a misspelling of ″profit.″ |

| | |
|---|---|
| 5. | **Logical Contradictions or Impractical Requests**: |

Queries that seem logically inconsistent or impossible given the schema context.

| | |
|---|---|
| ∘ | **Example Query**: ″List customers who have never made a purchase and their |
| | transaction details.″ |
| ∘ | **Ambiguity**: It's contradictory to ask for ″transaction details″ for customers with ″no |
| | purchase.″ |
| ∘ | **If the query does not fit any of the above ambiguity types but still appears ambiguous, |
| | label it as ambiguous with a suitable justification and ambiguity probability. Assign both |
| | a category and a subcategory if applicable. ** |

### Instruction for Ambiguity Detection:

| 1. | **Strictly No Assumptions**: Analyze solely based on the provided schema as context | |
|---|---|---|
| | for the query asked. Avoid any assumptions unless allowed by the degree_of_freedom. | |
| 2. | **Examine the Schema**: Review all tables, columns, primary keys, foreign keys, and | |
| | data types. | |
| 3. | **Logical Reasoning**: Relate tables and columns using primary and foreign keys | |
| | wherever necessary. | |
| 4. | **Apply Consistent Ambiguity Probability Scoring**: | |
| | a. | Consider all points and assign a probability score reflecting ambiguity |
| | | confidence. |
| | b. | The probability score should be generated such that its reproduceable. |

### Instructions for Output Format **Follow Strictly**

| | |
|---|---|
| 1. | Return the output in the **Valid JSON** format only. |
| 2. | Do not output any extra space or string except the JSON output; strictly no leading or |
| | trailing text. |
| 3. | Do not have any special characters in the JSON output, always ensure the output is a |
| | valid JSON |

```
### Output Format
Return the output only in **VALID JSON** format as shown below:
{{
  ″query″: ″<user query>″,
  ″ambiguity_status″: ″<‘ True‘ if Ambiguous or ‘ False‘ if Not Ambiguous>″,
  ″ambiguity_type″: ″<Context Ambiguity, Query Ambiguity, Ambiguities in Calculation Scope,
LLM Recognizable
Ambiguity, Logical Contradiction, or None>″,
  ″ambiguity_subcategory″: ″<Specific subcategory if applicable, or None>″,
  ″ambiguity_probability″: ″<0-100 score>″,
  ″explanation″: ″<Brief explanation of the ambiguity or lack thereof>″
}}
″″″
return prompt_text_v6
```

The revised prompt (provided below) further clarified task instructions, provided more detailed guidance on ambiguity types, and included specific self-review instructions to promote consistency in output. The revised prompt maintained the use of the context adherence factor and preserved the essential structure of the original prompt, but emphasized explicit reasoning steps and output formatting.

Ambiguity Detection - Refined Prompt

```
You are an advanced SQL generation assistant. Your task is to analyze the given CONTEXT and
USER_QUESTION to identify potential ambiguities when generating an SQL query.
### INPUTS:
**CONTEXT**: Details of the database schema, including tables, columns, relationships, and
instructions.
    {database_context}
**USER_QUESTION**: The natural language query for which SQL needs to be generated.
    {user_query}
**CONTEXT_ADHERENCE_FACTOR**: A parameter guiding how strictly you should adhere to
CONTEXT vs. relying on general knowledge.
    {context_adherence_factor}
### CONTEXT_ADHERENCE_FACTOR Explanation
```

| | |
|---|---|
| ∘ | **1**: Strictly follow the CONTEXT. Avoid making inferences or assumptions not |
| | explicitly present in the CONTEXT. |
| ∘ | **0.5**: Balance reasoning equally between CONTEXT and general knowledge. Use |
| | CONTEXT as a primary guide but allow moderate flexibility. |
| ∘ | **0**: Use CONTEXT as a reference but rely more heavily on general understanding and |
| | assumptions when CONTEXT details are insufficient. |

### Types of Ambiguity

| | |
|---|---|
| 1. | **Context Ambiguities** |

Contextual ambiguities arise when required information or relationships to interpret the query
are missing or unclear in the schema. This type includes the following subcategories:

| ∘ | **Missing Schema-Related Items**: The query references elements not present in the | |
|---|---|---|
| | schema, such as absent tables, columns, or relationships. | |
| | ◯ | **Example Query**: ″Show me the latest transactions.″ |
| | ◯ | **Ambiguity**: If there are no ″Transaction″ or ″Date″ columns, it's unclear how |
| | | to fulfill this request. |
| ∘ | *Duplicate or Similar-Sounding Context Items**: Confusion arises due to similar or | |
| | identical names. | |
| | ◯ | **Example Query**: ″What deals have been profitable?″ |
| | ◯ | **Ambiguity**: Both ″Trade″ and ″Transactions″ tables have a ″Profit″ column, so |
| | | it's unclear which is meant. |
| ∘ | **Domain-Specific Term Understanding Missing**: The query uses a term not directly | |
| | mapped to schema elements. | |
| | ◯ | **Example Query**: ″Show me the margin for the last quarter.″ |
| | ◯ | **Ambiguity**: ″Margin″ could mean Profit Margin, Interest Margin, or Trading |
| | | Margin depending on context. |
| ∘ | **Derived Definitions but Missing Instructions**: The query references a derived | |
| | business concept not directly represented in the schema. | |
| | ◯ | **Example Query**: ″Show me all valued customers.″ |
| | ◯ | **Ambiguity**: ″Valued customers″ lacks definition in the schema, and no rules |
| | | are provided for deriving it. |
| ∘ | **Value Ambiguities**: Unclear value definitions in the query make interpretation | |
| | difficult. | |
| | ◯ | **Example Query**: ″Show me high-value accounts.″ |
| | ◯ | **Ambiguity**: It's unclear whether ″high-value″ refers to account balance, |
| | | transaction count, or another measure. |
| ∘ | **Unclear Column or Table Naming**: Vague names or acronyms are difficult to interpret | |
| | without context. | |
| | ◯ | **Example Query**: ″What is the trend in MTR values?″ |
| | ◯ | **Ambiguity**: If ″MTR″ is an acronym without definition, it's unclear what it |
| | | refers to. |
| ∘ | **Unclear Metric or Criteria**: When the query specifies a condition or metric that could | |
| | refer to multiple columns or lacks clarity. | |
| | ◯ | **Example Query**: ″Show top-performing employees.″ |
| | ◯ | **Ambiguity**: Without a specific metric (sales, customer feedback, etc.), the |

criterion for ″top-performing″ is unclear.

| | |
|---|---|
| 2. | ** Query Ambiguitities** |

These ambiguities occur when the query itself lacks clarity, regardless of schema content.

| ∘ | **Vague or Open-Ended Questions**: The query is too broad or lacks specifics to convert | |
|---|---|---|
| | into SQL. | |
| | ◯ | **Example Query**: ″Show me all accounts.″ |
| | ◯ | **Ambiguity**: It's unclear how to focus or limit the result set without criteria |
| | | (e.g., active, highbalance). |
| ∘ | **Attachment, Entities, and Properties Ambiguity**: It's unclear which entities, | |
| | properties, or relationships are intended. | |
| | ◯ | **Example Query**: ″Show me the writers and editors on a work-for-hire.″ |
| | ◯ | **Ambiguity**: It's unclear if both writers and editors or only one group is |
| | | intended. |
| ∘ | **Implicit Assumptions about Business Knowledge**: Unstated assumptions about | |
| | business terms or context specific knowledge that may not be universally understood. | |
| | ◯ | **Example Query**: ″Show me the top-performing regions.″ |
| | ◯ | **Ambiguity**: It's unclear if ″top-performing″ means revenue, customer |

satisfaction, or another metric.

| | |
|---|---|
| 3. | **Ambiguities in Calculation Scope** |

Ambiguity arises when unclear calculation scope or granularity makes interpretation
challenging.

| | |
|---|---|
| ∘ | **Example Query**: ″What was the average sales growth last year?″ |
| ∘ | **Ambiguity**: It's unclear if ″average″ refers to overall sales growth, growth by region, or |
| | product growth. |
| 4. | **LLM Recognizable Ambiguities** |

Unclear language that a language model might detect based on syntax or common usage errors.

| ∘ | **Poorly Formed or Semantically Incorrect Questions**: Queries may contain | |
|---|---|---|
| | misspellings or incorrect terminology. | |
| | ◯ | **Example Query**: ″Show me the trend of region XYZ profitment.″ |

**Ambiguity**: ″Profitment″ is likely a misspelling of ″profit.″
### Instructions for Ambiguity Detection

| 1. | Carefully review the CONTEXT (database schema, tables, relationships, etc.) to | |
|---|---|---|
| | understand its structure. | |
| 2. | Analyze the USER_QUESTION for potential ambiguities based on the CONTEXT and the | |
| | CONTEXT_ADHERENCE_FACTOR. | |
| 3. | Avoid any assumptions unless allowed by the CONTEXT_ADHERENCE_FACTOR. | |
| 4. | Use the AMBIGUITY TYPES as guidance. If no category fits, identify the ambiguity and | |
| | explain. | |
| 5. | Treat unclear or uncertain queries as ambiguous unless the DEGREE OF FREEDOM | |
| | allows assumptions. | |
| 6. | Provide an **ambiguity probability score (0-100)**: | |
| | a. | **Close to 100**: Strong evidence of ambiguity. |
| | b. | **Close to 50**: Moderate ambiguity with some uncertainties. |
| | c. | **Close to 0**: High confidence in non-ambiguity. |

| | |
|---|---|
| 7. | **Self-Review Instruction**: After completing the analysis, review your reasoning for |

consistency and ensure that your explanation aligns with the assigned ambiguity status and
probability score.
Adjust if necessary to maintain accuracy and clarity.
### Instructions for Output Format **Follow Strictly**

| | |
|---|---|
| 1. | Return the output in the **Valid JSON** format only. |
| 2. | Do not output any extra space or string except the JSON output; strictly no leading or |
| | trailing text. |
| 3. | Do not have any special characters in the JSON output, always ensure the output is a |
| | valid JSON. |
| 4. | Strictly **do not output malformed string** and no Missing or misaligned curly braces in |
| | the JSON output. |

```
### Output Format (Strict JSON)
Return your output in **valid JSON** format only:
{{
    ″query″: ″<USER_QUESTION>″,
    ″ambiguity_status″: ″< ‘ True‘ if ambiguous, ‘ False‘ if not>″,
  ″ambiguity_probability″: ″<0-100>″,
  ″explanation″: ″<Reasoning for ambiguity_status>″
}}
```

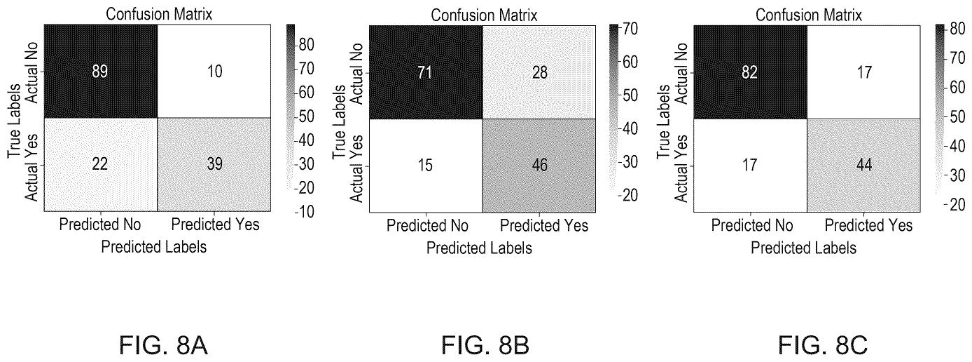

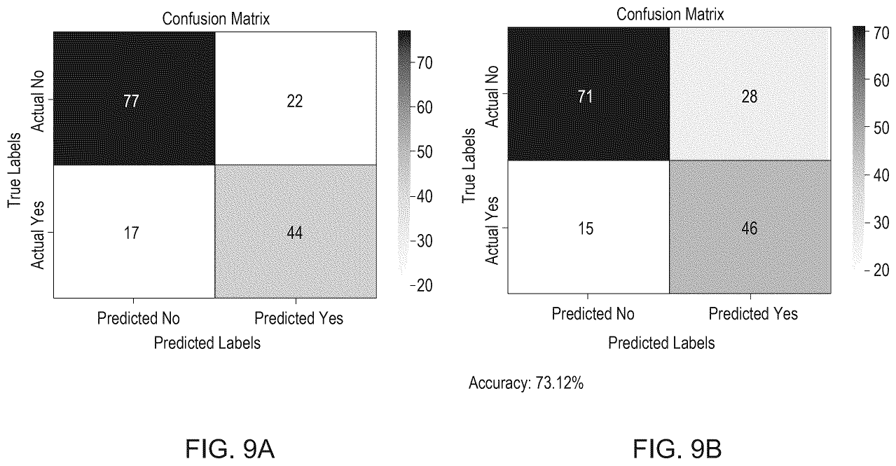

For each experiment (see Tables 7A and 7B), the Command R+ model was presented with synthetic queries and schema contexts from the Spider dataset. The model was evaluated under multiple settings of the context adherence factor (1, 0.5, and 0) and with both the original and revised prompt versions. Performance metrics included ambiguous recall, ambiguous precision, unambiguous recall, unambiguous precision, weighted F1 score, macro F1 score, accuracy, and mean explanation similarity (cosine). The performance of the system was assessed under both strict and flexible context adherence settings, with results quantified in Tables 7A and 7B and corresponding confusion matrices depicted in FIGS. 8A-8C and FIGS. 9A and 9B, respectively.

As observed in Table 7A, the results from the original prompt demonstrated that strict schema adherence (context adherence factor=1) yielded an ambiguous recall of 0.64, ambiguous precision of 0.80, unambiguous recall of 0.90, and unambiguous precision of 0.80. The weighted F1 and macro F1 scores were 0.79 and 0.78, respectively, with an overall accuracy of 0.80. Additionally, as shown in FIG. 8A, the confusion matrix revealed that the model demonstrated a strong capacity to identify unambiguous queries, as reflected by the prominent diagonal in the lower left quadrant (89 true negatives out of 99 possible unambiguous cases). However, this strictness also resulted in a notable number of ambiguous queries being overlooked (22 false negatives), as the model erred on the side of caution, declining to infer ambiguity in the absence of explicit schema cues. The relatively low number of false positives (10) further confirmed a conservative classification strategy. In sum, this configuration favored precision in the unambiguous class while sacrificing some sensitivity to ambiguous cases.

As the context adherence factor was reduced to 0.5, recall for ambiguous queries increased to 0.75, while ambiguous precision and unambiguous recall showed moderate variation (see Table 7A, second row). Additionally, as can be appreciated in FIG. 8B, the number of ambiguous queries correctly identified (true positives) increased to 46, while the count of ambiguous queries missed (false negatives) decreased to 15. This improvement in ambiguous recall, however, came at the expense of an increased rate of false positives (28), as the model became more willing to flag queries as ambiguous even when schema evidence was less definitive. The more balanced distribution between the lower left and upper right quadrants of the matrix illustrated a greater willingness to admit ambiguity, reflecting a model more attuned to subtle or context-dependent uncertainty.

At the most flexible setting (context adherence factor=0), recall for ambiguous queries increased to 0.72, while ambiguous precision and unambiguous recall showed moderate variation. A balanced performance was achieved, with ambiguous precision and unambiguous precision both at 0.72 and 0.83, respectively, and accuracy at 0.79. As shown in FIG. 8C, the model achieved its highest overall recall for ambiguous queries (44 true positives), while maintaining a robust identification rate for unambiguous cases (82 true negatives). The false positive and false negative rates were more evenly distributed (17 each), indicating that the model, when granted greater interpretive freedom, could more consistently recognize a wider variety of ambiguity forms, though some trade-off in specificity remained.

TABLE 7A
Spider Synthetic

| Context | | | | | | | |
|---|---|---|---|---|---|---|---|
| Adherence | Ambig. | Ambig. | Unambig. | Unambig. | Weigthed | Macro | |
| Factor | Recall | Precision | Recall | Precision | F1 | F1 | Accuracy |
| 1 | 0.64 | 0.8 | 0.9 | 0.8 | 0.79 | 0.78 | 0.80 |
| 0.5 | 0.75 | 0.62 | 0.72 | 0.83 | 0.73 | 0.72 | 0.73 |
| 0 | 0.72 | 0.72 | 0.83 | 0.83 | 0.79 | 0.77 | 0.79 |

As shown in Table 7B, under strict context adherence (context adherence factor=1), the model achieved an ambiguous recall of 0.72, ambiguous precision of 0.67, unambiguous recall of 0.78, and unambiguous precision of 0.82. The weighted F1 score was 0.76, with a macro F1 score of 0.75 and an overall accuracy of 0.86. The confusion matrix in FIG. 9A further illustrates these results: the model correctly identified 77 unambiguous queries (true negatives) and 44 ambiguous queries (true positives), while misclassifying 22 unambiguous queries as ambiguous (false positives) and 17 ambiguous queries as unambiguous (false negatives). This configuration supported a high level of precision for both ambiguous and unambiguous cases, with the diagonal dominance in the confusion matrix reflecting balanced and reliable discrimination between the two classes.

When the context adherence factor was set to 0, reflecting a more flexible reasoning strategy, the model maintained a robust ambiguous recall of 0.75 and ambiguous precision of 0.62, with unambiguous recall and precision at 0.72 and 0.83, respectively (see Table 7B, second row). The overall accuracy was 0.73. The confusion matrix in FIG. 9B shows 71 correct identifications of unambiguous queries (true negatives) and 46 ambiguous queries (true positives), with 28 false positives and 15 false negatives. This setting resulted in a model that was more willing to classify queries as ambiguous, as evidenced by the increase in false positives and true positives relative to the stricter setting. The trade-off between recall and precision was evident, with the model capturing a broader range of ambiguous cases at the expense of some additional misclassification of unambiguous queries.

TABLE 7B
Spider Synthetic - Revised Prompt

| Context | | | | | | | |
|---|---|---|---|---|---|---|---|
| Adherence | Ambig. | Ambig. | Unambig. | Unambig. | Weigthed | Macro | |
| Factor | Recall | Precision | Recall | Precision | F1 | F1 | Accuracy |
| 1 | 0.72 | 0.67 | 0.78 | 0.82 | 0.76 | 0.75 | 0.86 |
| 0 | 0.75 | 0.62 | 0.72 | 0.83 | 0.73 | 0.72 | 0.73 |

Comparison across these experiments demonstrated that both the design of the prompt and the tuning of the context adherence factor significantly influenced ambiguity detection outcomes. The inclusion of a context adherence parameter enabled granular control over the balance between schema-based reasoning and general knowledge, while the revised prompt provided additional structure and self-review, resulting in more reliable classification and explanation of ambiguous queries. The findings indicated that optimal performance was achieved when prompt instructions were explicit and context adherence was carefully configured to match the complexity and domain specificity of the dataset. In summary, the experiments on the Spider synthetic dataset established the importance of prompt engineering and parameter tuning in text-to-SQL ambiguity detection. The results highlighted that model sensitivity to ambiguity can be systematically adjusted through prompt design, and that the context adherence factor serves as a practical mechanism for balancing precision and recall according to application needs.

### Illustrative Method

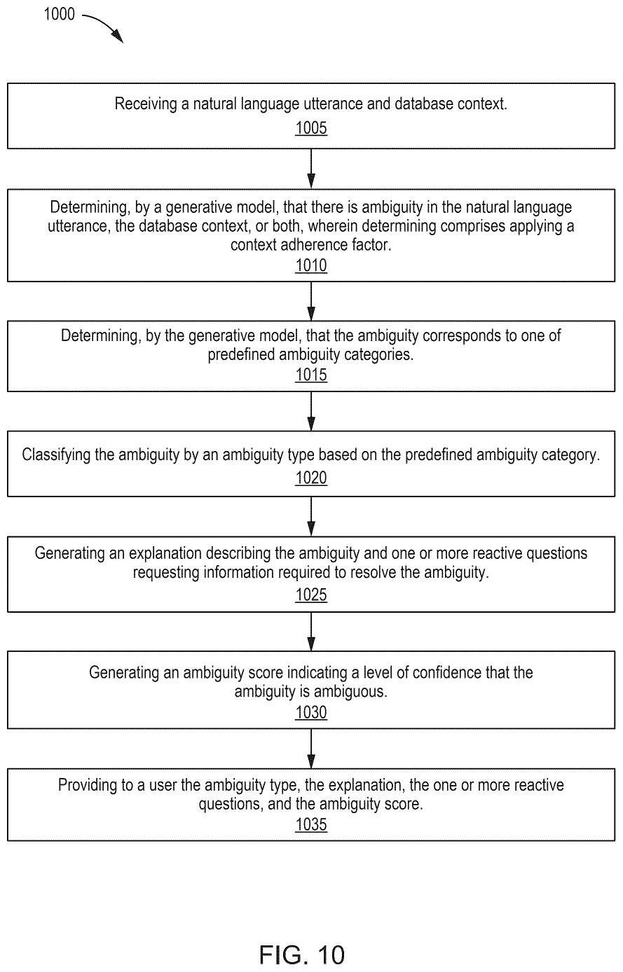

FIG. 10 is a flowchart illustrating a process 1000 for ambiguity detection in and context-driven optimization in text-to-SQL translation, according to various embodiments. The processing depicted in FIG. 10 may be implemented in software (e.g., code, instructions, program) executed by one or more processing units (e.g., processors, cores) of the respective systems, hardware, or combinations thereof. The software may be stored on a non-transitory storage medium (e.g., on a memory device). The method presented in FIG. 10 and described below is intended to be illustrative and non-limiting. Although FIG. 10 depicts the various processing steps occurring in a particular sequence or order, this is not intended to be limiting. In certain alternative embodiments, the steps may be performed in some different order, or some steps may also be performed in parallel. In certain embodiments, such as in the embodiments depicted in FIGS. 1-6, the processing depicted in FIG. 10 may be performed by an agent system (e.g., SQL agent system 200 described with respect to FIG. 2).

At box 1005, a natural language utterance and database context are received. The natural language utterance is a user-supplied query, request, or command expressed in spoken or written language that seeks information or action from a structured data source, such as a relational database. The utterance may be received via a user interface, messaging platform, application programming interface (API), or other input channel. In various embodiments, the natural language utterance may be a question such as “Show me all invoices over ten thousand dollars,” or a command such as “List customers who have not made a purchase in the last year.” The utterance may be provided as free text, voice input converted to text, or other machine-readable representations.

The database context comprises information describing the structure and semantics of the underlying data source. This context may include, but is not limited to, schema definitions that specify the names and types of tables, columns, relationships (such as primary and foreign keys), constraints, and business logic associated with the database. In some embodiments, the database context may also include sample data, metadata, explicit instructions for interpreting business terms, and illustrative example queries. The system may retrieve the database context from a schema registry, metadata service, configuration file, or directly from the data source. By combining the user's natural language utterance with the relevant database context, the system is positioned to interpret the user's intent with respect to the available data structures and business logic.

At box 1010, a generative model is used to determine that there is ambiguity in the natural language utterance, the database context, or both. Determining that there is ambiguity comprises applying a context adherence factor that balances between schema-based logical reasoning and common-sense interpretation of the generative model. At box 1010, a generative model is used to determine that there is ambiguity in the natural language utterance, the database context, or both.

Determining that there is ambiguity comprises applying a context adherence factor that balances between schema-based logical reasoning and common-sense interpretation of the generative model. The generative model analyzes the received natural language utterance together with the database context. The model evaluates whether the utterance can be mapped unambiguously to elements of the database schema or whether the language, structure, or context of the query introduces uncertainty, vagueness, or conflicting interpretations.

In various embodiments, the context adherence factor is a tunable parameter having a value within a predetermined range, such as from 0 to 1. When the context adherence factor is set to a maximum value within the range, the generative model relies exclusively on schema-based logical reasoning. In this configuration, the model interprets the utterance strictly according to the database schema and associated instructions, avoiding any inference or assumption about details not explicitly present. For example, if a user submits the query “List all accounts with high balance” and the schema does not define what constitutes “high balance” or lacks a corresponding column, the model, with the context adherence factor set to 1, identifies the query as ambiguous because the schema does not provide the necessary information to resolve the user's intent.

When the context adherence factor is set to an intermediate value within the range, the generative model prioritizes schema-based logical reasoning but also permits common-sense interpretations of terms in the natural language utterance. In this configuration, the model first attempts to map query terms to schema elements using explicit definitions, but, if the schema is incomplete or ambiguous, it applies domain knowledge or typical language usage to interpret the query. For example, if the context adherence factor is set to 0.5 and the user submits the query “Show all recent transactions,” the model may determine that “recent” is not explicitly defined in the schema but could, based on common business practice, interpret “recent” as transactions from the past 30 days or another reasonable time frame, while still flagging potential ambiguity for user confirmation.

When the context adherence factor is set to a minimum value within the range, the generative model prioritizes common-sense interpretation to resolve the natural language utterance when schema details are insufficient. In this configuration, the model relies primarily on general knowledge, conversational norms, and domain conventions, using the schema as a reference but making reasonable assumptions where explicit details are lacking. For example, if the context adherence factor is set to 0 and the user submits the query “Show me valued customers,” and the schema does not define “valued,” the model may, based on industry practice, infer that “valued customers” refers to customers with the highest purchase volume or frequency, and generate a candidate query accordingly, while potentially providing an explanation or prompt for user feedback.

In various embodiments, when a second (and/or subsequent) natural language utterance and database context is received, the generative model determines that there is no ambiguity in the second natural language utterance, database context, or both. Accordingly, a query statement in a programming language corresponding to the second natural language utterance and database context is generated. In addition to, or in alternative of, the natural language utterance and database context determined not be ambiguous may be used for other downstream processing events. For example, such cases may be incorporated into training datasets for further refining or validating the generative model, or used in ongoing model validation and performance assessment workflows.

At box 1015, the generative model determines that the ambiguity corresponds to one of predefined ambiguity categories. The predefined ambiguity categories comprise database context ambiguities, natural language utterance ambiguities, model-identifiable ambiguities, or any combination thereof. Database context ambiguities arise when the utterance references elements-such as tables, columns, or relationships—that are missing, duplicated, or undefined in the database schema. Natural language utterance ambiguities occur when the user's language is vague, open-ended, or subject to multiple interpretations, such as the use of colloquial expressions or domain-specific jargon not explicitly mapped in the schema. Model-identifiable ambiguities include cases where the generative model detects semantic inconsistencies, unclear calculation scope, or logical contradictions based on its language processing capabilities.

At box 1020, based on the predefined ambiguity category, the generative model classifies the ambiguity by an ambiguity type. For instance, if the ambiguity is identified as a database context ambiguity, the model may classify it further as a missing schema element, duplicate column, or undefined relationship. If the ambiguity is a natural language utterance ambiguity, the type may be classified as vague phrasing, implicit assumption, or attachment ambiguity.

In various embodiments, the database context ambiguity category may include a plurality of ambiguity types, comprising:
missing schema-related items, wherein the natural language utterance references elements not present in the database context, such as absent tables, columns, or relationships;
duplicate or similar-sounding context items, wherein confusion arises due to the presence of similar or identical names among tables, columns, or other schema elements;
domain-specific term understanding missing, wherein the natural language utterance includes a term that cannot be directly mapped to a schema element within the database context;
derived definitions but missing instructions, wherein the natural language utterance references a derived business concept that is not directly represented or defined in the schema;
value ambiguities, wherein the natural language utterance presents unclear value definitions that make interpretation difficult;
unclear column or table naming, wherein vague names or acronyms hinder the interpretation of the schema element referenced by the utterance; and
unclear metric or criteria, wherein the natural language utterance specifies a condition or metric that could refer to multiple columns or lacks sufficient clarity to enable precise mapping.

In various embodiments, the natural language utterance ambiguity category may include a plurality of ambiguity types, comprising:
vague or open-ended questions, wherein the natural language utterance is too broad or lacks sufficient specificity to be converted into a query statement;
attachment, entities, and properties ambiguity, wherein it is unclear which entities, properties, or relationships in the database context are intended to be referenced by the utterance; and
implicit assumptions about business knowledge, wherein the natural language utterance includes unstated assumptions regarding business terms or domain-specific knowledge that may not be universally understood or represented in the schema.

In various embodiments, the model-identifiable ambiguity category may include a plurality of ambiguity types, comprising:
ambiguities in calculation scope, wherein ambiguity arises due to unclear calculation scope or granularity, making interpretation of the requested operation challenging;
model-recognized ambiguities, wherein the large language model detects unclear language based on syntax, semantics, or common usage errors;
poorly formed or semantically incorrect questions, wherein the natural language utterance contains misspellings, syntactic errors, or incorrect terminology; and
logical contradictions or impractical requests, wherein the natural language utterance appears logically inconsistent or requests information or actions that are not possible given the database context.

In various embodiments, when a second (and/or subsequent) natural language utterance and database context is received, the generative model determines that there is ambiguity in the second natural language utterance, database context, or both. In addition, the generative model determines that the ambiguity in the second natural language utterance, the second database context, or both does not correspond to any of the predefined ambiguity categories. In such an instance, the method further comprises determining that the ambiguity in the second natural language utterance, the second database context, or both can be solved using common-sense interpretations. Accordingly, a query statement in a programming language corresponding to the second natural language utterance and the second database context is generated. In addition to, or in alternative of, natural language utterance and database context determined not be ambiguous may be used for other downstream processing events, for example model training, validation, and/or refinement.

In various embodiments, when a second (and/or subsequent) natural language utterance and database context is received, the generative model determines that there is ambiguity in the second natural language utterance, database context, or both. In addition, the generative model determines that the ambiguity in the second natural language utterance, the second database context, or both does not correspond to any of the predefined ambiguity categories. The method further comprises determining that the ambiguity in the second natural language utterance, the second database context, or both cannot be solved using common-sense interpretations. In such an instance, the method further comprises performing an iterative optimization process comprising generating, by an optimizer generative model, one or more new ambiguity categories and corresponding ambiguity instructions based on the second natural language utterance, the second database context, and the explanation.

At box 1025, the generative model generates an explanation describing the ambiguity and one or more reactive questions requesting information required to resolve the ambiguity. In various embodiments, the explanation references the specific ambiguity category and type assigned to the query, identifies the relevant schema elements, query features, or contextual factors contributing to the uncertainty, and provides the rationale for determining that the query is ambiguous. The explanation is generated in natural language and is intended to be actionable, concise, and understandable to both end users and domain experts. For example, if the ambiguity is due to a missing schema definition for a term used in the query, the explanation may state that the term “valued customer” is not defined in the current database schema and that additional clarification is required to process the request.

In various embodiments, the one or more reactive questions are designed to solicit the specific information needed to resolve the detected ambiguity. These reactive questions are tailored to the ambiguity type and context, and may prompt the user to select between multiple schema elements, specify the intended meaning of a domain-specific term, clarify vague language, or provide missing constraints or parameters relevant to the query. For instance, if the ambiguity results from a query referencing “recent transactions” without defining a time frame, the system may ask, “Please specify what time range should be considered ‘recent’ for this request.” The reactive questions are presented to the user via the interface or communication channel, initiating an interactive clarification process that enables the system to refine its understanding of the user's intent and progress toward generating an accurate, unambiguous query statement.

At box 1030, the generative model generates an ambiguity score indicating a level of confidence that the ambiguity is ambiguous. In various embodiments, the ambiguity score is generated as a numerical value within a predetermined range. A score at or near a maximum value within the range indicates a high level of confidence that the natural language utterance is ambiguous. For example, a score near the maximum value of 100 indicates that there are missing key terms or unclear relationships in the database schema. A score at or near a midpoint within the range indicates a moderate level of confidence that the natural language utterance is ambiguous. For example, a score near 50 indicates that there are elements in the natural language utterance that could be interpreted in multiple ways but not conclusively. A score at or near a minimum value within the range indicates a low level of confidence that the natural language utterance is ambiguous. For example, a score at or near a minimum value of 0 indicates the natural language utterance clearly matches the database context with no missing or unclear elements.

At box 1035, the ambiguity type, the explanation, the one or more reactive questions, and the ambiguity score are provided to a user. In various embodiments, the one or more reactive questions, and the ambiguity score are provided to the user through a graphical user interface, application programming interface, or other communication channel.

In various embodiments the method further comprises receiving a response from the user to the one or more reactive questions providing the information required to resolve the ambiguity and generating a query statement in a programming language corresponding to the natural language utterance and the database context. In addition to, or in alternative of, natural language utterance and database context determined not be ambiguous may be used for other downstream processing events, for example model training, validation, and/or refinement.

### Illustrative System

As noted above, infrastructure as a service (IaaS) is one particular type of cloud computing. IaaS can be configured to provide virtualized computing resources over a public network (e.g., the Internet). In an IaaS model, a cloud computing provider can host the infrastructure components (e.g., servers, storage devices, network nodes (e.g., hardware), deployment software, platform virtualization (e.g., a hypervisor layer), or the like). In some cases, an IaaS provider may also supply a variety of services to accompany those infrastructure components (example services include billing software, monitoring software, logging software, load balancing software, clustering software, etc.). Thus, as these services may be policy-driven, IaaS users may be able to implement policies to drive load balancing to maintain application availability and performance.

In some instances, IaaS customers may access resources and services through a wide area network (WAN), such as the Internet, and can use the cloud provider's services to install the remaining elements of an application stack. For example, the user can log in to the IaaS platform to create virtual machines (VMs), install operating systems (OSs) on each VM, deploy middleware such as databases, create storage buckets for workloads and backups, and even install enterprise software into that VM. Customers can then use the provider's services to perform various functions, including balancing network traffic, troubleshooting application issues, monitoring performance, managing disaster recovery, etc.

In most cases, a cloud computing model will require the participation of a cloud provider. The cloud provider may, but need not be, a third-party service that specializes in providing (e.g., offering, renting, selling) IaaS. An entity might also opt to deploy a private cloud, becoming its own provider of infrastructure services.

In some examples, IaaS deployment is the process of putting a new application, or a new version of an application, onto a prepared application server or the like. It may also include the process of preparing the server (e.g., installing libraries, daemons, etc.). This is often managed by the cloud provider, below the hypervisor layer (e.g., the servers, storage, network hardware, and virtualization). Thus, the customer may be responsible for handling (OS), middleware, and/or application deployment (e.g., on self-service virtual machines (e.g., that can be spun up on demand)) or the like.

In some examples, IaaS provisioning may refer to acquiring computers or virtual hosts for use, and even installing needed libraries or services on them. In most cases, deployment does not include provisioning, and the provisioning may need to be performed first.

In some cases, there are two different challenges for IaaS provisioning. First, there is the initial challenge of provisioning the initial set of infrastructure before anything is running. Second, there is the challenge of evolving the existing infrastructure (e.g., adding new services, changing services, removing services, etc.) once everything has been provisioned. In some cases, these two challenges may be addressed by enabling the configuration of the infrastructure to be defined declaratively. In other words, the infrastructure (e.g., what components are needed and how they interact) can be defined by one or more configuration files. Thus, the overall topology of the infrastructure (e.g., what resources depend on which, and how they each work together) can be described declaratively. In some instances, once the topology is defined, a workflow can be generated that creates and/or manages the different components described in the configuration files.

In some examples, an infrastructure may have many interconnected elements. For example, there may be one or more virtual private clouds (VPCs) (e.g., a potentially on-demand pool of configurable and/or shared computing resources), also known as a core network. In some examples, there may also be one or more inbound/outbound traffic group rules provisioned to define how the inbound and/or outbound traffic of the network will be set up and one or more virtual machines (VMs). Other infrastructure elements may also be provisioned, such as a load balancer, a database, or the like. As more and more infrastructure elements are desired and/or added, the infrastructure may incrementally evolve.

In some instances, continuous deployment techniques may be employed to enable deployment of infrastructure code across various virtual computing environments. Additionally, the described techniques can enable infrastructure management within these environments. In some examples, service teams can write code that is desired to be deployed to one or more, but often many, different production environments (e.g., across various different geographic locations, sometimes spanning the entire world). However, in some examples, the infrastructure on which the code will be deployed must first be set up. In some instances, the provisioning can be done manually, a provisioning tool may be utilized to provision the resources, and/or deployment tools may be utilized to deploy the code once the infrastructure is provisioned.

FIG. 11 is a block diagram 1100 illustrating an example pattern of an IaaS architecture, according to at least one embodiment. Service operators 1102 can be communicatively coupled to a secure host tenancy 1104 that can include a virtual cloud network (VCN) 1106 and a secure host subnet 1108. In some examples, the service operators 1102 may be using one or more client computing devices, which may be portable handheld devices (e.g., an iPhone®, cellular telephone, an iPad®, computing tablet, a personal digital assistant (PDA)) or wearable devices (e.g., a Google Glass® head mounted display), running software such as Microsoft Windows Mobile®, and/or a variety of mobile operating systems such as iOS, Windows Phone, Android, BlackBerry 8, Palm OS, and the like, and being Internet, e-mail, short message service (SMS), Blackberry®, or other communication protocol enabled. Alternatively, the client computing devices can be general purpose personal computers including, by way of example, personal computers and/or laptop computers running various versions of Microsoft Windows®, Apple Macintosh®, and/or Linux operating systems. The client computing devices can be workstation computers running any of a variety of commercially-available UNIX® or UNIX-like operating systems, including without limitation the variety of GNU/Linux operating systems, such as for example, Google Chrome OS. Alternatively, or in addition, client computing devices may be any other electronic device, such as a thin-client computer, an Internet-enabled gaming system (e.g., a Microsoft Xbox gaming console with or without a Kinect® gesture input device), and/or a personal messaging device, capable of communicating over a network that can access the VCN 1106 and/or the Internet.

The VCN 1106 can include a local peering gateway (LPG) 1110 that can be communicatively coupled to a secure shell (SSH) VCN 1112 via an LPG 1110 contained in the SSH VCN 1112. The SSH VCN 1112 can include an SSH subnet 1114, and the SSH VCN 1112 can be communicatively coupled to a control plane VCN 1116 via the LPG 1110 contained in the control plane VCN 1116. Also, the SSH VCN 1112 can be communicatively coupled to a data plane VCN 1118 via an LPG 1110. The control plane VCN 1116 and the data plane VCN 1118 can be contained in a service tenancy 1119 that can be owned and/or operated by the IaaS provider.

The control plane VCN 1116 can include a control plane demilitarized zone (DMZ) tier 1120 that acts as a perimeter network (e.g., portions of a corporate network between the corporate intranet and external networks). The DMZ-based servers may have restricted responsibilities and help keep breaches contained. Additionally, the DMZ tier 1120 can include one or more load balancer (LB) subnet(s) 1122, a control plane app tier 1124 that can include app subnet(s) 1126, a control plane data tier 1128 that can include database (DB) subnet(s) 1130 (e.g., frontend DB subnet(s) and/or backend DB subnet(s)). The LB subnet(s) 1122 contained in the control plane DMZ tier 1120 can be communicatively coupled to the app subnet(s) 1126 contained in the control plane app tier 1124 and an Internet gateway 1134 that can be contained in the control plane VCN 1116, and the app subnet(s) 1126 can be communicatively coupled to the DB subnet(s) 1130 contained in the control plane data tier 1128 and a service gateway 1136 and a network address translation (NAT) gateway 1138. The control plane VCN 1116 can include the service gateway 1136 and the NAT gateway 1138.

The control plane VCN 1116 can include a data plane mirror app tier 1140 that can include app subnet(s) 1126. The app subnet(s) 1126 contained in the data plane mirror app tier 1140 can include a virtual network interface controller (VNIC) 1142 that can execute a compute instance 1144. The compute instance 1144 can communicatively couple the app subnet(s) 1126 of the data plane mirror app tier 1140 to app subnet(s) 1126 that can be contained in a data plane app tier 1146.

The data plane VCN 1118 can include the data plane app tier 1146, a data plane DMZ tier 1148, and a data plane data tier 1150. The data plane DMZ tier 1148 can include LB subnet(s) 1122 that can be communicatively coupled to the app subnet(s) 1126 of the data plane app tier 1146 and the Internet gateway 1134 of the data plane VCN 1118. The app subnet(s) 1126 can be communicatively coupled to the service gateway 1136 of the data plane VCN 1118 and the NAT gateway 1138 of the data plane VCN 1118. The data plane data tier 1150 can also include the DB subnet(s) 1130 that can be communicatively coupled to the app subnet(s) 1126 of the data plane app tier 1146.

The Internet gateway 1134 of the control plane VCN 1116 and of the data plane VCN 1118 can be communicatively coupled to a metadata management service 1152 that can be communicatively coupled to public Internet 1154. Public Internet 1154 can be communicatively coupled to the NAT gateway 1138 of the control plane VCN 1116 and of the data plane VCN 1118. The service gateway 1136 of the control plane VCN 1116 and of the data plane VCN 1118 can be communicatively coupled to cloud services 1156.

In some examples, the service gateway 1136 of the control plane VCN 1116 or of the data plane VCN 1118 can make application programming interface (API) calls to cloud services 1156 without going through public Internet 1154. The API calls to cloud services 1156 from the service gateway 1136 can be one-way: the service gateway 1136 can make API calls to cloud services 1156, and cloud services 1156 can send requested data to the service gateway 1136. But, cloud services 1156 may not initiate API calls to the service gateway 1136.

In some examples, the secure host tenancy 1104 can be directly connected to the service tenancy 1119, which may be otherwise isolated. The secure host subnet 1108 can communicate with the SSH subnet 1114 through an LPG 1110 that may enable two-way communication over an otherwise isolated system. Connecting the secure host subnet 1108 to the SSH subnet 1114 may give the secure host subnet 1108 access to other entities within the service tenancy 1119.

The control plane VCN 1116 may allow users of the service tenancy 1119 to set up or otherwise provision desired resources. Desired resources provisioned in the control plane VCN 1116 may be deployed or otherwise used in the data plane VCN 1118. In some examples, the control plane VCN 1116 can be isolated from the data plane VCN 1118, and the data plane mirror app tier 1140 of the control plane VCN 1116 can communicate with the data plane app tier 1146 of the data plane VCN 1118 via VNICs 1142 that can be contained in the data plane mirror app tier 1140 and the data plane app tier 1146.

In some examples, users of the system, or customers, can make requests, for example create, read, update, or delete (CRUD) operations, through public Internet 1154 that can communicate the requests to the metadata management service 1152. The metadata management service 1152 can communicate the request to the control plane VCN 1116 through the Internet gateway 1134. The request can be received by the LB subnet(s) 1122 contained in the control plane DMZ tier 1120. The LB subnet(s) 1122 may determine that the request is valid, and in response to this determination, the LB subnet(s) 1122 can transmit the request to app subnet(s) 1126 contained in the control plane app tier 1124. If the request is validated and requires a call to public Internet 1154, the call to public Internet 1154 may be transmitted to the NAT gateway 1138 that can make the call to public Internet 1154. Metadata that may be desired to be stored by the request can be stored in the DB subnet(s) 1130.

In some examples, the data plane mirror app tier 1140 can facilitate direct communication between the control plane VCN 1116 and the data plane VCN 1118. For example, changes, updates, or other suitable modifications to configuration may be desired to be applied to the resources contained in the data plane VCN 1118. Via a VNIC 1142, the control plane VCN 1116 can directly communicate with, and can thereby execute the changes, updates, or other suitable modifications to configuration to, resources contained in the data plane VCN 1118.

In some embodiments, the control plane VCN 1116 and the data plane VCN 1118 can be contained in the service tenancy 1119. In this case, the user, or the customer, of the system may not own or operate either the control plane VCN 1116 or the data plane VCN 1118. Instead, the IaaS provider may own or operate the control plane VCN 1116 and the data plane VCN 1118, both of which may be contained in the service tenancy 1119. This embodiment can enable isolation of networks that may prevent users or customers from interacting with other users', or other customers', resources. Also, this embodiment may allow users or customers of the system to store databases privately without needing to rely on public Internet 1154, which may not have a desired level of threat prevention, for storage.

In other embodiments, the LB subnet(s) 1122 contained in the control plane VCN 1116 can be configured to receive a signal from the service gateway 1136. In this embodiment, the control plane VCN 1116 and the data plane VCN 1118 may be configured to be called by a customer of the IaaS provider without calling public Internet 1154. Customers of the IaaS provider may desire this embodiment since database(s) that the customers use may be controlled by the IaaS provider and may be stored on the service tenancy 1119, which may be isolated from public Internet 1154.

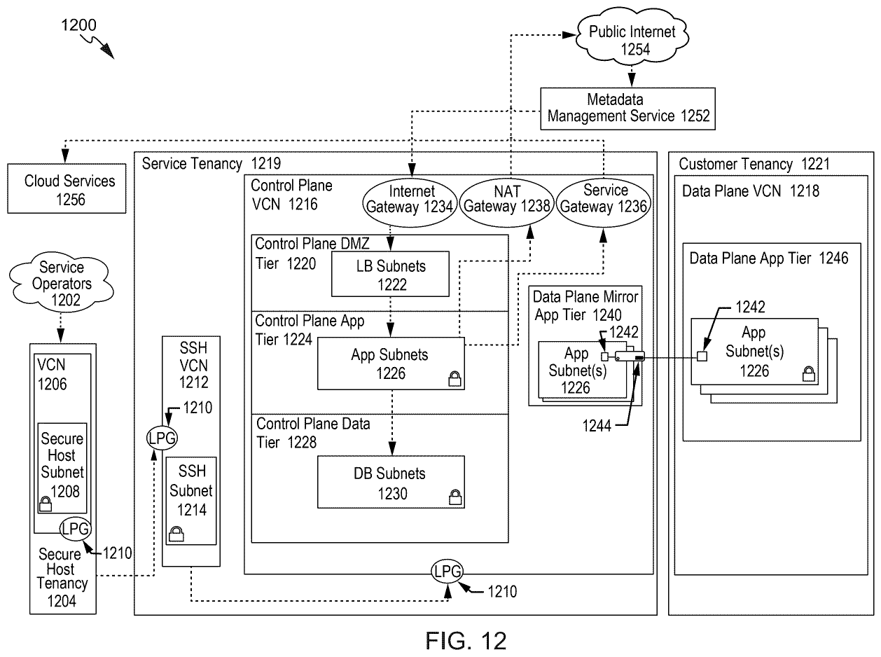

FIG. 12 is a block diagram 1200 illustrating another example pattern of an IaaS architecture, according to at least one embodiment. Service operators 1202 (e.g., service operators 1102 of FIG. 11) can be communicatively coupled to a secure host tenancy 1204 (e.g., the secure host tenancy 1104 of FIG. 11) that can include a virtual cloud network (VCN) 1206 (e.g., the VCN 1106 of FIG. 11) and a secure host subnet 1208 (e.g., the secure host subnet 1108 of FIG. 11). The VCN 1206 can include a local peering gateway (LPG) 1210 (e.g., the LPG 1110 of FIG. 11) that can be communicatively coupled to a secure shell (SSH) VCN 1212 (e.g., the SSH VCN 1112 of FIG. 11) via an LPG 1110 contained in the SSH VCN 1212. The SSH VCN 1212 can include an SSH subnet 1214 (e.g., the SSH subnet 1114 of FIG. 11), and the SSH VCN 1212 can be communicatively coupled to a control plane VCN 1216 (e.g., the control plane VCN 1116 of FIG. 11) via an LPG 1210 contained in the control plane VCN 1216. The control plane VCN 1216 can be contained in a service tenancy 1219 (e.g., the service tenancy 1119 of FIG. 11), and the data plane VCN 1218 (e.g., the data plane VCN 1118 of FIG. 11) can be contained in a customer tenancy 1221 that may be owned or operated by users, or customers, of the system.

The control plane VCN 1216 can include a control plane DMZ tier 1220 (e.g., the control plane DMZ tier 1120 of FIG. 11) that can include LB subnet(s) 1222 (e.g., LB subnet(s) 1122 of FIG. 11), a control plane app tier 1224 (e.g., the control plane app tier 1124 of FIG. 11) that can include app subnet(s) 1226 (e.g., app subnet(s) 1126 of FIG. 11), a control plane data tier 1228 (e.g., the control plane data tier 1128 of FIG. 11) that can include database (DB) subnet(s) 1230 (e.g., similar to DB subnet(s) 1130 of FIG. 11). The LB subnet(s) 1222 contained in the control plane DMZ tier 1220 can be communicatively coupled to the app subnet(s) 1226 contained in the control plane app tier 1224 and an Internet gateway 1234 (e.g., the Internet gateway 1134 of FIG. 11) that can be contained in the control plane VCN 1216, and the app subnet(s) 1226 can be communicatively coupled to the DB subnet(s) 1230 contained in the control plane data tier 1228 and a service gateway 1236 (e.g., the service gateway 1136 of FIG. 11) and a network address translation (NAT) gateway 1238 (e.g., the NAT gateway 1138 of FIG. 11). The control plane VCN 1216 can include the service gateway 1236 and the NAT gateway 1238.

The control plane VCN 1216 can include a data plane mirror app tier 1240 (e.g., the data plane mirror app tier 1140 of FIG. 11) that can include app subnet(s) 1226. The app subnet(s) 1226 contained in the data plane mirror app tier 1240 can include a virtual network interface controller (VNIC) 1242 (e.g., the VNIC of 1142) that can execute a compute instance 1244 (e.g., similar to the compute instance 1144 of FIG. 11). The compute instance 1244 can facilitate communication between the app subnet(s) 1226 of the data plane mirror app tier 1240 and the app subnet(s) 1226 that can be contained in a data plane app tier 1246 (e.g., the data plane app tier 1146 of FIG. 11) via the VNIC 1242 contained in the data plane mirror app tier 1240 and the VNIC 1242 contained in the data plane app tier 1246.

The Internet gateway 1234 contained in the control plane VCN 1216 can be communicatively coupled to a metadata management service 1252 (e.g., the metadata management service 1152 of FIG. 11) that can be communicatively coupled to public Internet 1254 (e.g., public Internet 1154 of FIG. 11). Public Internet 1254 can be communicatively coupled to the NAT gateway 1238 contained in the control plane VCN 1216. The service gateway 1236 contained in the control plane VCN 1216 can be communicatively coupled to cloud services 1256 (e.g., cloud services 1156 of FIG. 11).

In some examples, the data plane VCN 1218 can be contained in the customer tenancy 1221. In this case, the IaaS provider may provide the control plane VCN 1216 for each customer, and the IaaS provider may, for each customer, set up a unique compute instance 1244 that is contained in the service tenancy 1219. Each compute instance 1244 may allow communication between the control plane VCN 1216, contained in the service tenancy 1219, and the data plane VCN 1218 that is contained in the customer tenancy 1221. The compute instance 1244 may allow resources, that are provisioned in the control plane VCN 1216 that is contained in the service tenancy 1219, to be deployed or otherwise used in the data plane VCN 1218 that is contained in the customer tenancy 1221.

In other examples, the customer of the IaaS provider may have databases that live in the customer tenancy 1221. In this example, the control plane VCN 1216 can include the data plane mirror app tier 1240 that can include app subnet(s) 1226. The data plane mirror app tier 1240 can reside in the data plane VCN 1218, but the data plane mirror app tier 1240 may not live in the data plane VCN 1218. That is, the data plane mirror app tier 1240 may have access to the customer tenancy 1221, but the data plane mirror app tier 1240 may not exist in the data plane VCN 1218 or be owned or operated by the customer of the IaaS provider. The data plane mirror app tier 1240 may be configured to make calls to the data plane VCN 1218 but may not be configured to make calls to any entity contained in the control plane VCN 1216. The customer may desire to deploy or otherwise use resources in the data plane VCN 1218 that are provisioned in the control plane VCN 1216, and the data plane mirror app tier 1240 can facilitate the desired deployment, or other usage of resources, of the customer.

In some embodiments, the customer of the IaaS provider can apply filters to the data plane VCN 1218. In this embodiment, the customer can determine what the data plane VCN 1218 can access, and the customer may restrict access to public Internet 1254 from the data plane VCN 1218. The IaaS provider may not be able to apply filters or otherwise control access of the data plane VCN 1218 to any outside networks or databases. Applying filters and controls by the customer onto the data plane VCN 1218, contained in the customer tenancy 1221, can help isolate the data plane VCN 1218 from other customers and from public Internet 1254.

In some embodiments, cloud services 1256 can be called by the service gateway 1236 to access services that may not exist on public Internet 1254, on the control plane VCN 1216, or on the data plane VCN 1218. The connection between cloud services 1256 and the control plane VCN 1216 or the data plane VCN 1218 may not be live or continuous. Cloud services 1256 may exist on a different network owned or operated by the IaaS provider. Cloud services 1256 may be configured to receive calls from the service gateway 1236 and may be configured to not receive calls from public Internet 1254. Some cloud services 1256 may be isolated from other cloud services 1256, and the control plane VCN 1216 may be isolated from cloud services 1256 that may not be in the same region as the control plane VCN 1216. For example, the control plane VCN 1216 may be located in “Region 1,” and cloud service “Deployment 11,” may be located in Region 1 and in “Region 2.” If a call to Deployment 11 is made by the service gateway 1236 contained in the control plane VCN 1216 located in Region 1, the call may be transmitted to Deployment 11 in Region 1. In this example, the control plane VCN 1216, or Deployment 11 in Region 1, may not be communicatively coupled to, or otherwise in communication with, Deployment 11 in Region 2.

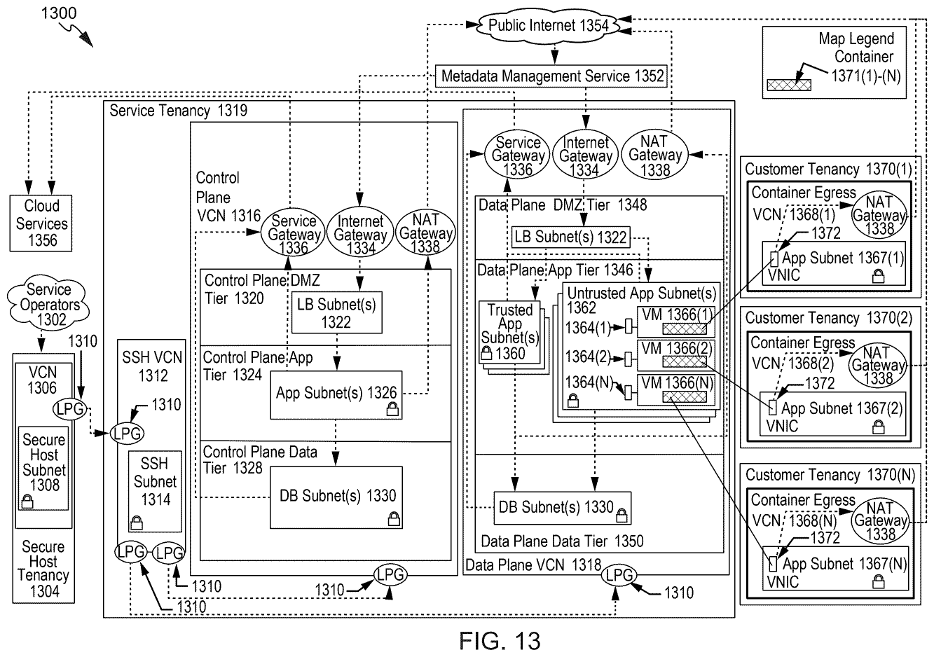

FIG. 13 is a block diagram 1300 illustrating another example pattern of an IaaS architecture, according to at least one embodiment. Service operators 1302 (e.g., service operators 1102 of FIG. 11) can be communicatively coupled to a secure host tenancy 1304 (e.g., the secure host tenancy 1104 of FIG. 11) that can include a virtual cloud network (VCN) 1306 (e.g., the VCN 1106 of FIG. 11) and a secure host subnet 1308 (e.g., the secure host subnet 1108 of FIG. 11). The VCN 1306 can include an LPG 1310 (e.g., the LPG 1110 of FIG. 11) that can be communicatively coupled to an SSH VCN 1312 (e.g., the SSH VCN 1112 of FIG. 11) via an LPG 1310 contained in the SSH VCN 1312. The SSH VCN 1312 can include an SSH subnet 1314 (e.g., the SSH subnet 1114 of FIG. 11), and the SSH VCN 1312 can be communicatively coupled to a control plane VCN 1316 (e.g., the control plane VCN 1116 of FIG. 11) via an LPG 1310 contained in the control plane VCN 1316 and to a data plane VCN 1318 (e.g., the data plane 1118 of FIG. 11) via an LPG 1310 contained in the data plane VCN 1318. The control plane VCN 1316 and the data plane VCN 1318 can be contained in a service tenancy 1319 (e.g., the service tenancy 1119 of FIG. 11).

The control plane VCN 1316 can include a control plane DMZ tier 1320 (e.g., the control plane DMZ tier 1120 of FIG. 11) that can include load balancer (LB) subnet(s) 1322 (e.g., LB subnet(s) 1122 of FIG. 11), a control plane app tier 1324 (e.g., the control plane app tier 1124 of FIG. 11) that can include app subnet(s) 1326 (e.g., similar to app subnet(s) 1126 of FIG. 11), a control plane data tier 1328 (e.g., the control plane data tier 1128 of FIG. 11) that can include DB subnet(s) 1330. The LB subnet(s) 1322 contained in the control plane DMZ tier 1320 can be communicatively coupled to the app subnet(s) 1326 contained in the control plane app tier 1324 and to an Internet gateway 1334 (e.g., the Internet gateway 1134 of FIG. 11) that can be contained in the control plane VCN 1316, and the app subnet(s) 1326 can be communicatively coupled to the DB subnet(s) 1330 contained in the control plane data tier 1328 and to a service gateway 1336 (e.g., the service gateway of FIG. 11) and a network address translation (NAT) gateway 1338 (e.g., the NAT gateway 1138 of FIG. 11). The control plane VCN 1316 can include the service gateway 1336 and the NAT gateway 1338.

The data plane VCN 1318 can include a data plane app tier 1346 (e.g., the data plane app tier 1146 of FIG. 11), a data plane DMZ tier 1348 (e.g., the data plane DMZ tier 1148 of FIG. 11), and a data plane data tier 1350 (e.g., the data plane data tier 1150 of FIG. 11). The data plane DMZ tier 1348 can include LB subnet(s) 1322 that can be communicatively coupled to trusted app subnet(s) 1360 and untrusted app subnet(s) 1362 of the data plane app tier 1346 and the Internet gateway 1334 contained in the data plane VCN 1318. The trusted app subnet(s) 1360 can be communicatively coupled to the service gateway 1336 contained in the data plane VCN 1318, the NAT gateway 1338 contained in the data plane VCN 1318, and DB subnet(s) 1330 contained in the data plane data tier 1350. The untrusted app subnet(s) 1362 can be communicatively coupled to the service gateway 1336 contained in the data plane VCN 1318 and DB subnet(s) 1330 contained in the data plane data tier 1350. The data plane data tier 1350 can include DB subnet(s) 1330 that can be communicatively coupled to the service gateway 1336 contained in the data plane VCN 1318.

The untrusted app subnet(s) 1362 can include one or more primary VNICs 1364(1)-(N) that can be communicatively coupled to tenant virtual machines (VMs) 1366(1)-(N). Each tenant VM 1366(1)-(N) can be communicatively coupled to a respective app subnet 1367(1)-(N) that can be contained in respective container egress VCNs 1368(1)-(N) that can be contained in respective customer tenancies 1370(1)-(N). Respective secondary VNICs 1372(1)-(N) can facilitate communication between the untrusted app subnet(s) 1362 contained in the data plane VCN 1318 and the app subnet contained in the container egress VCNs 1368(1)-(N). Each container egress VCNs 1368(1)-(N) can include a NAT gateway 1338 that can be communicatively coupled to public Internet 1354 (e.g., public Internet 1154 of FIG. 11).

The Internet gateway 1334 contained in the control plane VCN 1316 and contained in the data plane VCN 1318 can be communicatively coupled to a metadata management service 1352 (e.g., the metadata management system 1152 of FIG. 11) that can be communicatively coupled to public Internet 1354. Public Internet 1354 can be communicatively coupled to the NAT gateway 1338 contained in the control plane VCN 1316 and contained in the data plane VCN 1318. The service gateway 1336 contained in the control plane VCN 1316 and contained in the data plane VCN 1318 can be communicatively coupled to cloud services 1356.

In some embodiments, the data plane VCN 1318 can be integrated with customer tenancies 1370. This integration can be useful or desirable for customers of the IaaS provider in some cases such as a case that may desire support when executing code. The customer may provide code to run that may be destructive, may communicate with other customer resources, or may otherwise cause undesirable effects. In response to this, the IaaS provider may determine whether to run code given to the IaaS provider by the customer.

In some examples, the customer of the IaaS provider may grant temporary network access to the IaaS provider and request a function to be attached to the data plane app tier 1346. Code to run the function may be executed in the VMs 1366(1)-(N), and the code may not be configured to run anywhere else on the data plane VCN 1318. Each VM 1366(1)-(N) may be connected to one customer tenancy 1370. Respective containers 1371(1)-(N) contained in the VMs 1366(1)-(N) may be configured to run the code. In this case, there can be a dual isolation (e.g., the containers 1371(1)-(N) running code, where the containers 1371(1)-(N) may be contained in at least the VM 1366(1)-(N) that are contained in the untrusted app subnet(s) 1362), which may help prevent incorrect or otherwise undesirable code from damaging the network of the IaaS provider or from damaging a network of a different customer. The containers 1371(1)-(N) may be communicatively coupled to the customer tenancy 1370 and may be configured to transmit or receive data from the customer tenancy 1370. The containers 1371(1)-(N) may not be configured to transmit or receive data from any other entity in the data plane VCN 1318. Upon completion of running the code, the IaaS provider may kill or otherwise dispose of the containers 1371(1)-(N).

In some embodiments, the trusted app subnet(s) 1360 may run code that may be owned or operated by the IaaS provider. In this embodiment, the trusted app subnet(s) 1360 may be communicatively coupled to the DB subnet(s) 1330 and be configured to execute CRUD operations in the DB subnet(s) 1330. The untrusted app subnet(s) 1362 may be communicatively coupled to the DB subnet(s) 1330, but in this embodiment, the untrusted app subnet(s) may be configured to execute read operations in the DB subnet(s) 1330. The containers 1371(1)-(N) that can be contained in the VM 1366(1)-(N) of each customer and that may run code from the customer may not be communicatively coupled with the DB subnet(s) 1330.

In other embodiments, the control plane VCN 1316 and the data plane VCN 1318 may not be directly communicatively coupled. In this embodiment, there may be no direct communication between the control plane VCN 1316 and the data plane VCN 1318. However, communication can occur indirectly through at least one method. An LPG 1310 may be established by the IaaS provider that can facilitate communication between the control plane VCN 1316 and the data plane VCN 1318. In another example, the control plane VCN 1316 or the data plane VCN 1318 can make a call to cloud services 1356 via the service gateway 1336. For example, a call to cloud services 1356 from the control plane VCN 1316 can include a request for a service that can communicate with the data plane VCN 1318.

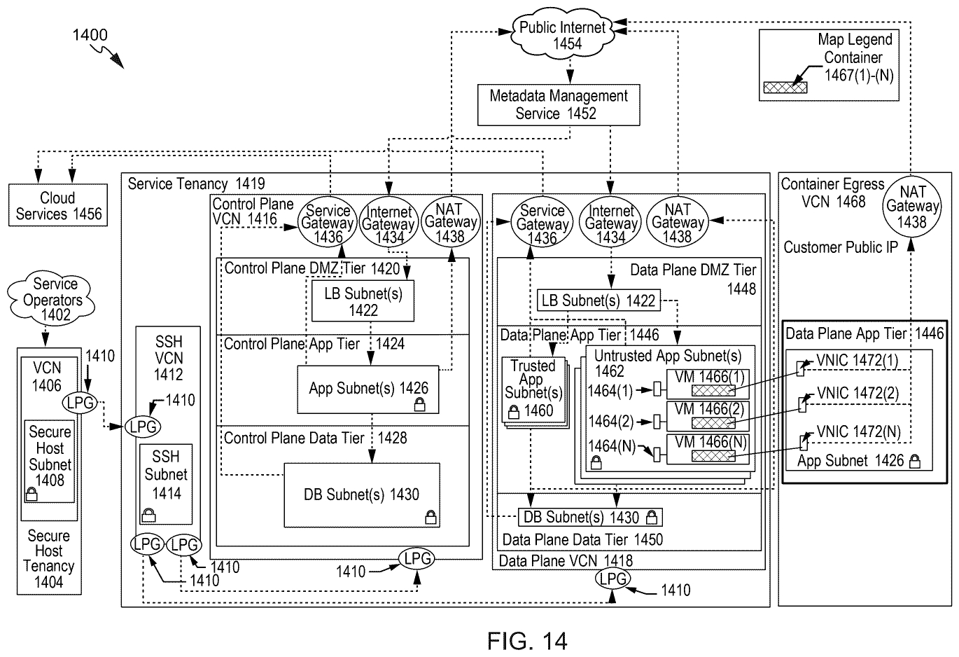

FIG. 14 is a block diagram 1400 illustrating another example pattern of an IaaS architecture, according to at least one embodiment. Service operators 1402 (e.g., service operators 1102 of FIG. 11) can be communicatively coupled to a secure host tenancy 1404 (e.g., the secure host tenancy 1104 of FIG. 11) that can include a virtual cloud network (VCN) 1406 (e.g., the VCN 1106 of FIG. 11) and a secure host subnet 1408 (e.g., the secure host subnet 1108 of FIG. 11). The VCN 1406 can include an LPG 1410 (e.g., the LPG 1110 of FIG. 11) that can be communicatively coupled to an SSH VCN 1412 (e.g., the SSH VCN 1112 of FIG. 11) via an LPG 1410 contained in the SSH VCN 1412. The SSH VCN 1412 can include an SSH subnet 1414 (e.g., the SSH subnet 1114 of FIG. 11), and the SSH VCN 1412 can be communicatively coupled to a control plane VCN 1416 (e.g., the control plane VCN 1116 of FIG. 11) via an LPG 1410 contained in the control plane VCN 1416 and to a data plane VCN 1418 (e.g., the data plane 1118 of FIG. 11) via an LPG 1410 contained in the data plane VCN 1418. The control plane VCN 1416 and the data plane VCN 1418 can be contained in a service tenancy 1419 (e.g., the service tenancy 1119 of FIG. 11).

The control plane VCN 1416 can include a control plane DMZ tier 1420 (e.g., the control plane DMZ tier 1120 of FIG. 11) that can include LB subnet(s) 1422 (e.g., LB subnet(s) 1122 of FIG. 11), a control plane app tier 1424 (e.g., the control plane app tier 1124 of FIG. 11) that can include app subnet(s) 1426 (e.g., app subnet(s) 1126 of FIG. 11), a control plane data tier 1428 (e.g., the control plane data tier 1128 of FIG. 11) that can include DB subnet(s) 1430 (e.g., DB subnet(s) 1330 of FIG. 13). The LB subnet(s) 1422 contained in the control plane DMZ tier 1420 can be communicatively coupled to the app subnet(s) 1426 contained in the control plane app tier 1424 and to an Internet gateway 1434 (e.g., the Internet gateway 1134 of FIG. 11) that can be contained in the control plane VCN 1416, and the app subnet(s) 1426 can be communicatively coupled to the DB subnet(s) 1430 contained in the control plane data tier 1428 and to a service gateway 1436 (e.g., the service gateway of FIG. 11) and a network address translation (NAT) gateway 1438 (e.g., the NAT gateway 1138 of FIG. 11). The control plane VCN 1416 can include the service gateway 1436 and the NAT gateway 1438.

The data plane VCN 1418 can include a data plane app tier 1446 (e.g., the data plane app tier 1146 of FIG. 11), a data plane DMZ tier 1448 (e.g., the data plane DMZ tier 1148 of FIG. 11), and a data plane data tier 1450 (e.g., the data plane data tier 1150 of FIG. 11). The data plane DMZ tier 1448 can include LB subnet(s) 1422 that can be communicatively coupled to trusted app subnet(s) 1460 (e.g., trusted app subnet(s) 1360 of FIG. 13) and untrusted app subnet(s) 1462 (e.g., untrusted app subnet(s) 1362 of FIG. 13) of the data plane app tier 1446 and the Internet gateway 1434 contained in the data plane VCN 1418. The trusted app subnet(s) 1460 can be communicatively coupled to the service gateway 1436 contained in the data plane VCN 1418, the NAT gateway 1438 contained in the data plane VCN 1418, and DB subnet(s) 1430 contained in the data plane data tier 1450. The untrusted app subnet(s) 1462 can be communicatively coupled to the service gateway 1436 contained in the data plane VCN 1418 and DB subnet(s) 1430 contained in the data plane data tier 1450. The data plane data tier 1450 can include DB subnet(s) 1430 that can be communicatively coupled to the service gateway 1436 contained in the data plane VCN 1418.

The untrusted app subnet(s) 1462 can include primary VNICs 1464(1)-(N) that can be communicatively coupled to tenant virtual machines (VMs) 1466(1)-(N) residing within the untrusted app subnet(s) 1462. Each tenant VM 1466(1)-(N) can run code in a respective container 1467(1)-(N), and be communicatively coupled to an app subnet 1426 that can be contained in a data plane app tier 1446 that can be contained in a container egress VCN 1468. Respective secondary VNICs 1472(1)-(N) can facilitate communication between the untrusted app subnet(s) 1462 contained in the data plane VCN 1418 and the app subnet contained in the container egress VCN 1468. The container egress VCN can include a NAT gateway 1438 that can be communicatively coupled to public Internet 1454 (e.g., public Internet 1154 of FIG. 11).

The Internet gateway 1434 contained in the control plane VCN 1416 and contained in the data plane VCN 1418 can be communicatively coupled to a metadata management service 1452 (e.g., the metadata management system 1152 of FIG. 11) that can be communicatively coupled to public Internet 1454. Public Internet 1454 can be communicatively coupled to the NAT gateway 1438 contained in the control plane VCN 1416 and contained in the data plane VCN 1418. The service gateway 1436 contained in the control plane VCN 1416 and contained in the data plane VCN 1418 can be communicatively coupled to cloud services 1456.

In some examples, the pattern illustrated by the architecture of block diagram 1400 of FIG. 14 may be considered an exception to the pattern illustrated by the architecture of block diagram 1300 of FIG. 13 and may be desirable for a customer of the IaaS provider if the IaaS provider cannot directly communicate with the customer (e.g., a disconnected region). The respective containers 1467(1)-(N) that are contained in the VMs 1466(1)-(N) for each customer can be accessed in real-time by the customer. The containers 1467(1)-(N) may be configured to make calls to respective secondary VNICs 1472(1)-(N) contained in app subnet(s) 1426 of the data plane app tier 1446 that can be contained in the container egress VCN 1468. The secondary VNICs 1472(1)-(N) can transmit the calls to the NAT gateway 1438 that may transmit the calls to public Internet 1454. In this example, the containers 1467(1)-(N) that can be accessed in real-time by the customer can be isolated from the control plane VCN 1416 and can be isolated from other entities contained in the data plane VCN 1418. The containers 1467(1)-(N) may also be isolated from resources from other customers.

In other examples, the customer can use the containers 1467(1)-(N) to call cloud services 1456. In this example, the customer may run code in the containers 1467(1)-(N) that requests a service from cloud services 1456. The containers 1467(1)-(N) can transmit this request to the secondary VNICs 1472(1)-(N) that can transmit the request to the NAT gateway that can transmit the request to public Internet 1454. Public Internet 1454 can transmit the request to LB subnet(s) 1422 contained in the control plane VCN 1416 via the Internet gateway 1434. In response to determining the request is valid, the LB subnet(s) can transmit the request to app subnet(s) 1426 that can transmit the request to cloud services 1456 via the service gateway 1436.

It should be appreciated that IaaS architectures 1100, 1200, 1300, 1400 depicted in the figures may have other components than those depicted. Further, the embodiments shown in the figures are only some examples of a cloud infrastructure system that may incorporate an embodiment of the disclosure. In some other embodiments, the IaaS systems may have more or fewer components than shown in the figures, may combine two or more components, or may have a different configuration or arrangement of components.

In certain embodiments, the IaaS systems described herein may include a suite of applications, middleware, and database service offerings that are delivered to a customer in a self-service, subscription-based, elastically scalable, reliable, highly available, and secure manner. An example of such an IaaS system is the Oracle Cloud Infrastructure (OCI) provided by the present assignee.

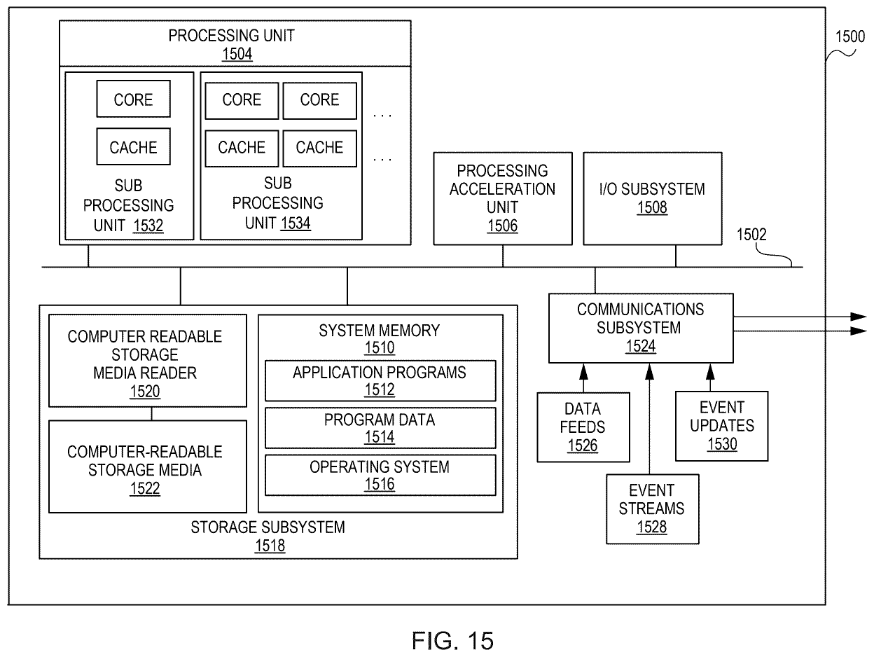

FIG. 15 illustrates an example computer system 1500, in which various embodiments may be implemented. The system 1500 may be used to implement any of the computer systems described above. As shown in the figure, computer system 1500 includes a processing unit 1504 that communicates with a number of peripheral subsystems via a bus subsystem 1502. These peripheral subsystems may include a processing acceleration unit 1506, an I/O subsystem 1508, a storage subsystem 1518 and a communications subsystem 1524. Storage subsystem 1518 includes tangible computer-readable storage media 1522 and a system memory 1510.

Bus subsystem 1502 provides a mechanism for letting the various components and subsystems of computer system 1500 communicate with each other as intended. Although bus subsystem 1502 is shown schematically as a single bus, alternative embodiments of the bus subsystem may utilize multiple buses. Bus subsystem 1502 may be any of several types of bus structures including a memory bus or memory controller, a peripheral bus, and a local bus using any of a variety of bus architectures. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard.

Processing unit 1504, which can be implemented as one or more integrated circuits (e.g., a conventional microprocessor or microcontroller), controls the operation of computer system 1500. One or more processors may be included in processing unit 1504. These processors may include single core or multicore processors. In certain embodiments, processing unit 1504 may be implemented as one or more independent processing units 1532 and/or 1534 with single or multicore processors included in each processing unit. In other embodiments, processing unit 1504 may also be implemented as a quad-core processing unit formed by integrating two dual-core processors into a single chip.

In various embodiments, processing unit 1504 can execute a variety of programs in response to program code and can maintain multiple concurrently executing programs or processes. At any given time, some or all of the program code to be executed can be resident in processor(s) 1504 and/or in storage subsystem 1518. Through suitable programming, processor(s) 1504 can provide various functionalities described above. Computer system 1500 may additionally include a processing acceleration unit 1506, which can include a digital signal processor (DSP), a special-purpose processor, and/or the like.

I/O subsystem 1508 may include user interface input devices and user interface output devices. User interface input devices may include a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may include, for example, motion sensing and/or gesture recognition devices such as the Microsoft Kinect® motion sensor that enables users to control and interact with an input device, such as the Microsoft Xbox® 360 game controller, through a natural user interface using gestures and spoken commands. User interface input devices may also include eye gesture recognition devices such as the Google Glass® blink detector that detects eye activity (e.g., ‘blinking’ while taking pictures and/or making a menu selection) from users and transforms the eye gestures as input into an input device (e.g., Google Glass®). Additionally, user interface input devices may include voice recognition sensing devices that enable users to interact with voice recognition systems (e.g., Siri® navigator), through voice commands.

User interface input devices may also include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include, for example, medical imaging input devices such as computed tomography, magnetic resonance imaging, position emission tomography, medical ultrasonography devices. User interface input devices may also include, for example, audio input devices such as MIDI keyboards, digital musical instruments and the like.

User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. In general, use of the term “output device” is intended to include all possible types of devices and mechanisms for outputting information from computer system 1500 to a user or other computer. For example, user interface output devices may include, without limitation, a variety of display devices that visually convey text, graphics and audio/video information such as monitors, printers, speakers, headphones, automotive navigation systems, plotters, voice output devices, and modems.

Computer system 1500 may comprise a storage subsystem 1518 that provides a tangible non-transitory computer-readable storage medium for storing software and data constructs that provide the functionality of the embodiments described in this disclosure. The software can include programs, code modules, instructions, scripts, etc., that when executed by one or more cores or processors of processing unit 1504 provide the functionality described above. Storage subsystem 1518 may also provide a repository for storing data used in accordance with the present disclosure.

As depicted in the example in FIG. 15, storage subsystem 1518 can include various components including a system memory 1510, computer-readable storage media 1522, and a computer readable storage media reader 1520. System memory 1510 may store program instructions that are loadable and executable by processing unit 1504. System memory 1510 may also store data that is used during the execution of the instructions and/or data that is generated during the execution of the program instructions. Various different kinds of programs may be loaded into system memory 1510 including but not limited to client applications, Web browsers, mid-tier applications, relational database management systems (RDBMS), virtual machines, containers, etc.

System memory 1510 may also store an operating system 1516. Examples of operating system 1516 may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome® OS, and the like) and/or mobile operating systems such as iOS, Windows® Phone, Android® OS, BlackBerry® OS, and Palm® OS operating systems. In certain implementations where computer system 1500 executes one or more virtual machines, the virtual machines along with their guest operating systems (GOSs) may be loaded into system memory 1510 and executed by one or more processors or cores of processing unit 1504.

System memory 1510 can come in different configurations depending upon the type of computer system 1500. For example, system memory 1510 may be volatile memory (such as random access memory (RAM)) and/or non-volatile memory (such as read-only memory (ROM), flash memory, etc.) Different types of RAM configurations may be provided including a static random access memory (SRAM), a dynamic random access memory (DRAM), and others. In some implementations, system memory 1510 may include a basic input/output system (BIOS) containing basic routines that help to transfer information between elements within computer system 1500, such as during start-up.

Computer-readable storage media 1522 may represent remote, local, fixed, and/or removable storage devices plus storage media for temporarily and/or more permanently containing, storing, computer-readable information for use by computer system 1500 including instructions executable by processing unit 1504 of computer system 1500.

Computer-readable storage media 1522 can include any appropriate media known or used in the art, including storage media and communication media, such as but not limited to, volatile and non-volatile, removable and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer readable media.

By way of example, computer-readable storage media 1522 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media. Computer-readable storage media 1522 may include, but is not limited to, Zip® drives, flash memory cards, universal serial bus (USB) flash drives, secure digital (SD) cards, DVD disks, digital video tape, and the like. Computer-readable storage media 1522 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs. The disk drives and their associated computer-readable media may provide non-volatile storage of computer-readable instructions, data structures, program modules, and other data for computer system 1500.

Machine-readable instructions executable by one or more processors or cores of processing unit 1504 may be stored on a non-transitory computer-readable storage medium. A non-transitory computer-readable storage medium can include physically tangible memory or storage devices that include volatile memory storage devices and/or non-volatile storage devices. Examples of non-transitory computer-readable storage medium include magnetic storage media (e.g., disk or tapes), optical storage media (e.g., DVDs, CDs), various types of RAM, ROM, or flash memory, hard drives, floppy drives, detachable memory drives (e.g., USB drives), or other type of storage device.

Communications subsystem 1524 provides an interface to other computer systems and networks. Communications subsystem 1524 serves as an interface for receiving data from and transmitting data to other systems from computer system 1500. For example, communications subsystem 1524 may enable computer system 1500 to connect to one or more devices via the Internet. In some embodiments communications subsystem 1524 can include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 802.11 family standards, or other mobile communication technologies, or any combination thereof)), global positioning system (GPS) receiver components, and/or other components. In some embodiments communications subsystem 1524 can provide wired network connectivity (e.g., Ethernet) in addition to or instead of a wireless interface.

In some embodiments, communications subsystem 1524 may also receive input communication in the form of structured and/or unstructured data feeds 1526, event streams 1528, event updates 1530, and the like on behalf of one or more users who may use computer system 1500.

By way of example, communications subsystem 1524 may be configured to receive data feeds 1526 in real-time from users of social networks and/or other communication services such as Twitter® feeds, Facebook® updates, web feeds such as Rich Site Summary (RSS) feeds, and/or real-time updates from one or more third party information sources.

Additionally, communications subsystem 1524 may also be configured to receive data in the form of continuous data streams, which may include event streams 1528 of real-time events and/or event updates 1530, that may be continuous or unbounded in nature with no explicit end. Examples of applications that generate continuous data may include, for example, sensor data applications, financial tickers, network performance measuring tools (e.g., network monitoring and traffic management applications), clickstream analysis tools, automobile traffic monitoring, and the like.

Communications subsystem 1524 may also be configured to output the structured and/or unstructured data feeds 1526, event streams 1528, event updates 1530, and the like to one or more databases that may be in communication with one or more streaming data source computers coupled to computer system 1500.

Computer system 1500 can be one of various types, including a handheld portable device (e.g., an iPhone® cellular phone, an iPad® computing tablet, a PDA), a wearable device (e.g., a Google Glass® head mounted display), a PC, a workstation, a mainframe, a kiosk, a server rack, or any other data processing system.

Due to the ever-changing nature of computers and networks, the description of computer system 1500 depicted in the figure is intended only as a specific example. Many other configurations having more or fewer components than the system depicted in the figure are possible. For example, customized hardware might also be used and/or particular elements might be implemented in hardware, firmware, software (including applets), or a combination. Further, connection to other computing devices, such as network input/output devices, may be employed. Based on the disclosure and teachings provided herein, a person of ordinary skill in the art will appreciate other ways and/or methods to implement the various embodiments.

Although specific embodiments have been described, various modifications, alterations, alternative constructions, and equivalents are also encompassed within the scope of the disclosure. Embodiments are not restricted to operation within certain specific data processing environments, but are free to operate within a plurality of data processing environments. Additionally, although embodiments have been described using a particular series of transactions and steps, it should be apparent to those skilled in the art that the scope of the present disclosure is not limited to the described series of transactions and steps. Various features and aspects of the above-described embodiments may be used individually or jointly.

Further, while embodiments have been described using a particular combination of hardware and software, it should be recognized that other combinations of hardware and software are also within the scope of the present disclosure. Embodiments may be implemented only in hardware, or only in software, or using combinations thereof. The various processes described herein can be implemented on the same processor or different processors in any combination. Accordingly, where components or services are described as being configured to perform certain operations, such configuration can be accomplished, e.g., by designing electronic circuits to perform the operation, by programming programmable electronic circuits (such as microprocessors) to perform the operation, or any combination thereof. Processes can communicate using a variety of techniques including but not limited to conventional techniques for inter process communication, and different pairs of processes may use different techniques, or the same pair of processes may use different techniques at different times.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific disclosure embodiments have been described, these are not intended to be limiting. Various modifications and equivalents are within the scope of the following claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is intended to be understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Preferred embodiments of this disclosure are described herein, including the best mode known for carrying out the disclosure. Variations of those preferred embodiments may become apparent to those of ordinary skill in the art upon reading the foregoing description. Those of ordinary skill should be able to employ such variations as appropriate and the disclosure may be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein.

All references, including publications, patent applications, and patents, cited herein are hereby incorporated by reference to the same extent as if each reference were individually and specifically indicated to be incorporated by reference and were set forth in its entirety herein.

In the foregoing specification, aspects of the disclosure are described with reference to specific embodiments thereof, but those skilled in the art will recognize that the disclosure is not limited thereto. Various features and aspects of the above-described disclosure may be used individually or jointly. Further, embodiments can be utilized in any number of environments and applications beyond those described herein without departing from the broader spirit and scope of the specification. The specification and drawings are, accordingly, to be regarded as illustrative rather than restrictive.

What is claimed is:

1. A computer-implemented method comprising:
receiving a natural language utterance and database context;
determining, by a generative model, that there is ambiguity in the natural language utterance, the database context, or both, wherein determining comprises applying a context adherence factor that balances between schema-based logical reasoning and common-sense interpretation of the generative model;
determining, by the generative model, that the ambiguity corresponds to one of predefined ambiguity categories;
classifying the ambiguity by an ambiguity type based on the predefined ambiguity category;
generating an explanation describing the ambiguity and one or more reactive questions requesting information required to resolve the ambiguity;
generating an ambiguity score indicating a level of confidence that the ambiguity is ambiguous; and
providing to a user the ambiguity type, the explanation, the one or more reactive questions, and the ambiguity score.

2. The computer-implemented method of claim 1, wherein the context adherence factor is a tunable parameter having a value within a predetermined range, and wherein:
when the context adherence factor is set to a maximum value within the range, the generative model relies exclusively on schema-based logical reasoning;
when the context adherence factor is set to an intermediate value within the range, the generative model prioritizes schema-based logical reasoning and permits common-sense interpretations of terms in the natural language utterance; or
when the context adherence factor is set to a minimum value within the range, the generative model prioritizes common-sense interpretation to interpret the natural language utterance when schema details are insufficient.

3. The computer-implemented method of claim 1 further comprising:
receiving a second natural language utterance and database context;
determining, by a generative model, that there is no ambiguity in the second natural language utterance and database context; and
generating a query statement in a programming language corresponding to the second natural language utterance and database context.

4. The computer-implemented method of claim 1, wherein the predefined ambiguity categories comprise database context ambiguities, natural language utterance ambiguities, model-identifiable ambiguities, or any combination thereof.

5. The computer-implemented method of claim 1 further comprising:
receiving a second natural language utterance and second database context;
determining, by a generative model, that there is ambiguity in the second natural language utterance, the second database context, or both;
determining, by a generative model, that the ambiguity in the second natural language utterance, the second database context, or both does not correspond to any of the predefined ambiguity categories;
determining that the ambiguity in the second natural language utterance, the second database context, or both can be solved using common-sense interpretations; and
generating a query statement in a programming language corresponding to the second natural language utterance and the second database context.

6. The computer-implemented method of claim 1 further comprising:
receiving a second natural language utterance and second database context;
determining, by a generative model, that there is ambiguity in the second natural language utterance, the second database context, or both;
determining, by a generative model, that the ambiguity in the second natural language utterance, the second database context, or both does not correspond to any of the predefined ambiguity categories;
determining that the ambiguity in the second natural language utterance, the second database context, or both cannot be solved using common-sense interpretations; and
performing an iterative optimization process comprising generating, by an optimizer generative model, one or more new ambiguity categories and corresponding ambiguity instructions based on the second natural language utterance, the second database context, and the explanation.

7. The computer-implemented method of claim 1, wherein the ambiguity score is generated as a numerical value within a predetermined range, and wherein:
a score at or near a maximum value within the range indicates a high level of confidence that the natural language utterance is ambiguous;
a score at or near a midpoint within the range indicates a moderate level of confidence that the natural language utterance is ambiguous; and
a score at or near a minimum value within the range indicates a low level of confidence that the natural language utterance is ambiguous.

8. The computer-implemented method of claim 1 further comprising:
receiving a response from the user to the one or more reactive questions providing the information required to resolve the ambiguity; and
generating a query statement in a programming language corresponding to the natural language utterance and the database context.

9. A system comprising:
one or more processors; and
one or more computer-readable media storing instructions which, when executed by the one or more processors, cause the system to perform operations comprising:
receiving a natural language utterance and database context;
determining, by a generative model, that there is ambiguity in the natural language utterance, the database context, or both, wherein determining comprises applying a context adherence factor that balances between schema-based logical reasoning and common-sense interpretation of the generative model;
determining, by the generative model, that the ambiguity corresponds to one of predefined ambiguity categories comprising database context ambiguities, natural language utterance ambiguities, model-identifiable ambiguities, or any combination thereof;
classifying the ambiguity by an ambiguity type based on the predefined ambiguity category;
generating an explanation describing the ambiguity and one or more reactive questions requesting information required to resolve the ambiguity;
generating an ambiguity score indicating a level of confidence that the ambiguity is ambiguous;
providing to a user the ambiguity type, the explanation, the one or more reactive questions, and the ambiguity score;
receiving a response from the user to the one or more reactive questions providing the information required to resolve the ambiguity; and
generating a query statement in a programming language corresponding to the natural language utterance and the database context.

10. The system of claim 9, wherein the context adherence factor is a tunable parameter having a value within a predetermined range, and wherein:
when the context adherence factor is set to a maximum value within the range, the generative model relies exclusively on schema-based logical reasoning;
when the context adherence factor is set to an intermediate value within the range, the generative model prioritizes schema-based logical reasoning and permits common-sense interpretations of terms in the natural language utterance; or
when the context adherence factor is set to a minimum value within the range, the generative model prioritizes common-sense interpretation to interpret the natural language utterance when schema details are insufficient.

11. The system of claim 9 further comprising:
receiving a second natural language utterance and database context;
determining, by a generative model, that there is no ambiguity in the second natural language utterance and database context; and
generating a query statement in a programming language corresponding to the second natural language utterance and database context.

12. The system of claim 9, wherein the ambiguity types comprise: column ambiguity, table ambiguity, join ambiguity, value ambiguity, calculation scope ambiguity, domain-specific term ambiguity, or any combination thereof.

13. The system of claim 9 further comprising:
receiving a second natural language utterance and second database context;
determining, by a generative model, that there is ambiguity in the second natural language utterance, the second database context, or both;
determining, by a generative model, that the ambiguity in the second natural language utterance, the second database context, or both does not correspond to any of the predefined ambiguity categories;
determining that the ambiguity in the second natural language utterance, the second database context, or both can be solved using common-sense interpretations; and
generating a query statement in a programming language corresponding to the second natural language utterance and the second database context.

14. The system of claim 9, further comprising:
receiving a second natural language utterance and second database context;
determining, by a generative model, that there is ambiguity in the second natural language utterance, the second database context, or both;
determining, by a generative model, that the ambiguity in the second natural language utterance, the second database context, or both does not correspond to any of the predefined ambiguity categories;
determining that the ambiguity in the second natural language utterance, the second database context, or both cannot be solved using common-sense interpretations; and
performing an iterative optimization process comprising generating, by an optimizer generative model, one or more new ambiguity categories and corresponding ambiguity instructions based on the second natural language utterance, the second database context, and the explanation.

15. The system of claim 9, wherein the ambiguity score is generated as a numerical value within a predetermined range, and wherein:
a score at or near a maximum value within the range indicates a high level of confidence that the natural language utterance is ambiguous;
a score at or near a midpoint within the range indicates a moderate level of confidence that the natural language utterance is ambiguous; and
a score at or near a minimum value within the range indicates a low level of confidence that the natural language utterance is ambiguous.

16. One or more non-transitory computer-readable media storing instructions which, when executed by one or more processors, cause the one or more processors to perform operations comprising:
receiving a natural language utterance and database context;
determining, by a generative model, that there is ambiguity in the natural language utterance, the database context, or both, wherein determining comprises applying a context adherence factor value within a predetermined range, and wherein: (i) the context adherence factor is a maximum value within the range, the generative model relies exclusively on schema-based logical reasoning, (ii) the context adherence factor is an intermediate value within the range, the generative model prioritizes schema-based logical reasoning and permits common-sense interpretations of terms in the natural language utterance, or (iii) the context adherence factor is a minimum value within the range, the generative model prioritizes common-sense interpretation to interpret the natural language utterance when schema details are insufficient;
determining, by the generative model, that the ambiguity corresponds to one of predefined ambiguity categories comprising database context ambiguities, natural language utterance ambiguities, model-identifiable ambiguities, or any combination thereof;
classifying the ambiguity by an ambiguity type based on the predefined ambiguity category;
generating an explanation describing the ambiguity and one or more reactive questions requesting information required to resolve the ambiguity;
generating an ambiguity score indicating a level of confidence that the ambiguity is ambiguous;
providing to a user the ambiguity type, the explanation, the one or more reactive questions, and the ambiguity score;
receiving a response from the user to the one or more reactive questions providing the information required to resolve the ambiguity; and
generating a query statement in a programming language corresponding to the natural language utterance and the database context.

17. The one or more non-transitory computer-readable media of claim 16 further comprising:
receiving a second natural language utterance and database context;
determining, by a generative model, that there is no ambiguity in the second natural language utterance and database context; and
generating a query statement in a programming language corresponding to the second natural language utterance and database context.

18. The one or more non-transitory computer-readable media of claim 16 further comprising:
receiving a second natural language utterance and second database context;
determining, by a generative model, that there is ambiguity in the second natural language utterance, the second database context, or both;
determining, by a generative model, that the ambiguity in the second natural language utterance, the second database context, or both does not correspond to any of the predefined ambiguity categories;
determining that the ambiguity in the second natural language utterance, the second database context, or both can be solved using common-sense interpretations; and
generating a query statement in a programming language corresponding to the second natural language utterance and the second database context.

19. The one or more non-transitory computer-readable media of claim 16 further comprising:
receiving a second natural language utterance and second database context;
determining, by a generative model, that there is ambiguity in the second natural language utterance, the second database context, or both;
determining, by a generative model, that the ambiguity in the second natural language utterance, the second database context, or both does not correspond to any of the predefined ambiguity categories;
determining that the ambiguity in the second natural language utterance, the second database context, or both cannot be solved using common-sense interpretations; and
performing an iterative optimization process comprising generating, by an optimizer generative model, one or more new ambiguity categories and corresponding ambiguity instructions based on the second natural language utterance, the second database context, and the explanation.

20. The one or more non-transitory computer-readable media of claim 16, wherein the ambiguity score is generated as a numerical value within a predetermined range, and wherein:
a score at or near a maximum value within the range indicates a high level of confidence that the natural language utterance is ambiguous;
a score at or near a midpoint within the range indicates a moderate level of confidence that the natural language utterance is ambiguous; and
a score at or near a minimum value within the range indicates a low level of confidence that the natural language utterance is ambiguous.
